(19) United States
(12) Patent Application Publication
(10) Pub. No.: US 2018/0119010 A1
(43) Pub. Date: May 3, 2018

(54) LIQUID-CRYSTALLINE MEDIUM

(71) Applicant: Merck Patent GmbH, Darmstadt (DE)

(72) Inventors: Melanie KLASEN-MEMMER, Heuchelheim (DE); Achim GOETZ, Seoul (KR); Georg BERNATZ, Darmstadt (DE)

(73) Assignee: Merck Patent GmbH, Darmstadt (DE)

(21) Appl. No.: 15/857,947

(22) Filed: Dec. 29, 2017

Related U.S. Application Data
(62) Division of application No. 14/008,022, filed on Sep. 27, 2013.

(30) Foreign Application Priority Data
Mar. 29, 2011 (DE) 102011015461.2

(51) Int. Cl. C09K 19/32; C09K 19/30; C09K 19/34; C09K 19/44; C09K 19/06; C09K 19/12; C09K 19/04; C09K 19/54

(52) U.S. Cl. CPC C09K 19/32; C09K 2019/3425; C09K 19/3066; C09K 19/3098; C09K 19/3402; C09K 19/44; C09K 19/062; C09K 2019/122; C09K 2019/0448; C09K 2019/123; C09K 2019/3009; C09K 2019/301; C09K 2019/3016; C09K 2019/3422; C09K 2019/548; C09K 19/3001

(57) ABSTRACT

The invention relates to a liquid-crystalline medium which comprises at least one compound of the formula I,

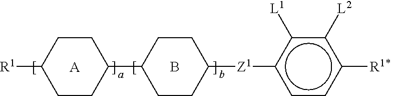

in which
R¹, R¹*, rings A and B, Z¹, L¹, L², a and b have the meanings indicated in Claim 1,
and to the use thereof for an active-matrix display, in particular based on the VA, PSA, PS-VA, PALC, FFS, PS-FFS, IPS or PS-IPS effect.

The invention relates to a liquid-crystalline medium which comprises at least one compound of the formula I,

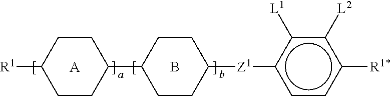

in which
R¹ and R¹* each, independently of one another, denote an alkyl or alkoxy radical having 1 to 15 C atoms, where, in addition, one or more CH₂ groups in these radicals may each be replaced, independently of one another, by —C≡C—, —CF₂O—, —CH═CH—,

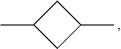

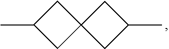

—O—, —CO—O—, —O—CO— in such a way that O atoms are not linked directly to one another, and in which, in addition, one or more H atoms may be replaced by halogen,
Z¹ denotes —CH₂O— or —OCH₂—
a denotes 0, 1 or 2
b denotes 1 or 2,

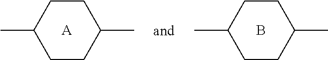

each, independently of one another, denote

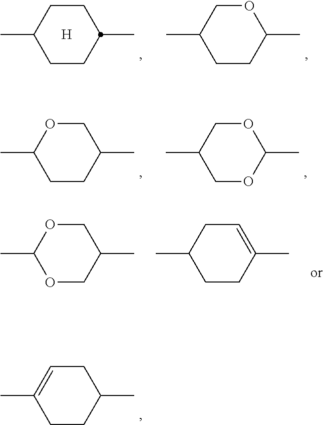

L¹ and L² each, independently of one another, denote F, Cl, CF₃, OCF₃ or CHF₂.

Media of this type can be used, in particular, for electro-optical displays having active-matrix addressing based on the ECB effect and for IPS (in-plane switching) displays or FFS (fringe field switching) displays. In particular, the liquid-crystal mixtures according to the iunvention are suitable for use in LC displays of the PS (polymer stabilised) or PSA (polymer sustained alignment) type.

The principle of electrically controlled birefringence, the ECB effect or also DAP (deformation of aligned phases) effect, was described for the first time in 1971 (M. F. Schieckel and K. Fahrenschon, “Deformation of nematic liquid crystals with vertical orientation in electrical fields”, Appl. Phys. Lett. 19 (1971), 3912). This was followed by papers by J. F. Kahn (Appl. Phys. Lett. 20 (1972), 1193) and G. Labrunie and J. Robert (J. Appl. Phys. 44 (1973), 4869).

The papers by J. Robert and F. Clerc (SID 80 Digest Techn. Papers (1980), 30), J. Duchene (Displays 7 (1986), 3) and H. Schad (SID 82 Digest Techn. Papers (1982), 244) showed that liquid-crystalline phases must have high values for the ratio of the elastic constants K₃/K₁, high values for the optical anisotropy Δn and values for the dielectric anisotropy of Δε≤−0.5 in order to be suitable for use in high-information display elements based on the ECB effect. Electro-optical display elements based on the ECB effect have a homeotropic edge alignment (VA technology=vertically aligned). Dielectrically negative liquid-crystal media can also be used in displays which use the so-called IPS or FFS effect.

Displays which use the ECB effect, as so-called VAN (vertically aligned nematic) displays, for example in the MVA (multi-domain vertical alignment, for example: Yoshide, H. et al., paper 3.1: “MVA LCD for Notebook or Mobile PCs . . . ”, SID 2004 International Symposium, Digest of Technical Papers, XXXV, Book I, pp. 6 to 9, and Liu, C. T. et al., paper 15.1: “A 46-inch TFT-LCD HDTV Technology . . . ”, SID 2004 International Symposium, Digest of Technical Papers, XXXV, Book II, pp. 750 to 753), PVA (patterned vertical alignment, for example: Kim, Sang Soo, paper 15.4: “Super PVA Sets New State-of-the-Art for LCD-TV”, SID 2004 International Symposium, Digest of Technical Papers, XXXV, Book II, pp. 760 to 763), ASV (advanced super view, for example: Shigeta, Mitzuhiro and Fukuoka, Hirofumi, paper 15.2: “Development of High Quality LCDTV”, SID 2004 International Symposium, Digest of Technical Papers, XXXV, Book II, pp. 754 to 757) modes, have established themselves as one of the three more recent types of liquid-crystal display that are currently the most important, in particular for television applications, besides IPS (in-plane switching) displays (for example: Yeo, S. D., paper 15.3: “An LC Display for the TV Application”, SID 2004 International Symposium, Digest of Technical Papers, XXXV, Book II, pp. 758 & 759) and the long-known TN (twisted nematic) displays. The technologies are compared in general form, for example, in Souk, Jun, SID Seminar 2004, seminar M-6: “Recent Advances in LCD Technology”, Seminar Lecture Notes, M-6/1 to M-6/26, and Miller, Ian, SID Seminar 2004, seminar M-7: “LCD-Television”, Seminar Lecture Notes, M-7/1 to M-7/32. Although the response times of modern ECB displays have already been significantly improved by addressing methods with overdrive, for example: Kim, Hyeon Kyeong et al., paper 9.1: “A 57-in. Wide UXGA TFT-LCD for HDTV Application”, SID 2004 International Symposium, Digest of Technical Papers, XXXV, Book I, pp. 106 to 109, the achievement of video-compatible response times, in particular on switching of grey shades, is still a problem which has not yet been satisfactorily solved.

Industrial application of this effect in electro-optical display elements requires LC phases, which have to satisfy a multiplicity of requirements. Particularly important here are chemical resistance to moisture, air and physical influences, such as heat, infrared, visible and ultraviolet radiation and direct and alternating electric fields.

Furthermore, industrially usable LC phases are required to have a liquid-crystalline mesophase in a suitable temperature range and low viscosity.

None of the hitherto-disclosed series of compounds having a liquid-crystal-line mesophase includes a single compound which meets all these requirements. Mixtures of two to 25, preferably three to 18, compounds are therefore generally prepared in order to obtain substances which can be used as LC phases. However, it has not been possible to prepare optimum phases easily in this way since no liquid-crystal materials having significantly negative dielectric anisotropy and adequate long-term stability were hitherto available.

Matrix liquid-crystal displays (MLC displays) are known. Non-linear elements which can be used for individual switching of the individual pixels are, for example, active elements (i.e. transistors). The term “active matrix” is then used, where a distinction can be made between two types:
1. MOS (metal oxide semiconductor) transistors on a silicon wafer as substrate
2. thin-film transistors (TFTs) on a glass plate as substrate.

In the case of type 1, the electro-optical effect used is usually dynamic scattering or the guest-host effect. The use of single-crystal silicon as substrate material restricts the display size, since even modular assembly of various part-displays results in problems at the joints.

In the case of the more promising type 2, which is preferred, the electro-optical effect used is usually the TN effect.

A distinction is made between two technologies: TFTs comprising compound semiconductors, such as, for example, CdSe, or TFTs based on polycrystalline or amorphous silicon. The latter technology is being worked on intensively worldwide.

The TFT matrix is applied to the inside of one glass plate of the display, while the other glass plate carries the transparent counterelectrode on its inside. Compared with the size of the pixel electrode, the TFT is very small and has virtually no adverse effect on the image. This technology can also be extended to fully colour-capable displays, in which a mosaic of red, green and blue filters is arranged in such a way that a filter element is opposite each switchable pixel.

The term MLC displays here covers any matrix display with integrated non-linear elements, i.e. besides the active matrix, also displays with passive elements, such as varistors or diodes (MIM=metal-insulator-metal).

MLC displays of this type are particularly suitable for TV applications (for example pocket TVs) or for high-information displays in automobile or air-craft construction. Besides problems regarding the angle dependence of the contrast and the response times, difficulties also arise in MLC displays due to insufficiently high specific resistance of the liquid-crystal mixtures [TOGASHI, S., SEKIGUCHI, K., TANABE, H., YAMAMOTO, E., SORIMACHI, K., TAJIMA, E., WATANABE, H., SHIMIZU, H., Proc. Eurodisplay 84, September 1984: A 210-288 Matrix LCD Controlled by Double Stage Diode Rings, pp. 141 ff., Paris; STROMER, M., Proc. Eurodisplay 84, September 1984: Design of Thin Film Transistors for Matrix Addressing of Television Liquid Crystal Displays, pp. 145 ff., Paris]. With decreasing resistance, the contrast of an MLC display deteriorates. Since the specific resistance of the liquid-crystal mixture generally drops over the life of an MLC display owing to interaction with the inside surfaces of the display, a high (initial) resistance is very important for displays that have to have acceptable resistance values over a long operating period.

VA displays have significantly better viewing-angle dependencies and are therefore principally used for televisions and monitors. However, there continues to be a need here to improve the response times, in particular with respect to the use of televisions having frame rates (image change frequency/repetition rates) of greater than 60 Hz. At the same time, however, the properties, such as, for example, the low-temperature stability, must not be impaired.

The liquid-crystal displays (LC displays) used at present are usually those of the TN (twisted nematic) type. However, these have the disadvantage of a strong viewing-angle dependence of the contrast. In addition, so-called VA (vertical alignment) displays are known which have a broader viewing angle. The LC cell of a VA display contains a layer of a liquid-crystalline medium between two transparent electrodes, where the liquid-crystalline medium usually has a negative value of the dielectric (DC) anisotropy. In the switched-off state, the molecules of the LC layer are aligned perpendicular to the electrode surfaces (homeotropically) or have a tilted homeotropic alignment. On application of an electrical voltage to the electrodes, a realignment of the LC molecules parallel to the electrode surfaces takes place. Furthermore, OCB (optically compensated bend) displays are known which are based on a birefringence effect and have an LC layer with a so-called “bend” alignment and usually positive (DC) anisotropy. On application of an electrical voltage, a realignment of the LC molecules perpendicular to the electrode surfaces takes place. In addition, OCB displays normally contain one or more birefringent optical retardation films in order to prevent undesired transparency to light of the bend cell in the dark state. OCB displays have a broader viewing angle and shorter response times compared with TN displays. Also known are IPS (in-plane switching) displays, which contain an LC layer between two substrates, only one of which has an electrode layer, usually with a comb-shaped structure. On application of a voltage, an electric field which has a significant component parallel to the LC layer is thereby generated. This causes a realignment of the LC molecules in the layer plane. Furthermore, so-called FFS (fringe-field switching) displays have been proposed (see, inter alia, S. H. Jung et al., Jpn. J. Appl. Phys., Volume 43, No. 3, 2004, 1028), which likewise contain two electrodes on the same substrate, but, in contrast to IPS displays, only one of these is in the form of a structured (comb-shaped) electrode, and the other electrode is unstructured. A strong, so-called “fringe field” is thereby generated, i.e. a strong electric field close to the edge of the electrodes, and, throughout the cell, an electric field which has both a strong vertical component and also a strong horizontal component. Both IPS displays and also FFS displays have a low viewing-angle dependence of the contrast.

In VA displays of the more recent type, uniform alignment of the LC molecules is restricted to a plurality of relatively small domains within the LC cell. Disclinations may exist between these domains, also known as tilt domains. VA displays having tilt domains have, compared with conventional VA displays, a greater viewing-angle independence of the contrast and the grey shades. In addition, displays of this type are simpler to produce since additional treatment of the electrode surface for uniform alignment of the molecules in the switched-on state, such as, for example, by rubbing, is no longer necessary. Instead, the preferential direction of the tilt or pretilt angle is controlled by a special design of the electrodes. In so-called MVA (multidomain vertical alignment) displays, this is usually achieved by the electrodes having protrusions which cause a local pretilt. As a consequence, the LC molecules are aligned parallel to the electrode surfaces in different directions in different, defined regions of the cell on application of a voltage. “Controlled” switching is thereby achieved, and the formation of interfering disclination lines is prevented. Although this arrangement improves the viewing angle of the display, it results, however, in a reduction in its transparency to light. A further development of MVA uses protrusions on only one electrode side, while the opposite electrode has slits, which improves the transparency to light. The slitted electrodes generate an inhomogeneous electric field in the LC cell on application of a voltage, meaning that controlled switching is still achieved. For further improvement of the transparency to light, the separations between the slits and protrusions can be increased, but this in turn results in a lengthening of the response times. In the so-called PVA (patterned VA), protrusions are rendered completely superfluous in that both electrodes are structured by means of slits on the opposite sides, which results in increased contrast and improved transparency to light, but is technologically difficult and makes the display more sensitive to mechanical influences (tapping, etc.). For many applications, such as, for example, monitors and especially TV screens, however, a shortening of the response times and an improvement in the contrast and luminance (transmission) of the display are demanded.

A further development are the so-called PS (polymer-stabilised) displays, which are also known under the term “PSA” (polymer-sustained alignment). In these, a small amount (for example 0.3%, typically <1%) of a polymerisable compound is added to the liquid-crystalline medium and, after introduction into the LC cell, is polymerised or crosslinked in situ, usually by UV photopolymerisation, with or without an applied electrical voltage between the electrodes. The addition of polymerisable mesogenic or liquid-crystal-line compounds, also known as “reactive mesogens” (RMs), to the LC mixture has proven particularly suitable. In the meantime, the PSA principle is being used in diverse classical LC displays. Thus, for example, PSA-VA, PSA-OCB, PS-IPS, PS-FFS and PS-TN displays are known. The in-situ polymerisation of the polymerisable compound(s) is usually carried out, for example in the case of PSA-VA displays, with an applied electrical voltage with or without an applied electrical voltage in the case of PSA-IPS displays. As can be demonstrated in test cells, the PSA method results in a pretilt in the cell. In the case of PSA-OCB displays, it is therefore possible for the bend structure to be stabilised so that an offset voltage is unnecessary or can be reduced. In the case of PSA-VA displays, this pretilt has a positive effect on response times. For PSA-VA displays, a standard MVA or PVA pixel and electrode layout can be used. In addition, however, it is possible, for example, to manage with only one structured electrode side and no protrusions, which significantly simplifies production and at the same time results in very good contrast at the same time as very good transparency to light. PSA-VA displays are described, for example, in JP 10-036847 A, EP 1 170 626 A2, EP 1 378 557 A1, EP 1 498 468 A1, US 2004/0191428 A1, US 2006/0066793 A1 and US 2006/0103804 A1. PSA-OCB displays are described, for example, in T.-J- Chen et al., Jpn. J. Appl. Phys. 45, 2006, 2702-2704 and S. H. Kim, L.-C- Chien, Jpn. J. Appl. Phys. 43, 2004, 7643-7647. PS-IPS displays are described, for example, in U.S. Pat. No. 6,177,972 and Appl. Phys. Lett. 1999, 75(21), 3264. PS-TN displays are described, for example, in Optics Express 2004, 12(7), 1221.

In particular for monitor applications and especially for TV applications, optimisation of the response times, but also of the contrast and luminance (thus also transmission) of the LC display continues to be demanded. The PSA method can provide crucial advantages here. In particular in the case of PSA-VA, a shortening of the response times, which correlates with a measurable pretilt in test cells, can be achieved without significant adverse effects on other parameters.

However, it has been found that the LC mixtures known from the prior art still have some disadvantages on use in VA and PSA displays. Thus, not every desired soluble RM by far is suitable for use in PSA displays, and it is often difficult to find more suitable selection criteria than the direct PSA experiment with pretilt measurement. The choice becomes even smaller if polymerisation by means of UV light without the addition of photoinitiators is desired, which may be advantageous for certain applications. In addition, the liquid-crystal mixture or the liquid-crystal mixture (also referred to as “LC host mixture” below)+polymerisable component “material system” selected should have the lowest possible rotational viscosity and the best possible electrical properties, with the emphasis here being on the so-called “voltage holding ratio” (VHR or HR). In connection with PSA displays, a high VHR after irradiation with UV light is, in particular, of central importance since UV exposure is a necessary part of the display production process, but naturally also occurs as “normal” exposure in the finished display.

In addition, the problem arises that not all LC mixture+polymerisable component combinations by far are suitable for PSA displays since, for example, no tilt or an inadequate tilt arises or since, for example, the VHR is inadequate for TFT display applications.

In particular, it would be desirable to have available novel materials for PSA displays which generate a particularly low pretilt angle. Materials which generate a lower pretilt angle during polymerisation for the same exposure time than the materials known to date, and/or through the use of which the (higher) pretilt angle that can be achieved using the known materials can already be achieved after a shorter exposure time would be particularly desirable. The production time (tact time) of the display could thus be shortened and the costs of the production process reduced.

There is thus still a great demand for liquid-crystal mixtures for MLC displays having very high specific resistance at the same time as a large working-temperature range, short response times and a low threshold voltage, with the aid of which various grey shades can be generated. Furthermore, it should be possible to employ the liquid-crystalline mixtures both in VA, IPS and FFS, PALC and also in PS-VA, PSA, PS-IPS, PS-FFS displays, and they should not exhibit the disadvantages described above, or should only do so to a small extent, and should at the same time have improved properties. In PS-VA and PSA displays, the liquid-crystalline media comprising a polymerisable component should be capable of establishing an adequate pre-tilt in the MLC displays and should have a relatively high voltage holding ratio (VHR or HR).

The invention is based on the object of providing liquid-crystalline media which can be employed, in particular, both in IPS, FFS, VA and also in PS-VA displays and are suitable, in particular, for monitor and TV applications, which do not have the disadvantages indicated above, or only do so to a reduced extent. In particular, it must be ensured for monitors and televisions that they also work at extremely high and extremely low temperatures and at the same time have short response times and at the same time have an improved reliability behaviour, in particular exhibit no or significantly reduced image sticking after long operating times.

Surprisingly, it is possible to improve the rotational viscosity values and thus the response times if polar compounds of the general formula I are used in liquid-crystal mixtures, in particular in LC mixtures having negative dielectric anisotropy, preferably for VA displays. Furthermore, it has been found, surprisingly, that the use of liquid-crystalline media according to the invention in PS-VA and PSA displays facilitates particularly low pre-tilt angles and rapid establishment of the desired tilt angles. This has been demonstrated in the case of the media according to the invention by means of pre-tilt measurements. In particular, it has been possible to achieve a pre-tilt without the addition of photoinitiator. In addition, the media according to the invention exhibit significantly faster generation of the pre-tilt angle compared with the materials known from the prior art, as has been demonstrated by exposure time-dependent measurements of the pre-tilt angle.

The invention thus relates to a liquid-crystalline medium which comprises at least one compound of the formula I.

The compounds of the formula I in liquid-crystalline media simultaneously have very low rotational viscosity values and high absolute values of the dielectric anisotropy. It is therefore possible to prepare liquid-crystal mixtures, preferably VA and PS-VA mixtures, which have short response times, at the same time good phase properties and good low-temperature behaviour.

The invention furthermore relates to a liquid-crystalline medium comprising an LC mixture according to the invention as described above and below, and one or more polymerisable compounds, preferably selected from the group consisting of reactive mesogens.

The invention furthermore relates to a liquid-crystalline medium comprising an LC mixture according to the invention as described above and below, and a polymer obtainable by polymerisation of one or more polymerisable compounds, which are preferably selected from the group consisting of reactive mesogens.

The invention furthermore relates to an LC medium comprising
a polymerisable component A) comprising one or more polymerisable compounds, preferably selected from reactive mesogens, and
a liquid-crystalline component B), also referred to as “LC host mixture” below, consisting of an LC mixture according to the invention comprising one or more compounds of the formula I as described above and below.

The invention furthermore relates to an LC medium comprising
a polymer obtainable by polymerisation of a polymerisable component A) comprising one or more polymerisable compounds, preferably selected from reactive mesogens, and
a liquid-crystalline component B), also referred to as “LC host mixture” below, consisting of an LC mixture according to the invention comprising one or more compounds of the formula I as described above and below.

The invention furthermore relates to the use of LC mixtures according to the invention in PS and PSA displays, in particular the use in PS and PSA displays containing a liquid-crystalline medium, for generating a tilt angle in the liquid-crystalline medium by in-situ polymerisation of the polymerisable compound(s) in the PSA display, preferably with application of an electric and/or magnetic field, preferably an electric field.

The invention furthermore relates to an LC display containing an LC medium according to the invention, in particular a PS or PSA display, particularly preferably a PSA-VA, PS-IPS or PS-FFS display.

The invention furthermore relates to an LC display of the PS or PSA type containing an LC cell consisting of two substrates and two electrodes, where at least one substrate is transparent to light and at least one substrate has an electrode, and a layer, located between the substrates, of an LC medium comprising a polymerised component and a low-molecular-weight component, where the polymerised component is obtainable by polymerisation of one or more polymerisable compounds in the LC medium between the substrates of the LC cell, preferably with application of an electrical voltage to the electrodes, where the low-molecular-weight component is an LC mixture according to the invention as described above and below.

The invention furthermore relates to a process for the preparation of a liquid-crystal mixture according to the invention in which at least one compound of the formula I is mixed with further mesogenic compounds and optionally with one or more polymerisable compounds and/or one or more additives and/or stabilisers.

The invention furthermore relates to a process for the production of an LC display in which an LC mixture according to the invention is mixed with one or more polymerisable compounds and optionally with further liquid-crystal-line compounds and/or additives and/or stabilisers, the mixture obtained in this way is introduced into an LC cell having two substrates and two electrodes, as described above and below, and the polymerisable compound(s) is (are) polymerised at the electrodes, preferably with application of an electrical voltage. The mixtures according to the invention preferably exhibit very broad nematic phase ranges with clearing points ≥70° C., preferably ≥75° C., in particular ≥80° C., very favourable values of the capacitive threshold, relatively high values of the holding ratio and at the same time very good low-temperature stabilities at −20° C. and −30° C., as well as very low rotational viscosity values and short response times. The mixtures according to the invention are furthermore distinguished by the fact that, in addition to the improvement in the rotational viscosity γ₁, relatively high values of the elastic constants K₃₃ for improving the response times can be observed.

Some preferred embodiments of the mixtures according to the invention are indicated below.

In the compounds of the formula I, R¹ preferably denotes straight-chain alkyl, in particular C₂H₅, n-C₃H₇, n-C₄H₉, n-C₅H₁₁, n-C₆H₁₃, furthermore alkenyl or alkoxy, such as, for example, CH₂═CH, CH₃CH═CH, CH₃CH₂CH═CH, C₃H₇CH═CH, OC₂H₅, OC₃H₇, OC₄H₉, OC₅H₁₁, OC₆H₁₃, and alkenyloxy, such as, for example, OCH₂CH═CH₂, OCH₂CH═CHCH₃, OCH₂CH═CHC₂H₅. R¹ very particularly preferably denotes C₂H₅, n-C₃H₇, n-C₄H₉, n-C₅H₁₁.

In the compounds of the formula I, R¹* preferably denotes straight-chain alkyl or alkoxy, in particular OC₂H₅, OC₃H₇, OC₄H₉, OC₅H₁₁, OC₆H₁₃, C₂H₅, C₃H₇, C₄H₉, C₅H₁₁, C₆H₁₃, and furthermore alkenyloxy, such as, for example, OCH₂CH═CH₂, OCH₂CH═CHCH₃, OCH₂CH═CHC₂H₅. R¹* very particularly preferably denotes C₂H₅, C₃H₇, C₄H₉ or C₅H₁₁.

Preferred compounds of the formula I are the compounds of the formulae I-1 to I-192,

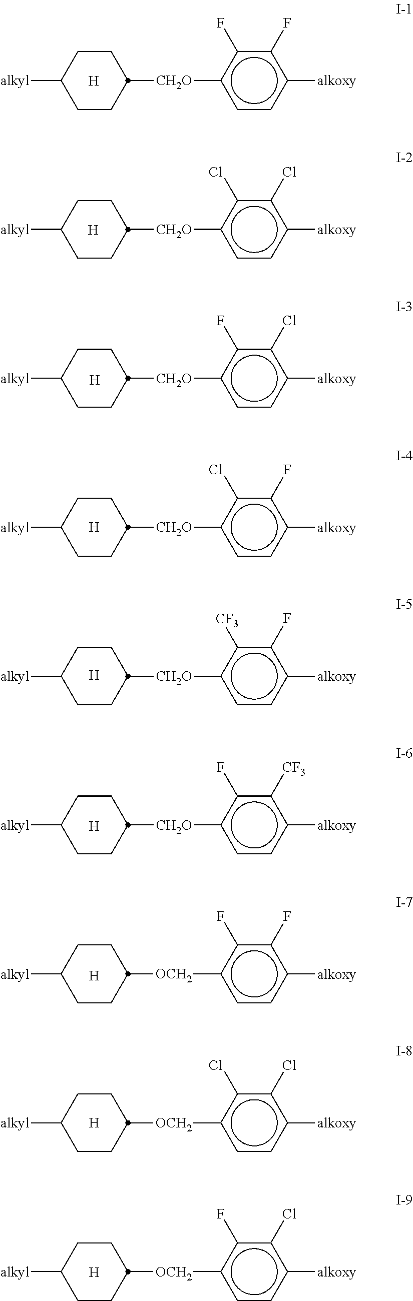

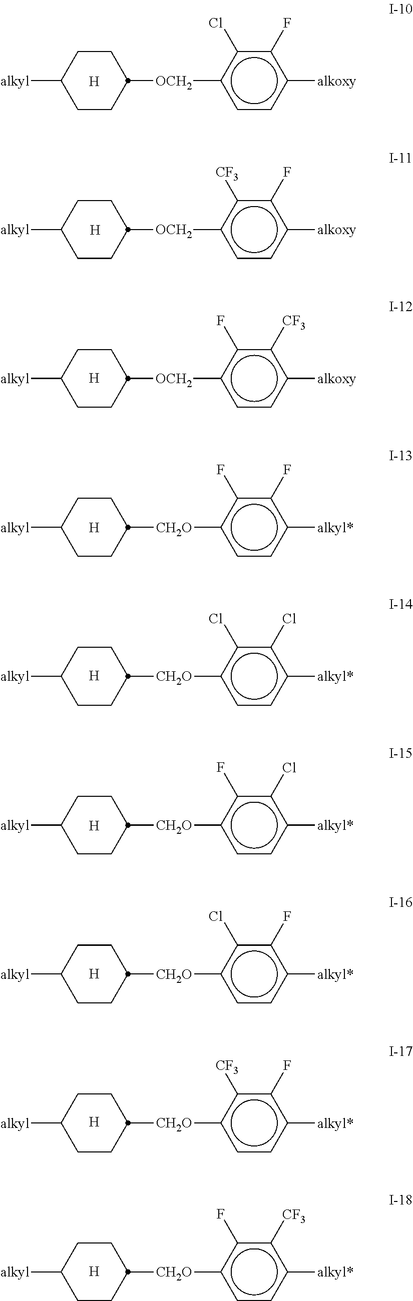

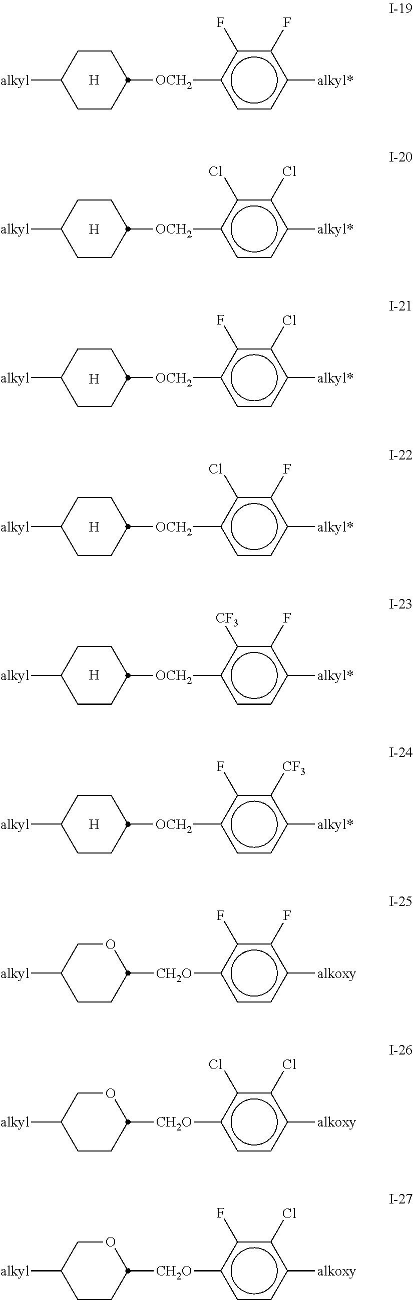

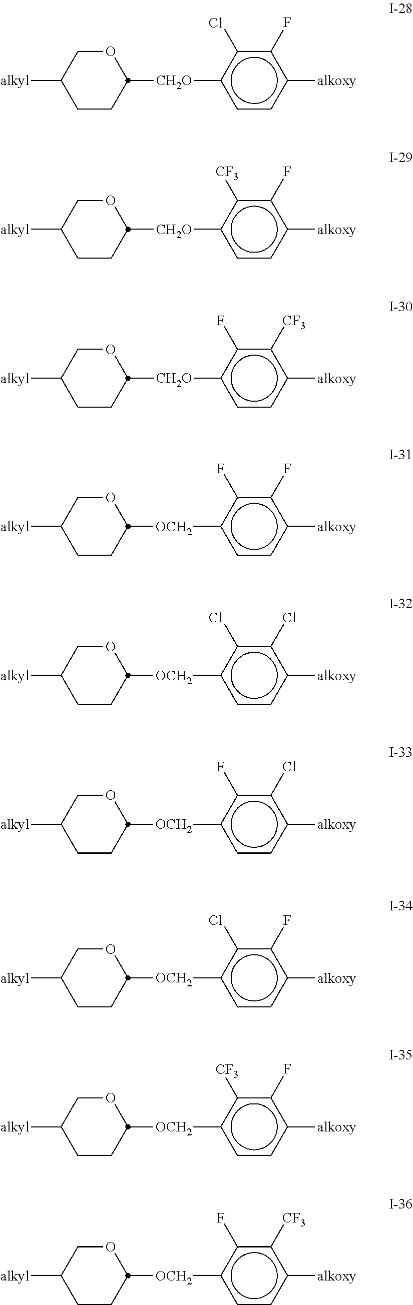

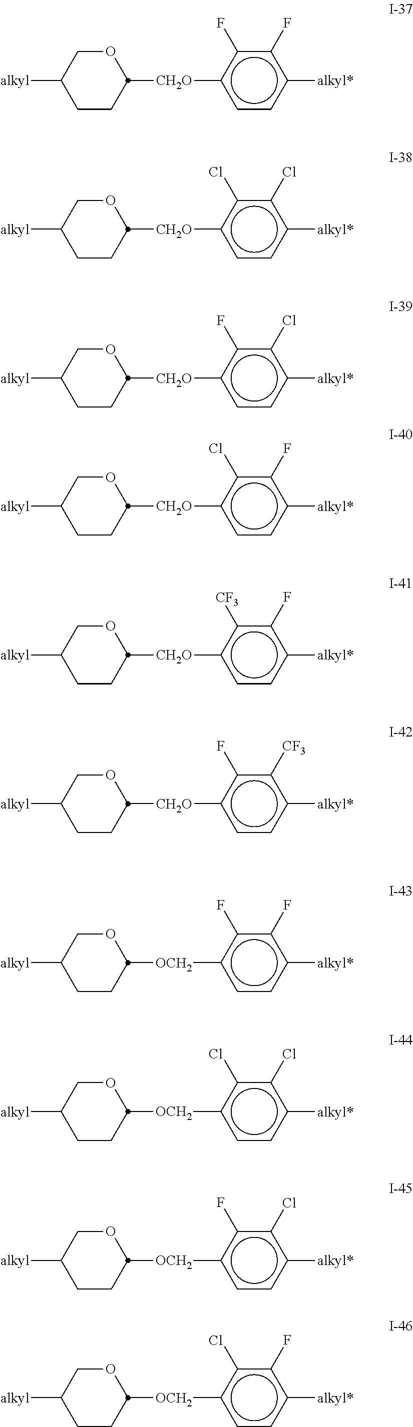

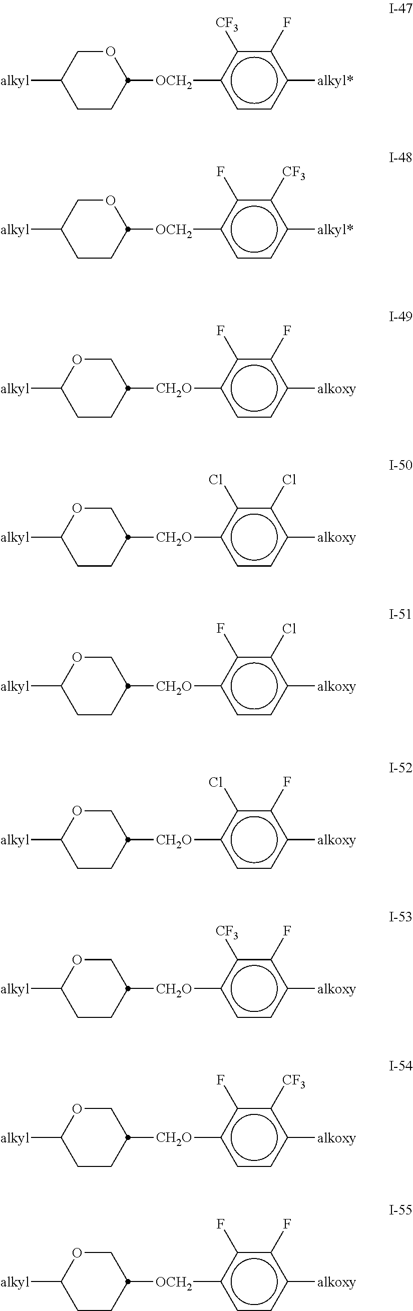

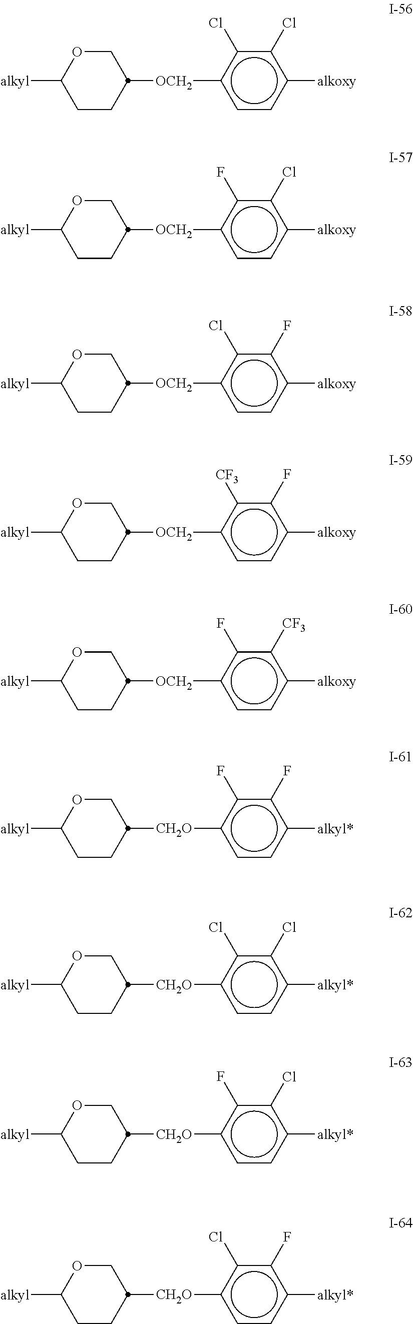

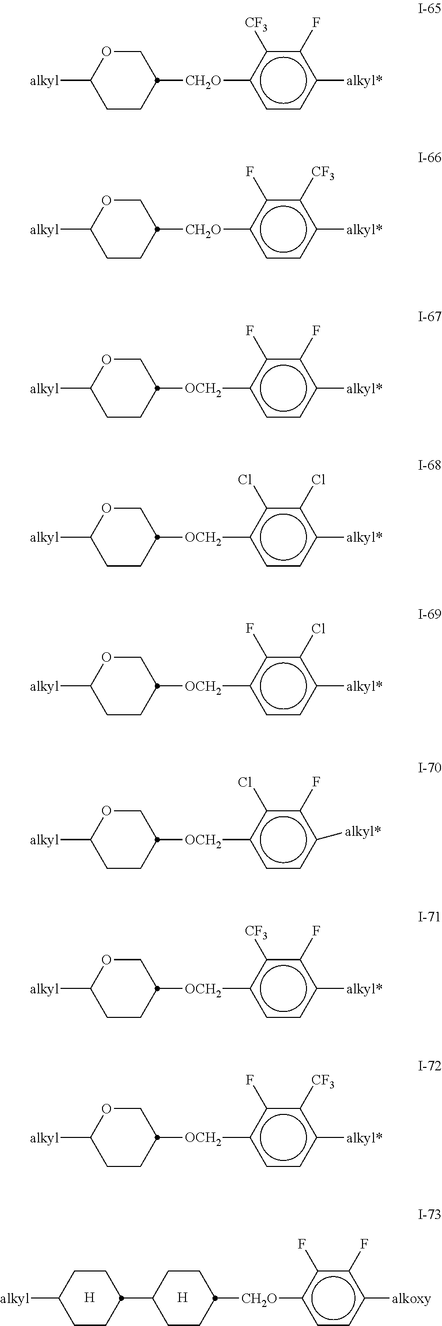

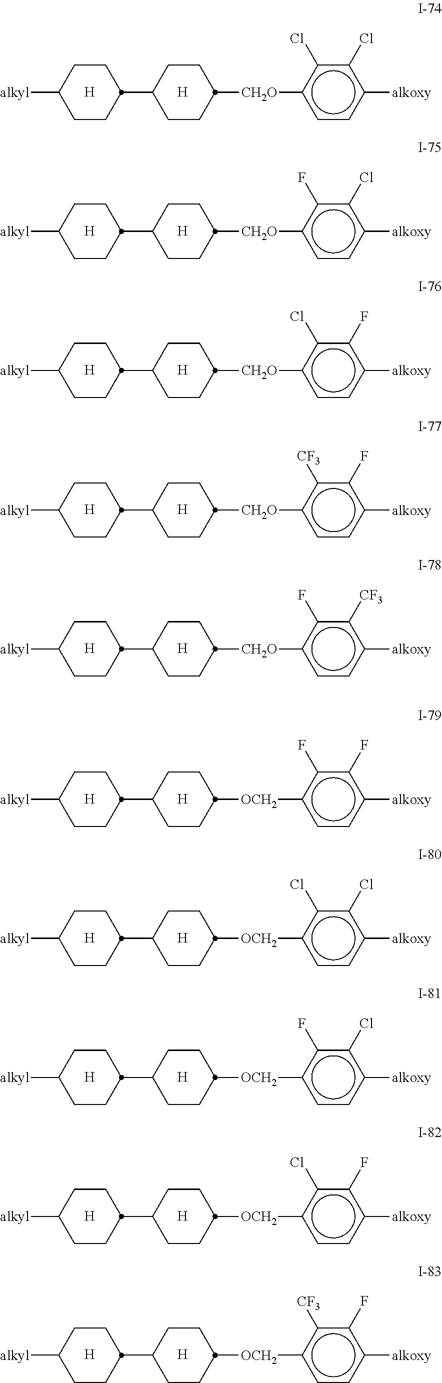

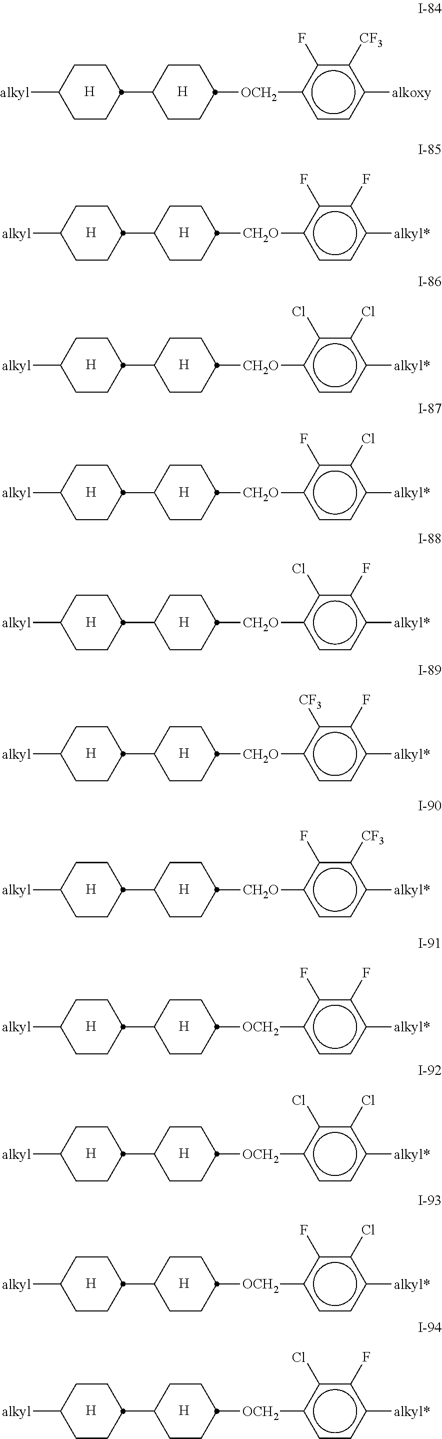

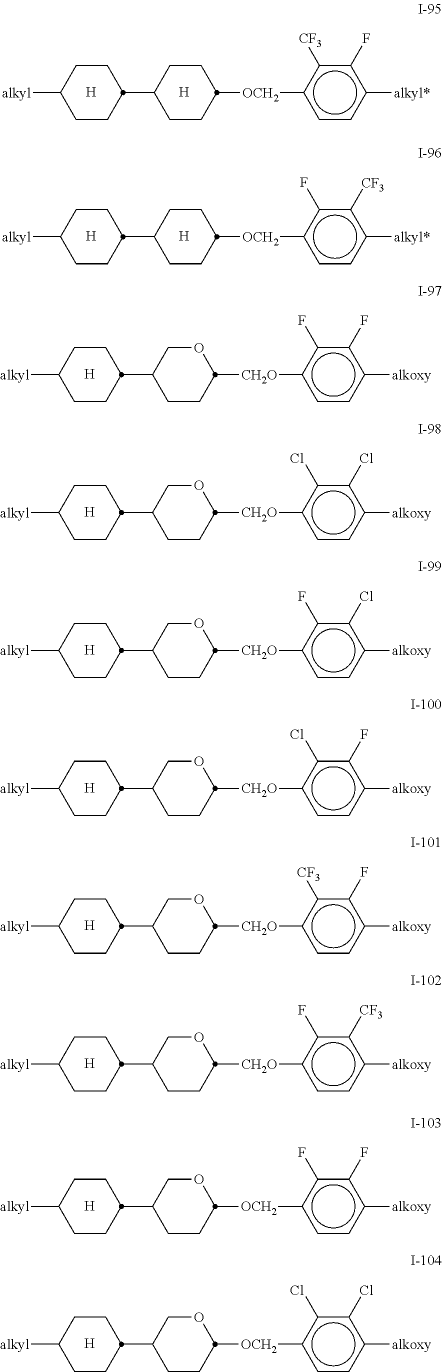

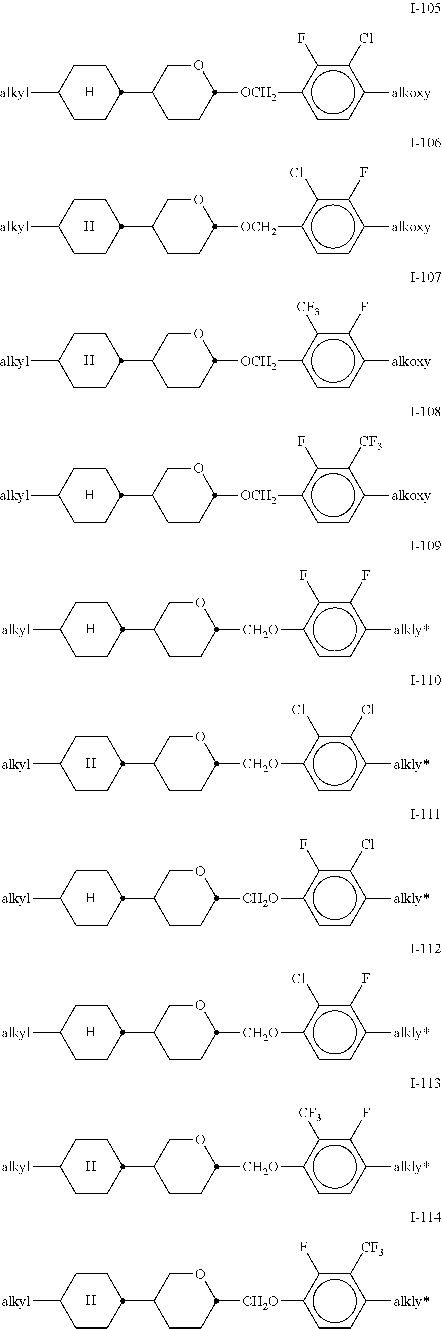

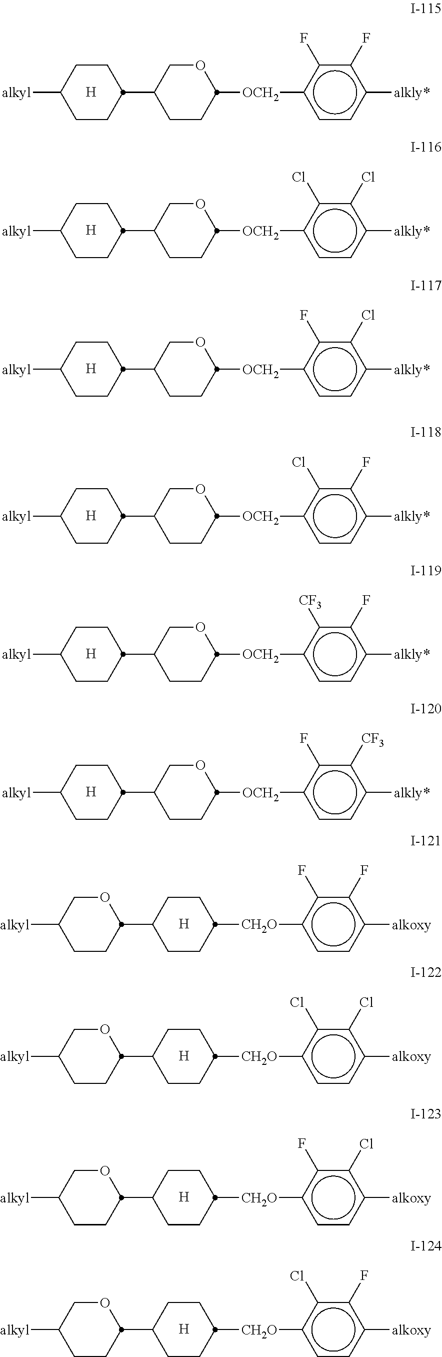

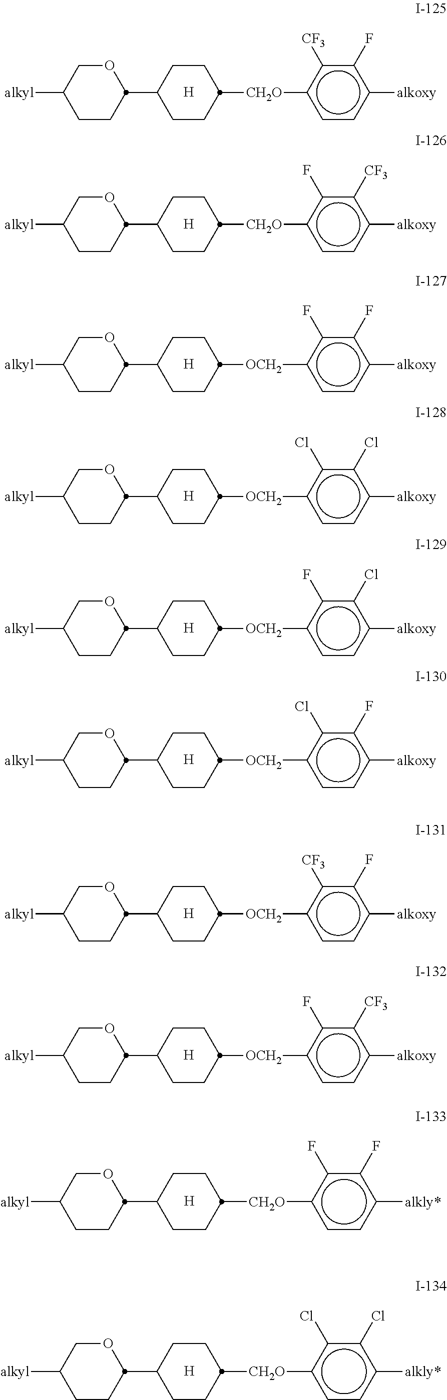

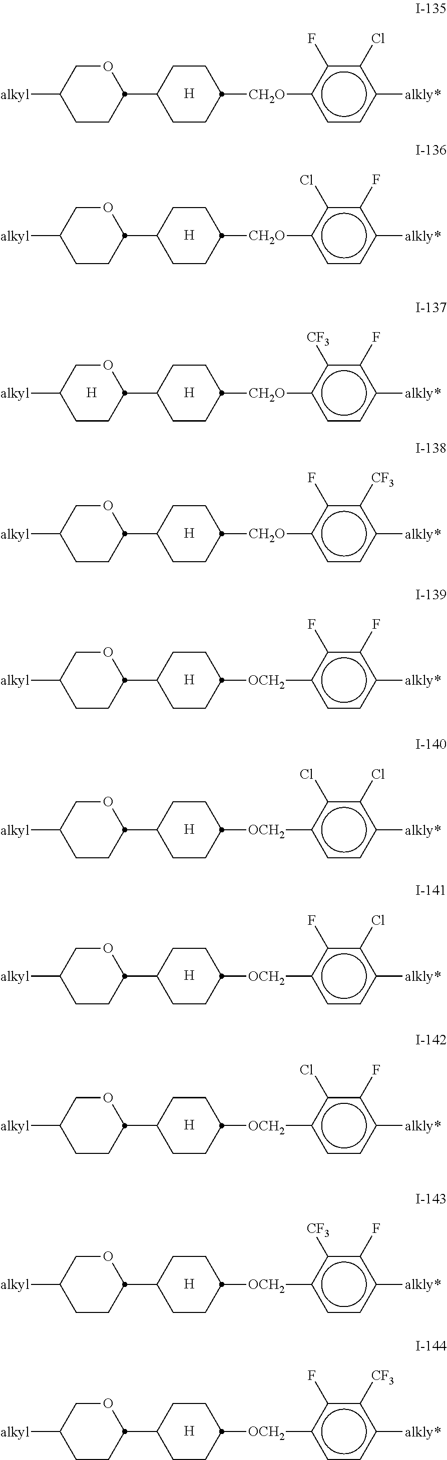

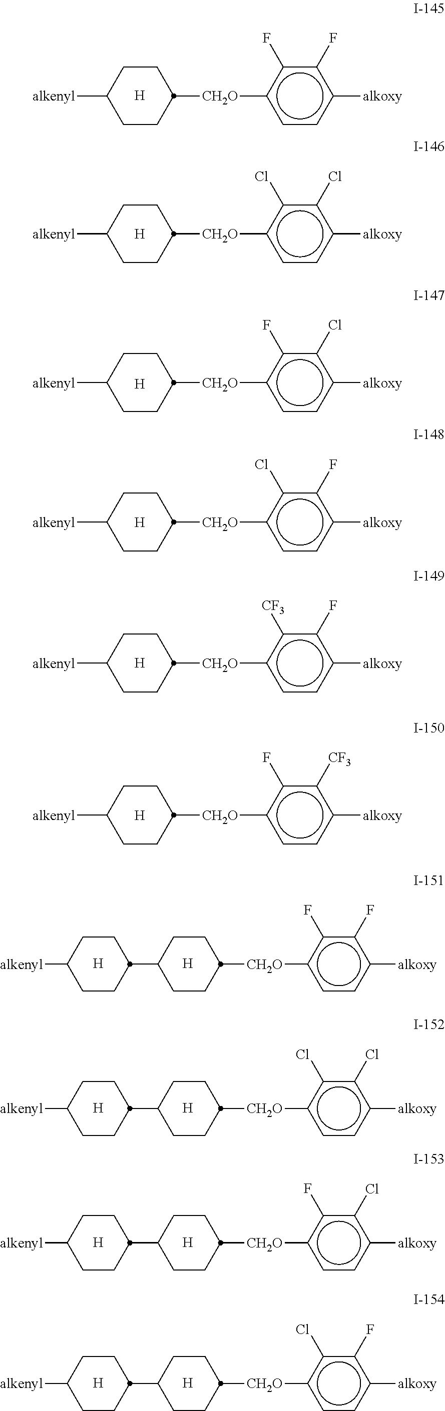

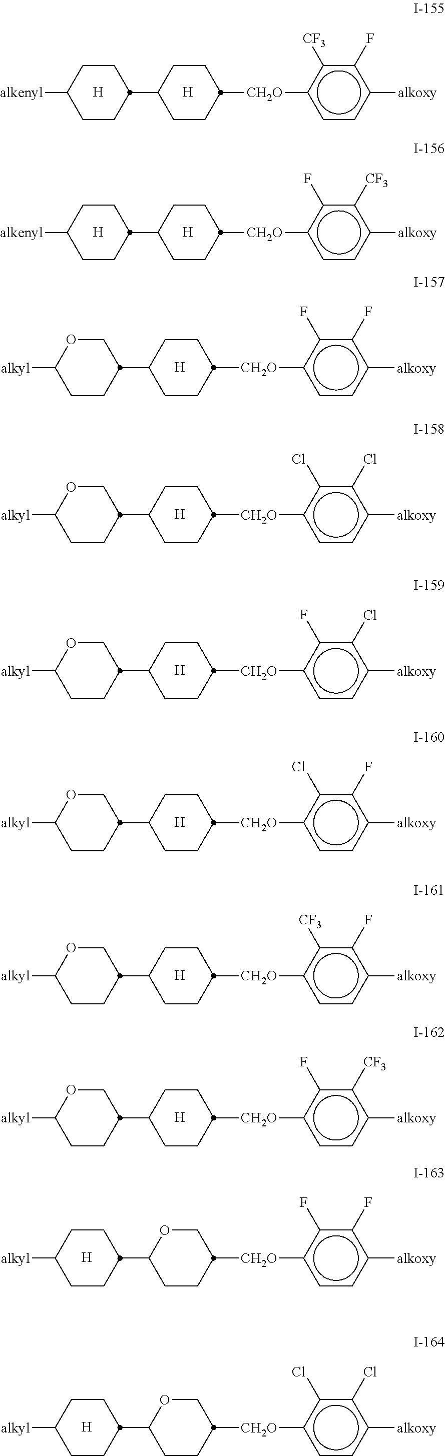

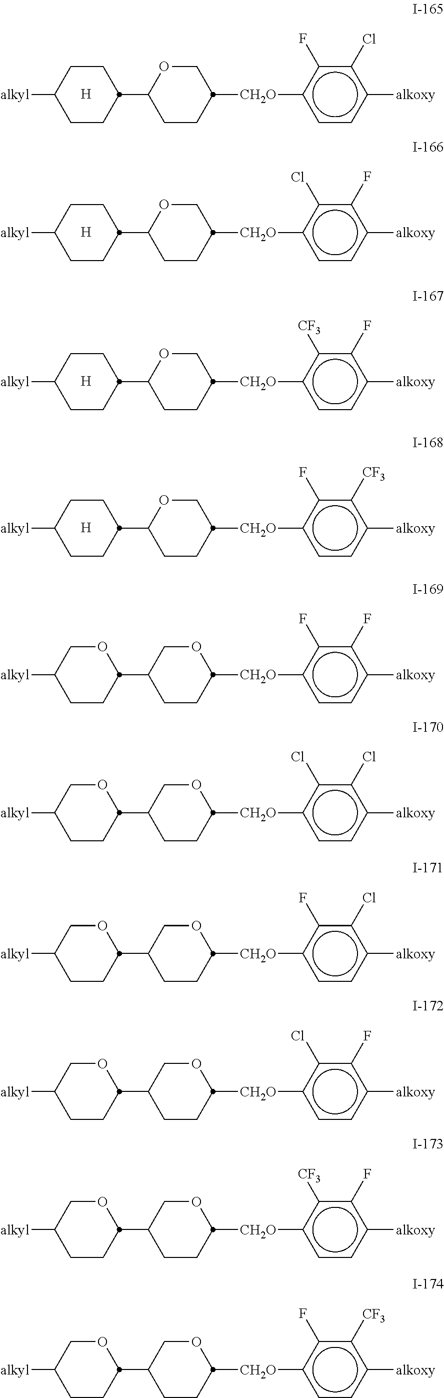

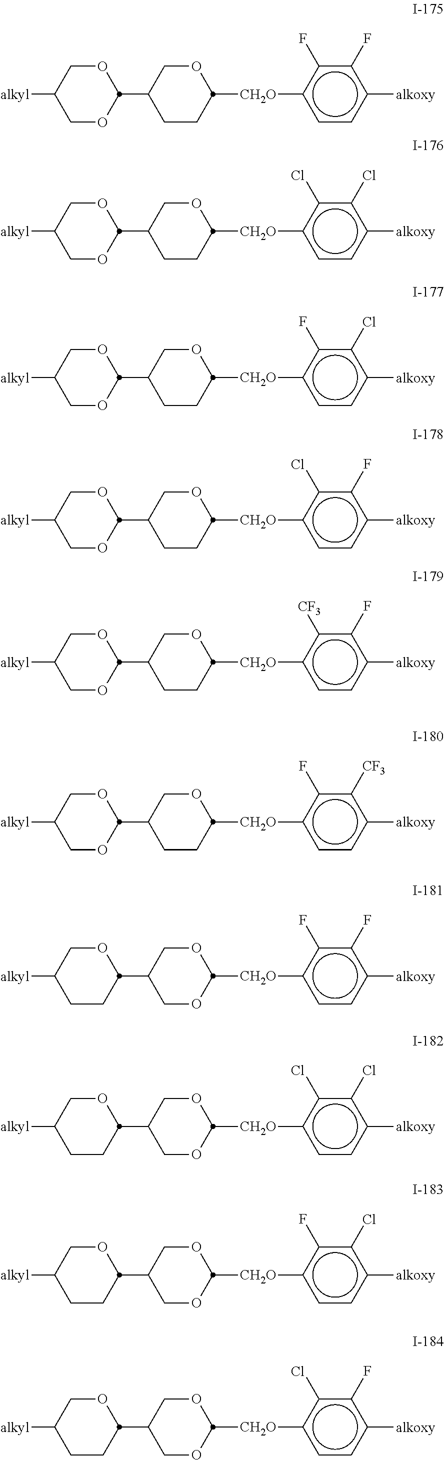

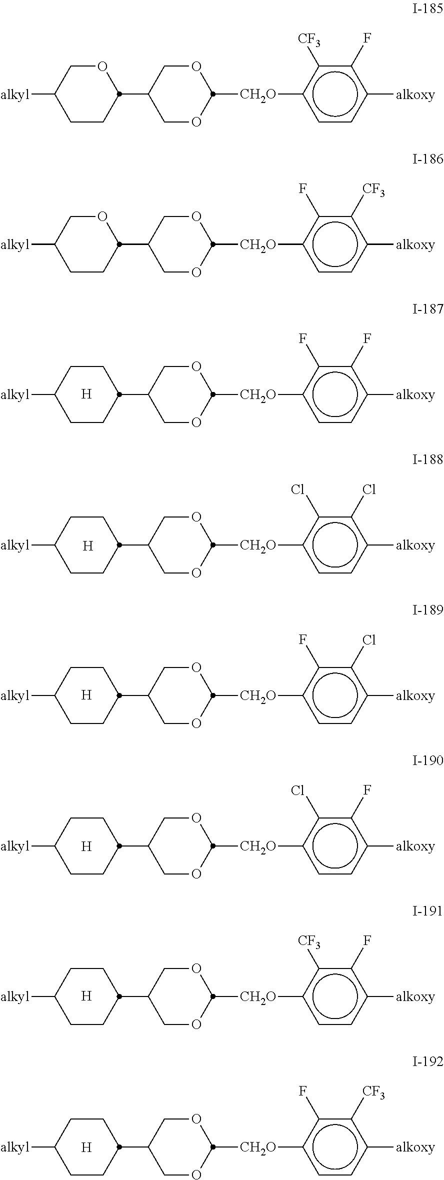

in which

alkyl and alkyl* each, independently of one another, denote a straight-chain alkyl radical having 1-6 C atoms, alkoxy denotes a straight-chain alkoxy radical having 1-6 C atoms, and alkenyl denotes a straight-chain alkenyl radical having 2-6 C atoms.

Of the sub-formulae I-1 to I-192 indicated, particular preference is given to the compounds of the formulae I-1, I-13, I-73 and I-85.

The mixtures according to the invention very particularly preferably comprise at least one compound from the following group:

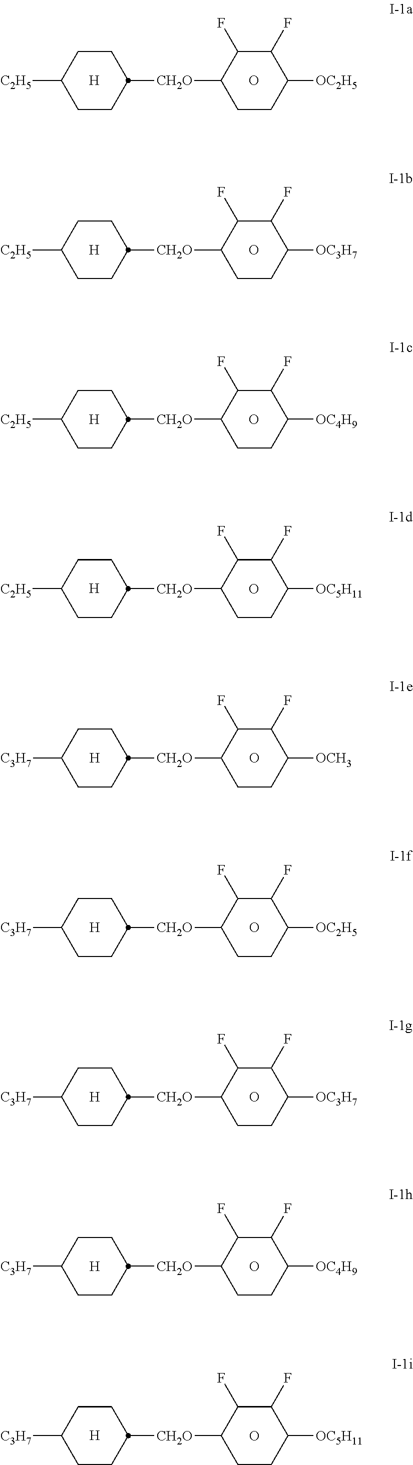

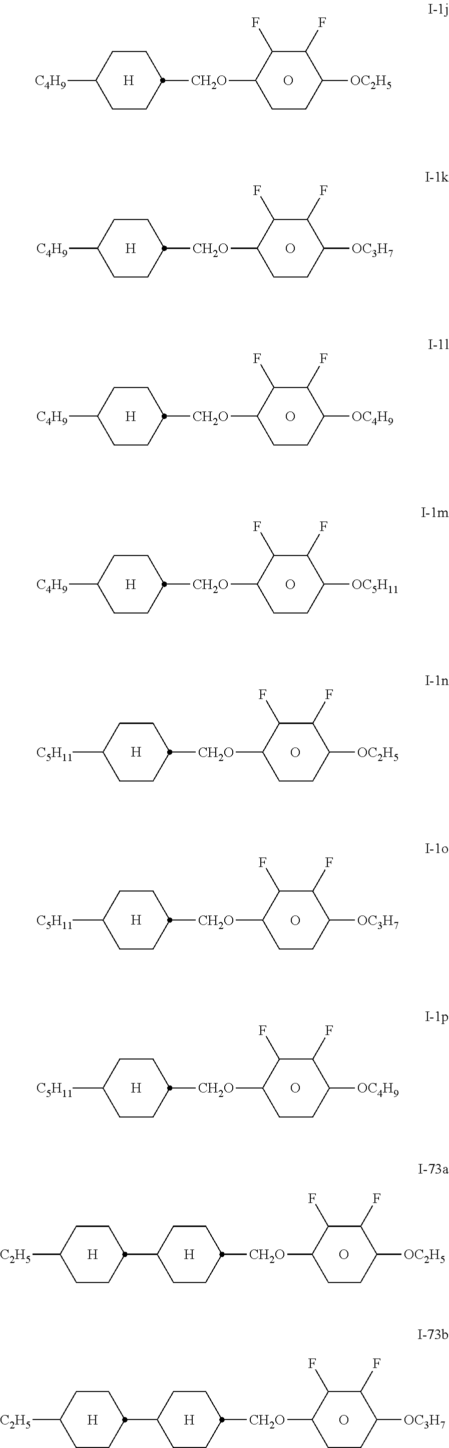

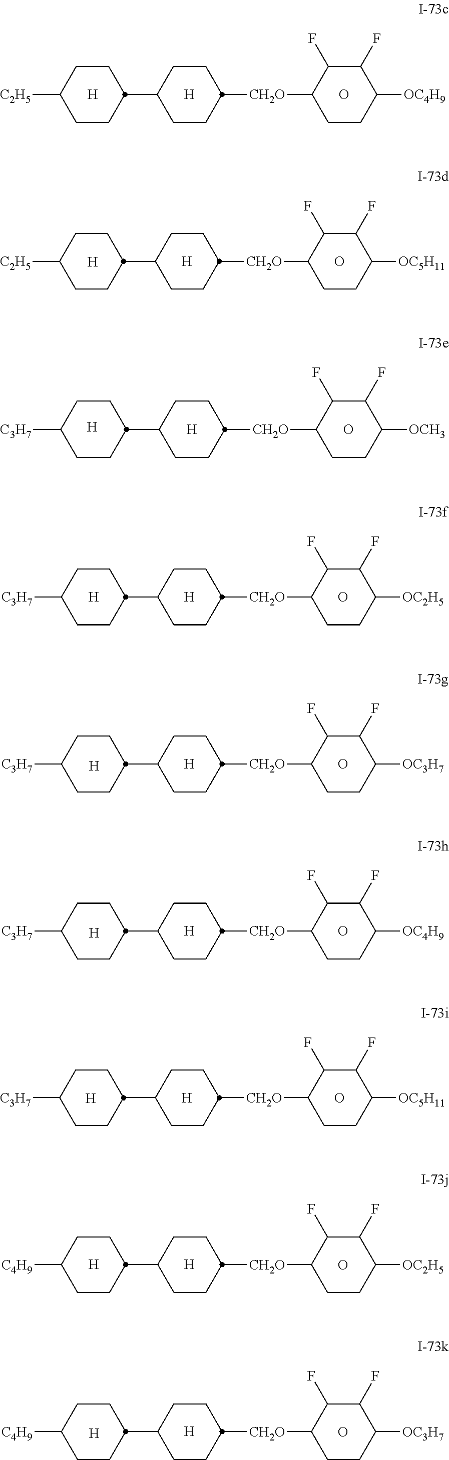

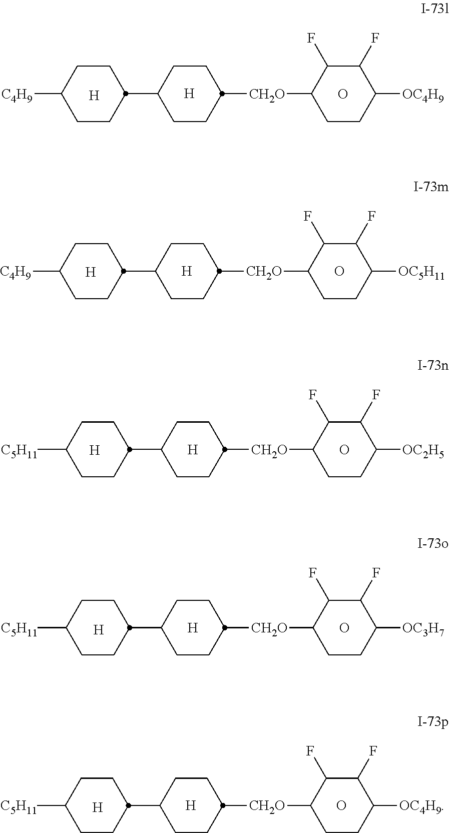

Of the preferred compounds of the formulae I-1a to I-1p and I-73a to I-73p, very particular preference is given, in particular, to the compounds of the formulae I-1f and I-73f.

The compounds of the formula I and the sub-formulae thereof are preferably employed in amounts of 1-15% by weight, preferably 1-10% by weight, per homologue and based on the mixture. If a plurality of compounds of the formula I are employed in the mixtures according to the invention, the total concentration of all compounds of the formula I is 1-30% by weight, preferably 1-20% by weight, based on the mixture.

In the compounds of the formula I and the sub-formulae, L¹ and L² each, independently of one another, preferably denote F or Cl, in particular L¹=L²=F, and R¹ preferably denotes straight-chain alkoxy, and R¹* preferably denotes straight-chain alkyl.

The compounds of the formula I can be prepared, for example, as follows:

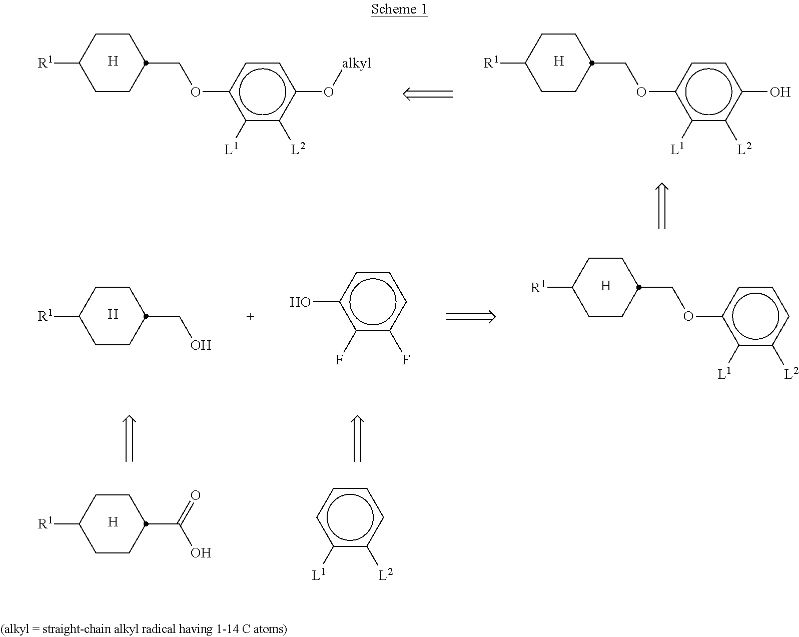

The media according to the invention preferably comprise one, two, three, four or more, preferably two or three, compounds of the formula I.

The compounds of the formula I are preferably employed in the liquid-crystalline medium in amounts of ≥1% by weight, preferably ≥5% by weight, based on the mixture as a whole. Particular preference is given to liquid-crystalline media which comprise 2-15% by weight of one or more compounds of the formula I.

Preferred embodiments of the liquid-crystalline medium according to the invention are indicated below:
a) Liquid-crystalline medium which additionally comprises one or more compounds selected from the group of the compounds of the formulae IIA, IIB and IIC,

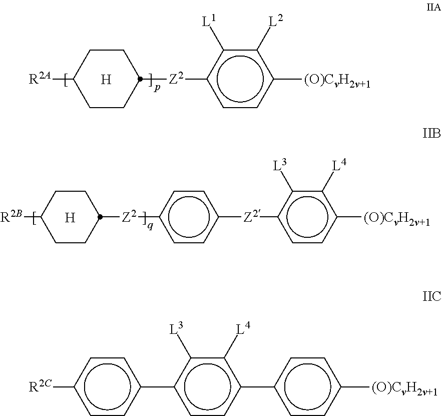

in which
R^{2A}, R^{2B} and R^{2C} each, independently of one another, denote H, an alkyl radical having up to 15 C atoms which is un-substituted, monosubstituted by CN or CF₃ or at least monosubstituted by halogen, where, in addition, one or more CH₂ groups in these radicals may be replaced by —O—, —S—,

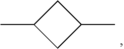

—C≡C—, —CF₂O—, —OCF₂—, —OC—O— or —O—CO— in such a way that O atoms are not linked directly to one another,
L¹⁻⁴ each, independently of one another, denote F, Cl, CF₃ or CHF₂,
Z² and Z^{2′} each, independently of one another, denote a single bond, —CH₂CH₂—, —CH═CH—, —CF₂O—, —OCF₂—, —COO—, —OCO—, —C₂F₄—, —CF═CF—, —CH═CHCH₂O—,
p denotes 1 or 2,
q denotes 0 or 1, and
v denotes 1 to 6.
In the compounds of the formulae IIA and IIB, Z² may have identical or different meanings. In the compounds of the formula IIB, Z² and Z^{2′} may have identical or different meanings.
In the compounds of the formulae IIA, IIB and IIC, R^{2A}, R^{2B} and R^{2C} each preferably denote alkyl having 1-6 C atoms, in particular CH₃, C₂H₅, n-C₃H₇, n-C₄H₉, n-O₅H₁₁.
In the compounds of the formulae IIA and IIB, L¹, L², L³ and L⁴ preferably denote L¹=L²=F and L³=L⁴=F, furthermore L¹=F and L²=Cl, L¹=Cl and L²=F, L³=F and L⁴=Cl, L³=Cl and L⁴=F. Z² and Z²′ in the formulae IIA and IIB preferably each, independently of one another, denote a single bond, furthermore a —C₂H₄— bridge.
If in the formula IIB Z²═—C₂H₄—, Z^{2′} is preferably a single bond or, if Z^{2′}═—C₂H₄—, Z² is preferably a single bond. In the compounds of the formulae IIA and IIB, (O)CᵥH₂ᵥ₊₁ preferably denotes OCᵥH₂ᵥ₊₁, furthermore C_{V}H₂ᵥ₊₁. In the compounds of the formula IIC, (O)CᵥH₂ᵥ₊₁ preferably denotes CᵥH₂ᵥ₊₁. In the compounds of the formula IIC, L³ and L⁴ preferably each denote F.
Preferred compounds of the formulae IIA, IIB and IIC are indicated below:

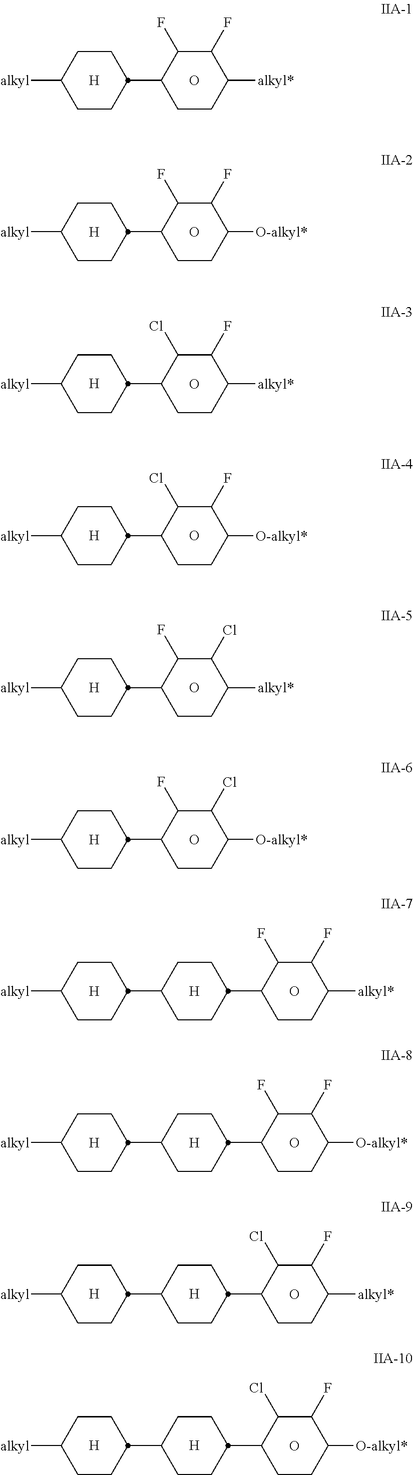

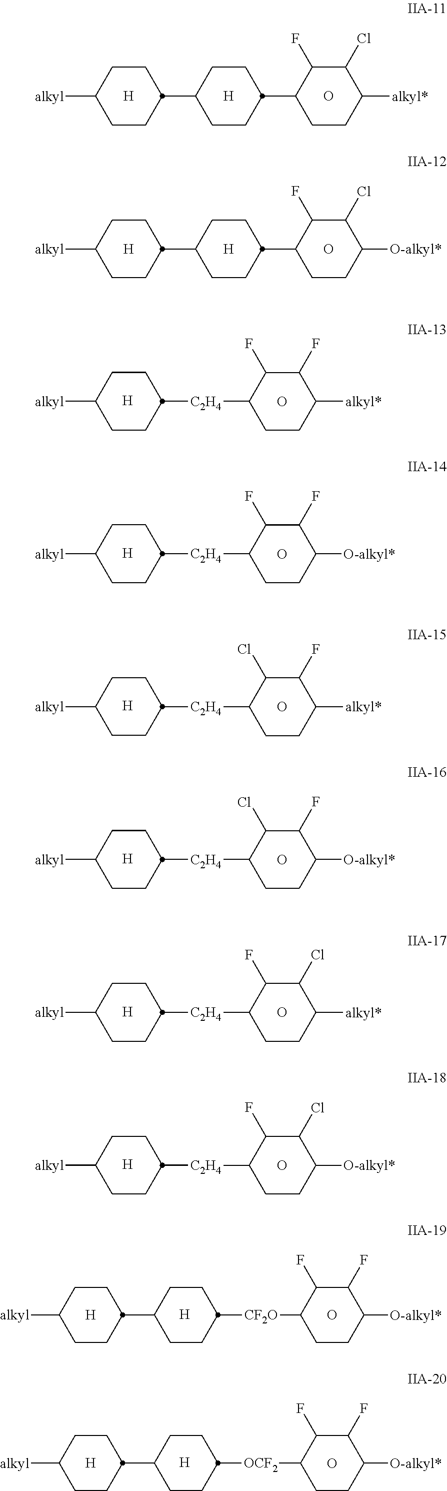

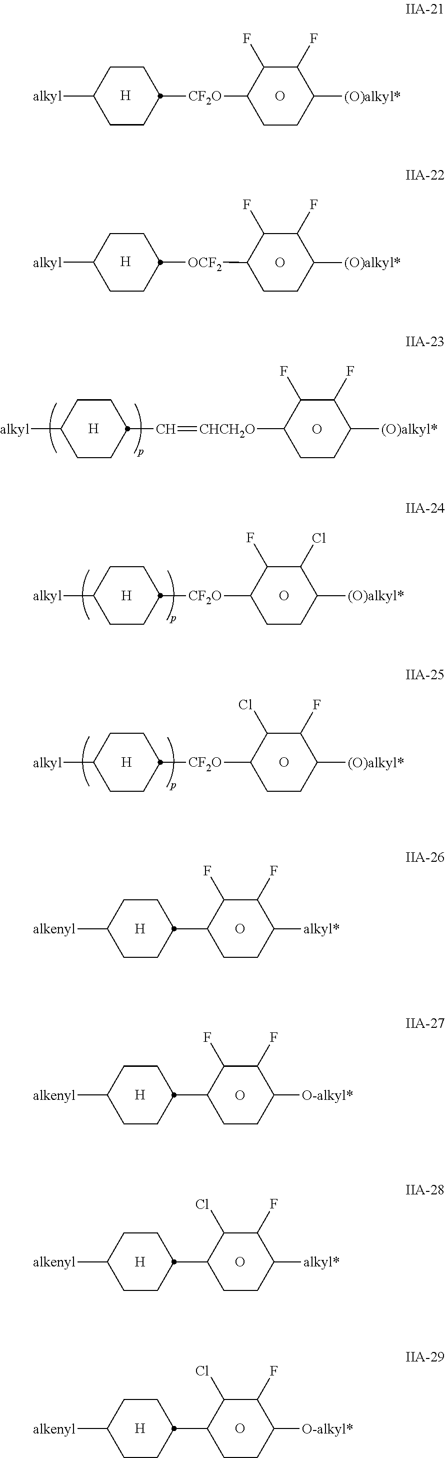

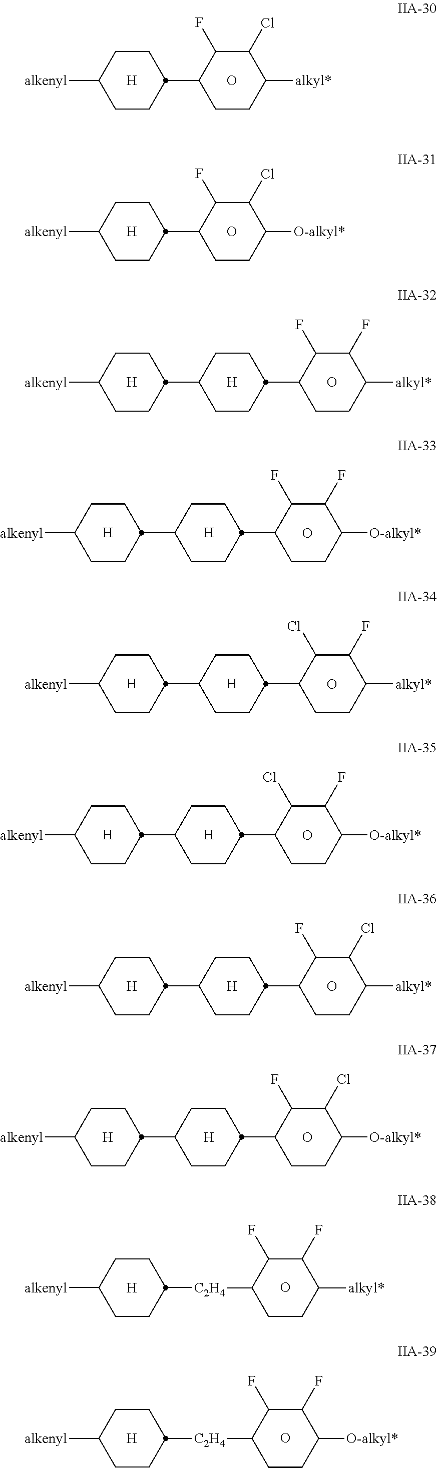

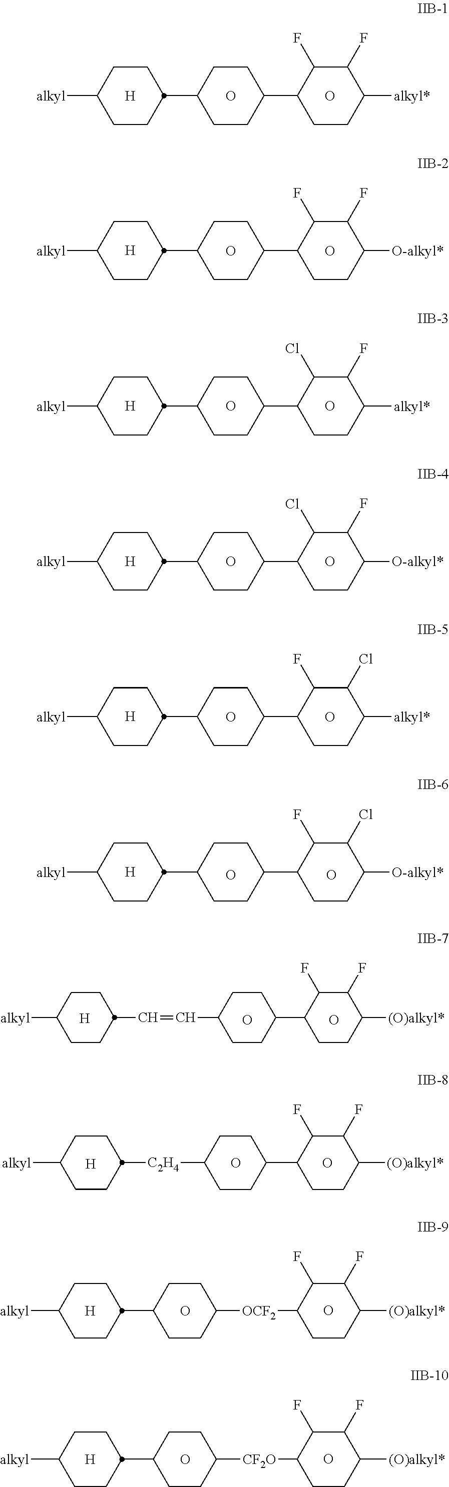

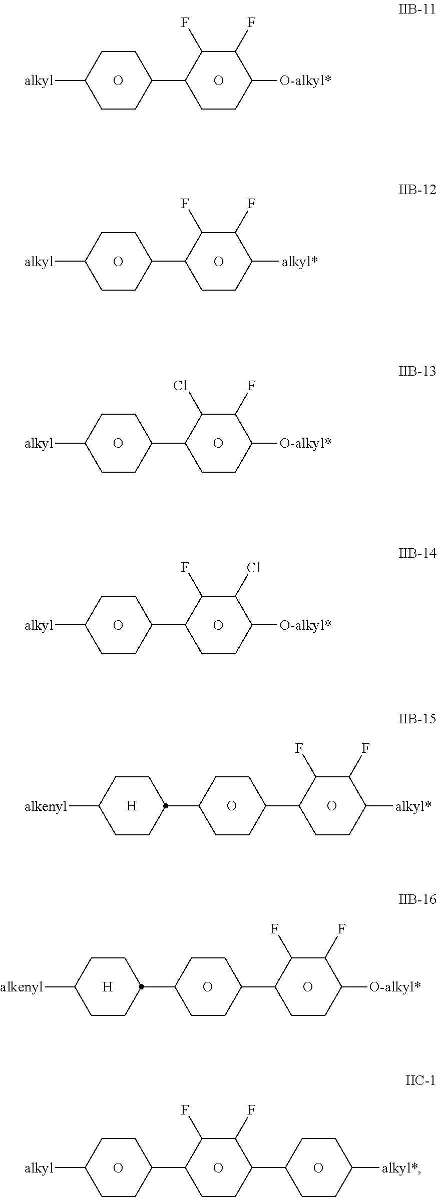

in which alkyl and alkyl* each, independently of one another, denote a straight-chain alkyl radical having 1-6 C atoms.
Particularly preferred mixtures according to the invention comprise one or more compounds of the formulae IIA-2, IIA-8, IIA-14, IIA-27, IIA-33, IIB-2, IIB-11, IIB-16 and IIC-1.
The proportion of compounds of the formulae IIA and/or IIB in the mixture as a whole is preferably at least 20% by weight.
Particularly preferred media according to the invention comprise at least one compound of the formula IIC-1,

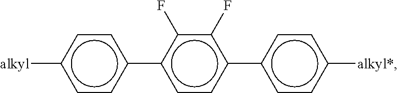

in which alkyl and alkyl* have the meanings indicated above, preferably in amounts of >3% by weight, in particular >5% by weight and particularly preferably 5-25% by weight.
b) Liquid-crystalline medium which additionally comprises one or more compounds of the formula III,

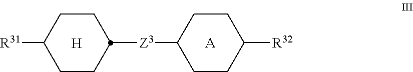

in which
R³¹ and R³² each, independently of one another, denote a straight-chain alkyl, alkoxyalkyl or alkoxy radical having up to 12 C atoms, and

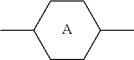

denotes

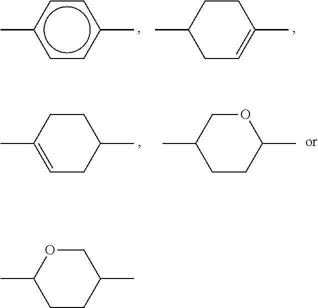

Z³ denotes a single bond, —CH₂CH₂—, —CH═CH—, —CF₂O—, —OCF₂—, —CH₂O—, —OCH₂—, —COO—, —C₂F₄, —C₄H₈—, —CF═CF—.
Preferred compounds of the formula III are indicated below:

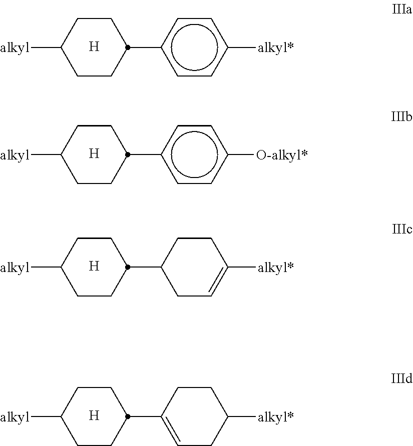

in which
alkyl and
alkyl* each, independently of one another, denote a straight-chain alkyl radical having 1-6 C atoms.
The medium according to the invention preferably comprises at least one compound of the formula IIIa and/or formula IIIb.
The proportion of compounds of the formula III in the mixture as a whole is preferably at least 5% by weight.
c) Liquid-crystalline medium additionally comprising a compound of the formula

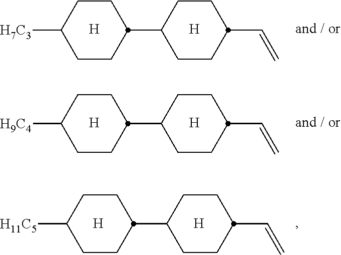

preferably in total amounts of 5% by weight, in particular 10% by weight.
Preference is furthermore given to mixtures according to the invention comprising the compound

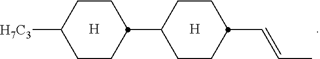

d) Liquid-crystalline medium which additionally comprises one or more tetracyclic compounds of the formulae

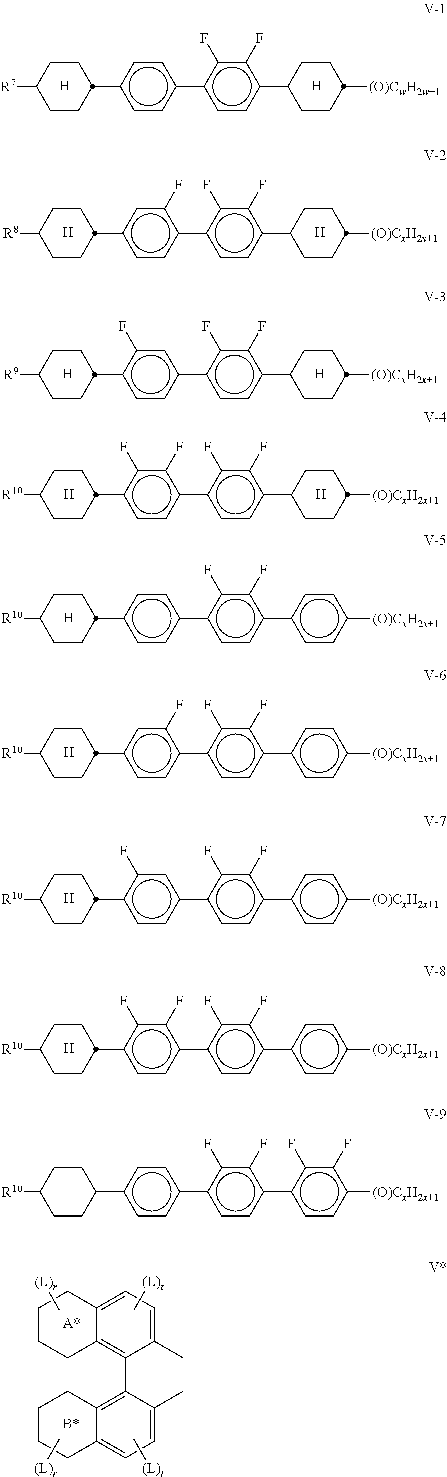

in which
R⁷⁻¹⁰ each, independently of one another, have one of the meanings indicated for R^{2A} in Claim 2, and
w and x each, independently of one another, denote 1 to 6.
Particular preference is given to mixtures comprising at least one compound of the formula V-9.
e) Liquid-crystalline medium which additionally comprises one or more compounds of the formulae Y-1 to Y-6,

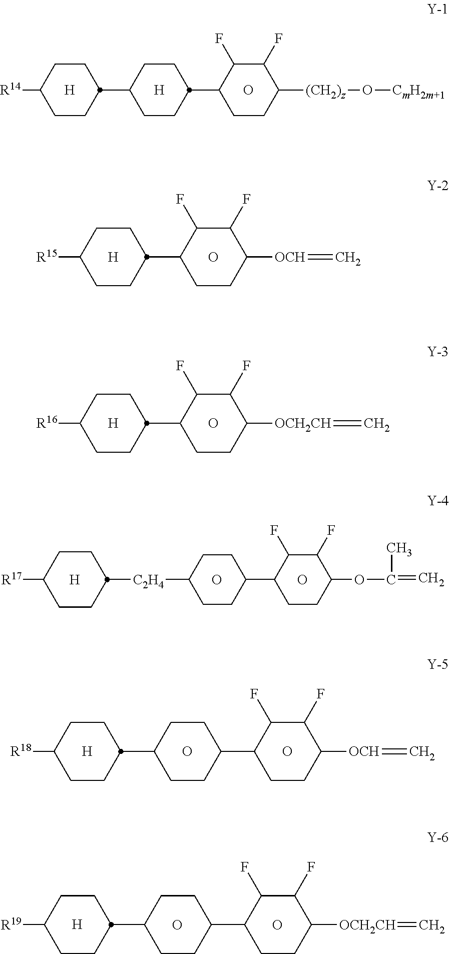

in which R¹⁴-R¹⁹ each, independently of one another, denote an alkyl or alkoxy radical having 1-6 C atoms; z and m each, independently of one another, denote 1-6; x denotes 0, 1, 2 or 3.
The medium according to the invention particularly preferably comprises one or more compounds of the formulae Y-1 to Y-6, preferably in amounts of ≥5% by weight.
f) Liquid-crystalline medium additionally comprising one or more fluorinated terphenyls of the formulae T-1 to T-21,

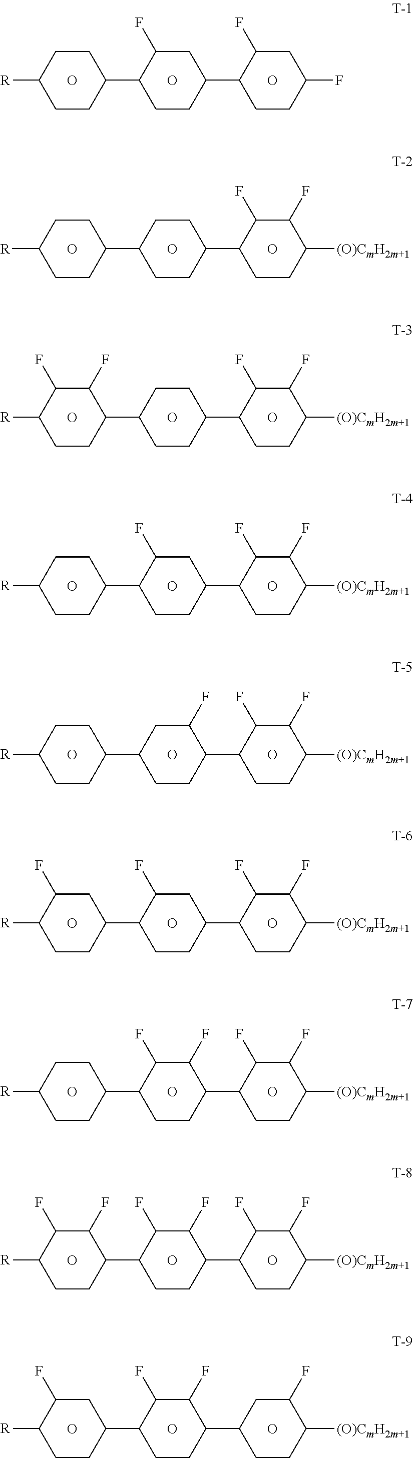

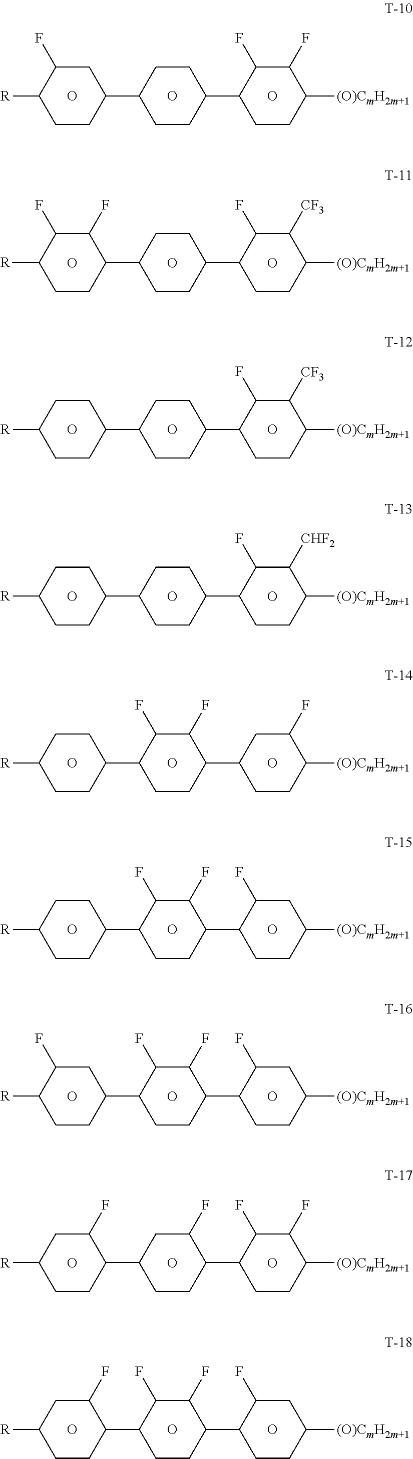

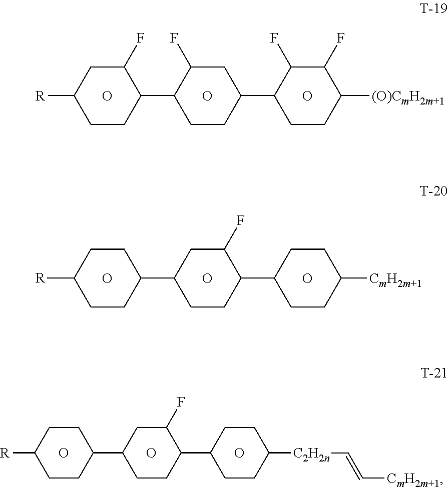

in which
R denotes a straight-chain alkyl or alkoxy radical having 1-7 C atoms, and m=0, 1, 2, 3, 4, 5 or 6 and n denotes 0, 1, 2, 3 or 4.
R preferably denotes methyl, ethyl, propyl, butyl, pentyl, hexyl, methoxy, ethoxy, propoxy, butoxy, pentoxy.
The medium according to the invention preferably comprises the terphenyls of the formulae T-1 to T-21 in amounts of 2-30% by weight, in particular 5-20% by weight.
Particular preference is given to compounds of the formulae T-1, T-2, T-20 and T-21. In these compounds, R preferably denotes alkyl, furthermore alkoxy, each having 1-5 C atoms. In the compounds of the formula T-20, R preferably denotes alkyl or alkenyl, in particular alkyl. In the compound of the formula T-21, R preferably denotes alkyl.
The terphenyls are preferably employed in the mixtures according to the invention if the Δn value of the mixture is to be ≥0.1. Preferred mixtures comprise 2-20% by weight of one or more terphenyl compounds selected from the group of the compounds T-1 to T-21.
g) Liquid-crystalline medium additionally comprising one or more biphenyls of the formulae B-1 to B-4,

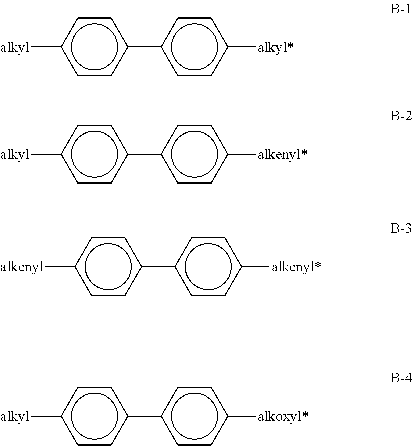

in which
alkyl and alkyl* each, independently of one another, denote a straight-chain alkyl radical having 1-6 C atoms, and
alkoxy denotes a straight-chain alkoxy radical having 1-6 C atoms,
alkenyl and alkenyl* each, independently of one another, denote a straight-chain alkenyl radical having 2-6 C atoms.
The proportion of the biphenyls of the formulae B-1 to B-4 in the mixture as a whole is preferably at least 3% by weight, in particular ≥5% by weight.
Of the compounds of the formulae B-1 to B-4, the compounds of the formula B-2 are particularly preferred.
Particularly preferred biphenyls are

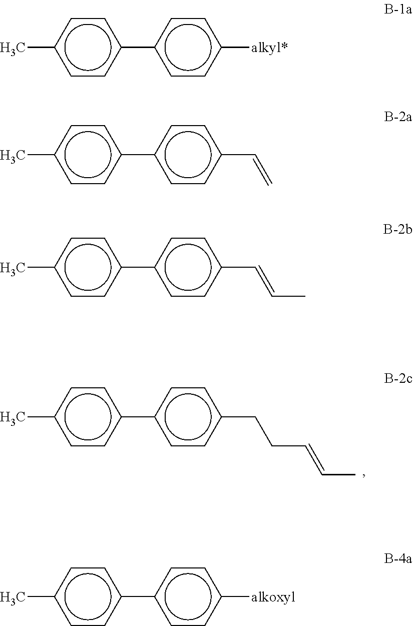

in which alkyl* denotes an alkyl radical having 1-6 C atoms. The medium according to the invention particularly preferably comprises one or more compounds of the formulae B-1a and/or B-2c.
h) Liquid-crystalline medium comprising at least one compound of the formulae Z-1 to Z-7,

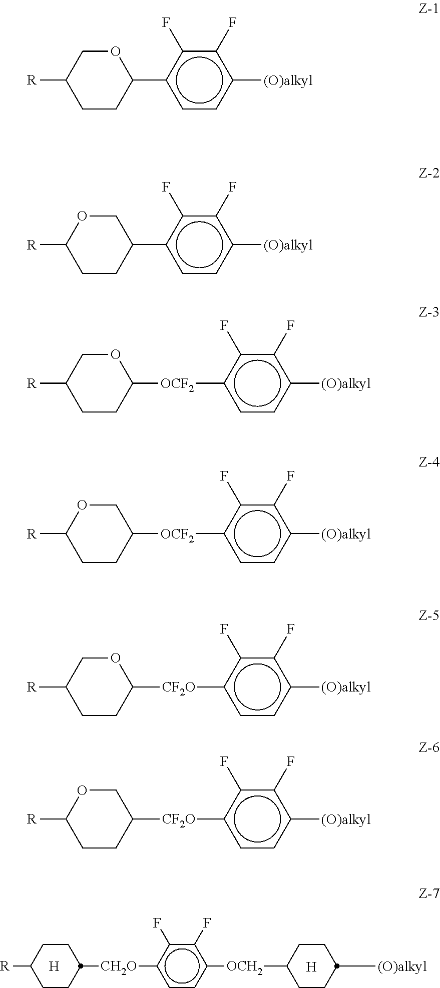

in which R and alkyl have the meanings indicated above.
i) Liquid-crystalline medium comprising at least one compound of the formulae O-1 to O-16,

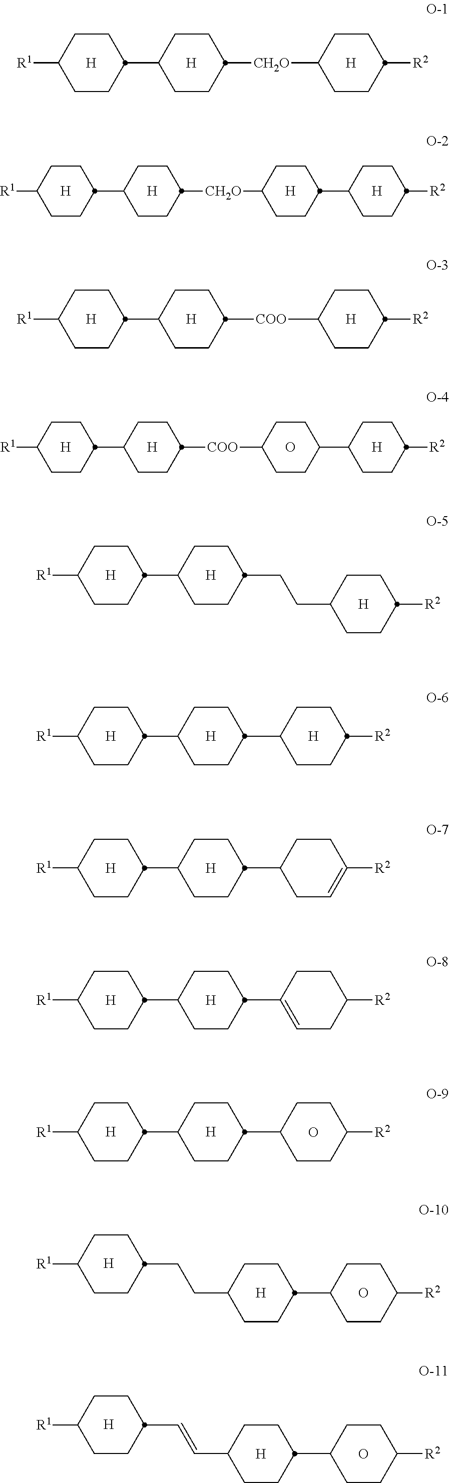

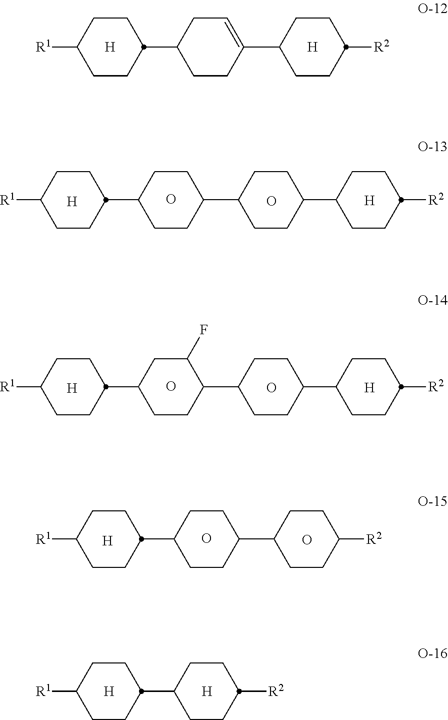

in which R¹ and R² have the meanings indicated for R^{2A}. R¹ and R² preferably each, independently of one another, denote straight-chain alkyl.
Preferred media comprise one or more compounds of the formulae O-1, O-3, O-4, O-5, O-9, O-13, O-14, O-15 and/or O-16.
Mixtures according to the invention very particularly preferably comprise the compounds of the formula O-9, O-15 and/or O-16, in particular in amounts of 5-30%.
Preferred compounds of the formulae O-15 and O-16 are indicated below:

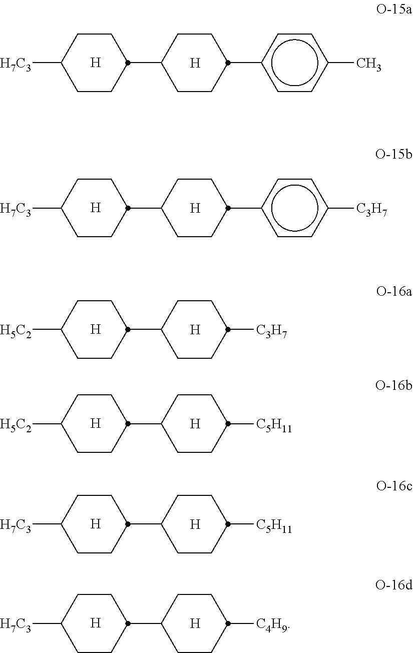

The medium according to the invention particularly preferably comprises the tricyclic compounds of the formula O-15a and/or of the formula O-15b in combination with one or more bicyclic compounds of the formulae O-16a to O-16d. The total proportion of the compounds of the formulae O-15a and/or O-15b in combination with one or more compounds selected from the bicyclic compounds of the formulae O-16a to O-16d is 5-40%, very particularly preferably in amounts of 15-35%, based on the mixture.
Very particularly preferred mixtures comprise compounds O-15a and O-16a:

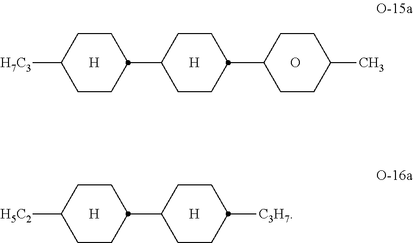

Compounds O-15a and O-16a are preferably present in the mixture in a concentration of 15-35%, particularly preferably 15-25% and especially preferably 18-22%, based on the mixture as a whole.
Very particularly preferred mixtures comprise compounds O-15b and O-16a:

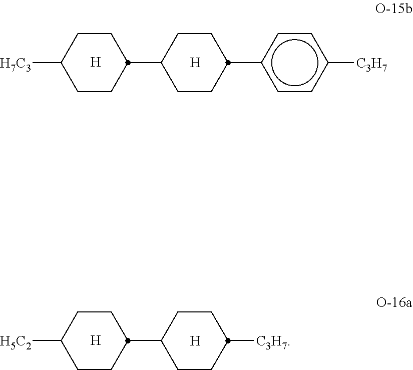

Compounds O-15b and O-16a are preferably present in the mixture in a concentration of 15-35%, particularly preferably 15-25% and especially preferably 18-22%, based on the mixture as a whole.
Very particularly preferred mixtures comprise the following three compounds:

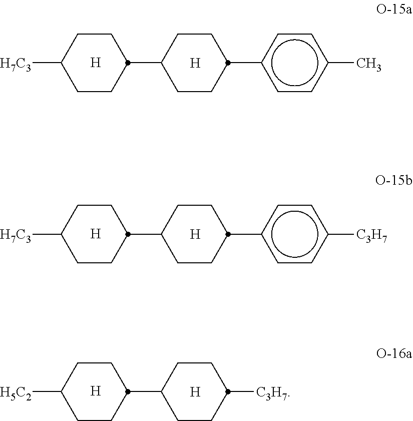

Compounds O-15a, O-15b and O-16a are preferably present in the mixture in a concentration of 15-35%, particularly preferably 15-25% and especially preferably 18-22%, based on the mixture as a whole.
j) Preferred liquid-crystalline media according to the invention comprise one or more substances which contain a tetrahydronaphthyl or naphthyl unit, such as, for example, the compounds of the formulae N-1 to N-5,

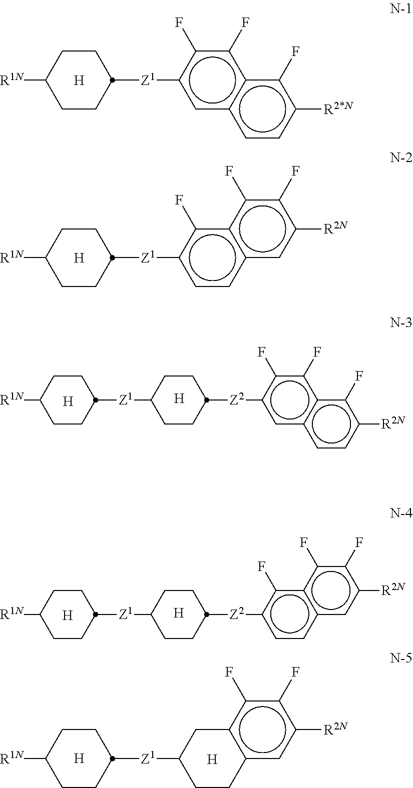

in which R^{1N} and R^{2N} each, independently of one another, have the meanings indicated for R^{2A}, preferably denote straight-chain alkyl, straight-chain alkoxy or straight-chain alkenyl, and
Z¹ and Z² each, independently of one another, denote —C₂H₄—, —CH═CH—, —(CH₂)₄—, —(CH₂)₃O—, —O(CH₂)₃—, —CH═CHCH₂CH₂—, —CH₂CH₂CH═CH—, —CH₂O—, —OCH₂—, —COO—, —OCO—, —C₂F₄—, —CF═CF—, —CF═CH—, —CH═CF—, —CF₂O—, —OCF₂—, —CH₂— or a single bond.
k) Preferred mixtures comprise one or more compounds selected from the group of the difluorodibenzochroman compounds of the formula BC, chromans of the formula CR, fluorinated phenanthrenes of the formulae PH-1 and PH-2, fluorinated dibenzofurans of the formula BF,

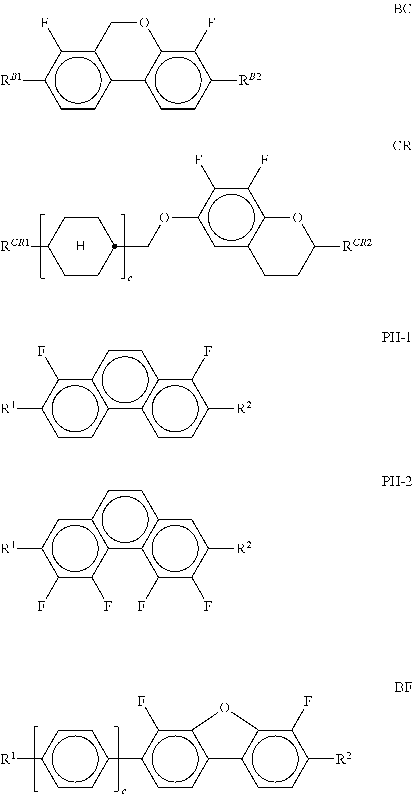

in which
R^{B1}, R^{B2}, R^{CR1}, R^{CR2}, R¹, R² each, independently of one another, have the meaning of R^{2A}. c is 0, 1 or 2.
The mixtures according to the invention preferably comprise the compounds of the formulae BC, CR, PH-1, PH-2 and/or BF in amounts of 3 to 20% by weight, in particular in amounts of 3 to 15% by weight. Particularly preferred compounds of the formulae BC and CR are the compounds BC-1 to BC-7 and CR-1 to CR-5,

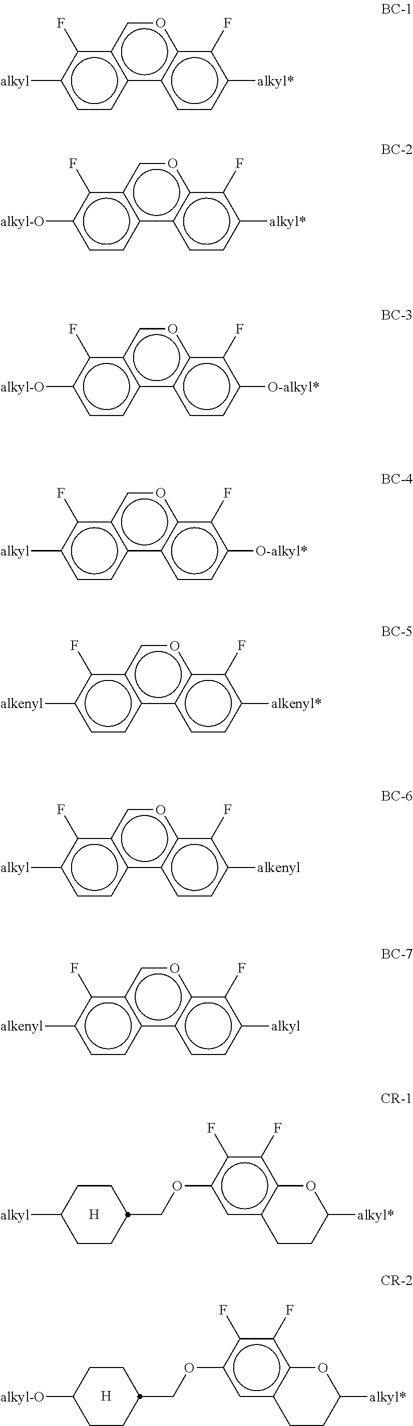

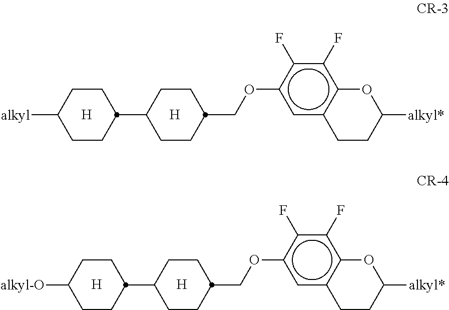

in which
alkyl and alkyl* each, independently of one another, denote a straight-chain alkyl radical having 1-6 C atoms, and
alkenyl and
alkenyl* each, independently of one another, denote a straight-chain alkenyl radical having 2-6 C atoms.
Very particular preference is given to mixtures comprising one, two or three compounds of the formula BC-2.
l) Preferred mixtures comprise one or more indane compounds of the formula In,

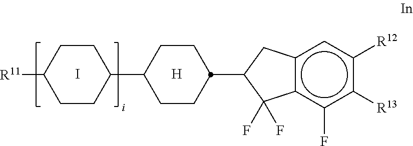

in which
R¹¹, R¹²,
R¹³ each, independently of one another, denote a straight-chain alkyl, alkoxy, alkoxyalkyl or alkenyl radical having 1-6 C atoms,
R¹² and R¹³ additionally denote halogen, preferably F,

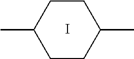

denotes

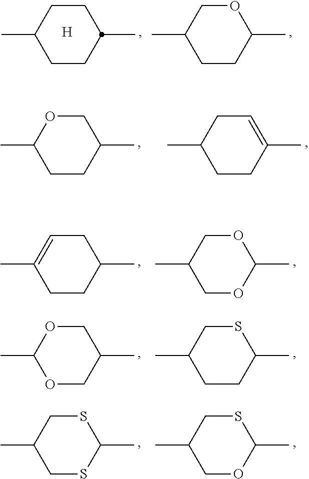

i denotes 0, 1 or 2.
Preferred compounds of the formula In are the compounds of the formulae In-1 to In-16 indicated below:

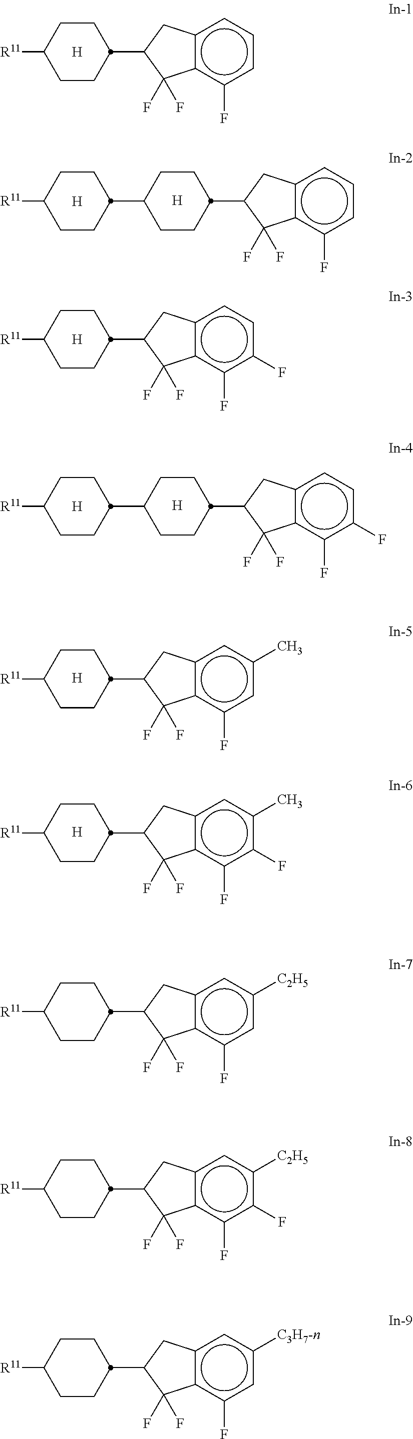

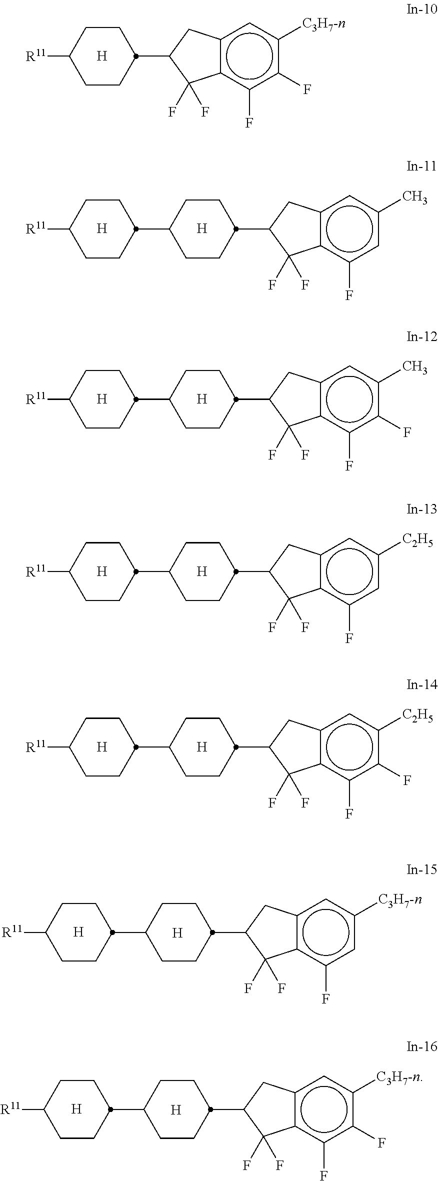

Particular preference is given to the compounds of the formulae In-1, In-2, In-3 and In-4.
The compounds of the formula In and the sub-formulae In-1 to In-16 are preferably employed in the mixtures according to the invention in concentrations ≥5% by weight, in particular 5-30% by weight and very particularly preferably 5-25% by weight.
m) Preferred mixtures additionally comprise one or more compounds of the formulae L-1 to L-11,

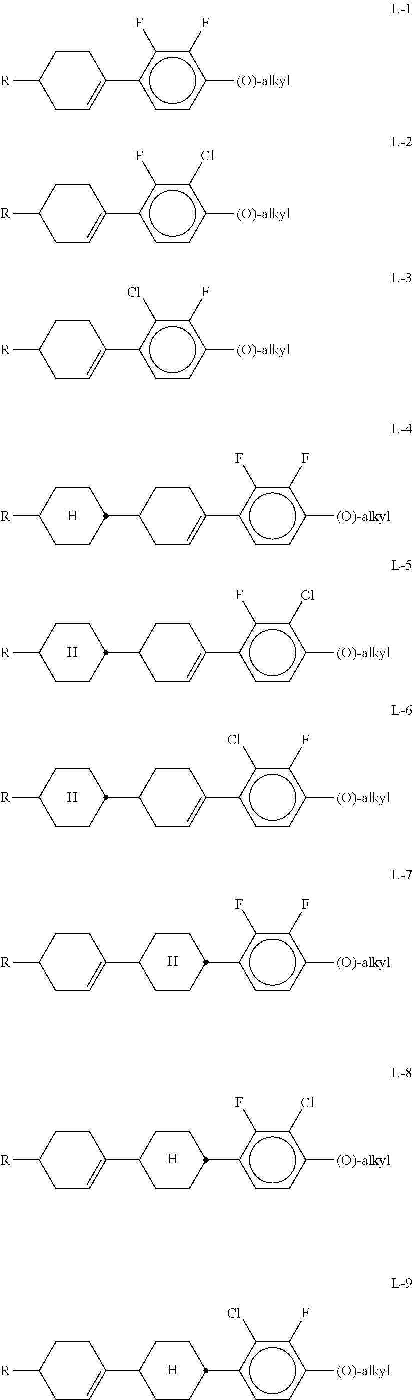

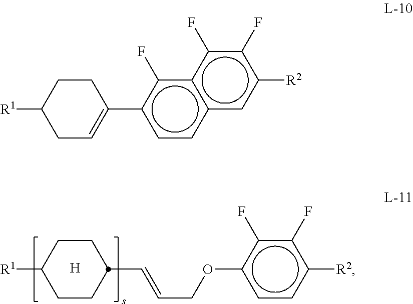

in which
R, R¹ and R² each, independently of one another, have the meanings indicated for R^{2A} in Claim 2, and alkyl denotes an alkyl radical having 1-6 C atoms. s denotes 1 or 2.
Particular preference is given to the compounds of the formulae L-1 and L-4, in particular L-4.
The compounds of the formulae L-1 to L-11 are preferably employed in concentrations of 5-50% by weight, in particular 5-40% by weight and very particularly preferably 10-40% by weight.
n) The medium additionally comprises one or more compounds of the formula EY

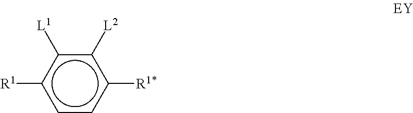

in which R¹, R¹*, L¹ and L² have the meanings indicated in formula I. In the compounds of the formula EY, R¹ and R¹* preferably denote alkoxy having ≥2 C atoms, and L¹=L²=F. Particular preference is given to the compounds of the formulae

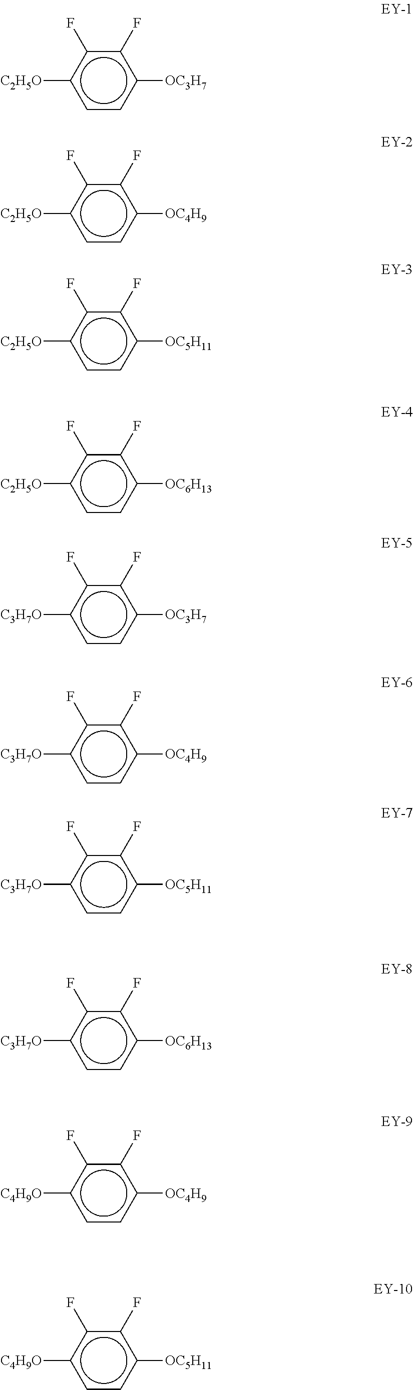

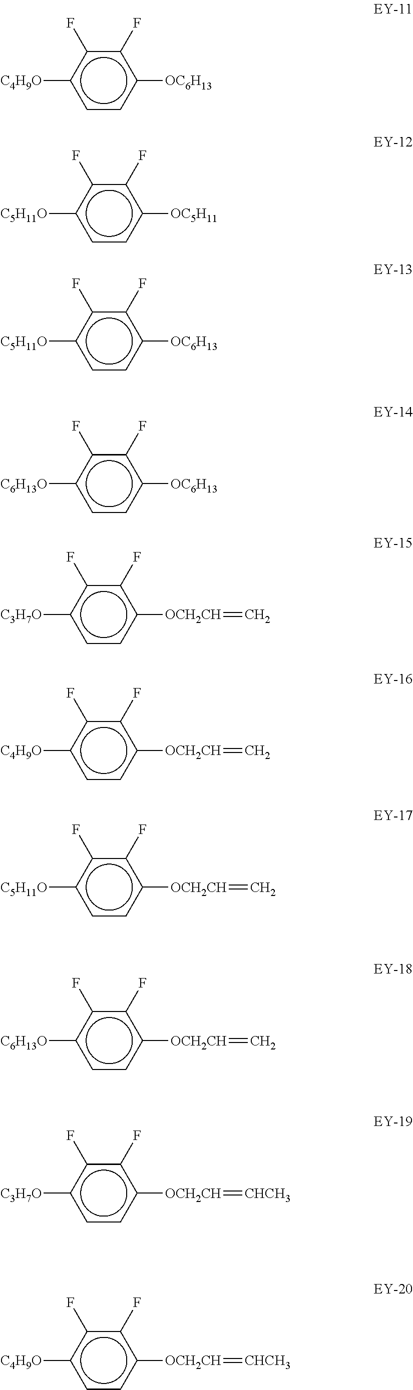

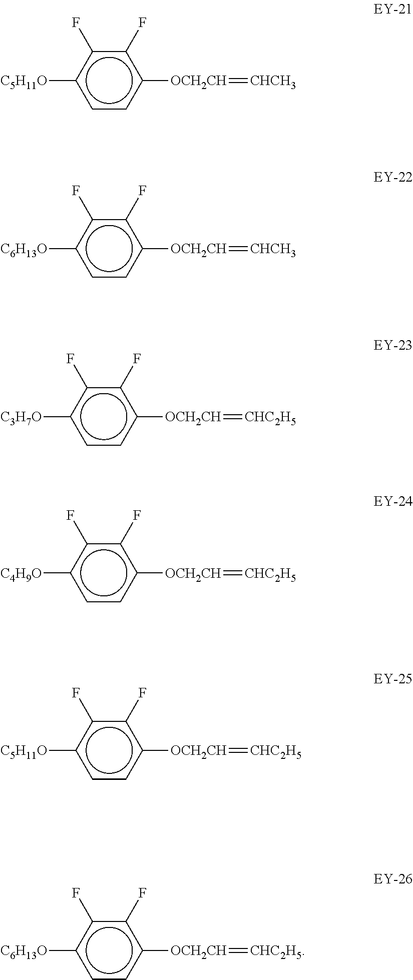

Particularly preference is given to the compounds of the formulae EY-1 to EY-12, in particular EY-2, EY-9 and EY-10.
o) The medium additionally comprises one or more tolan compounds of the formulae To-1 to To-12,

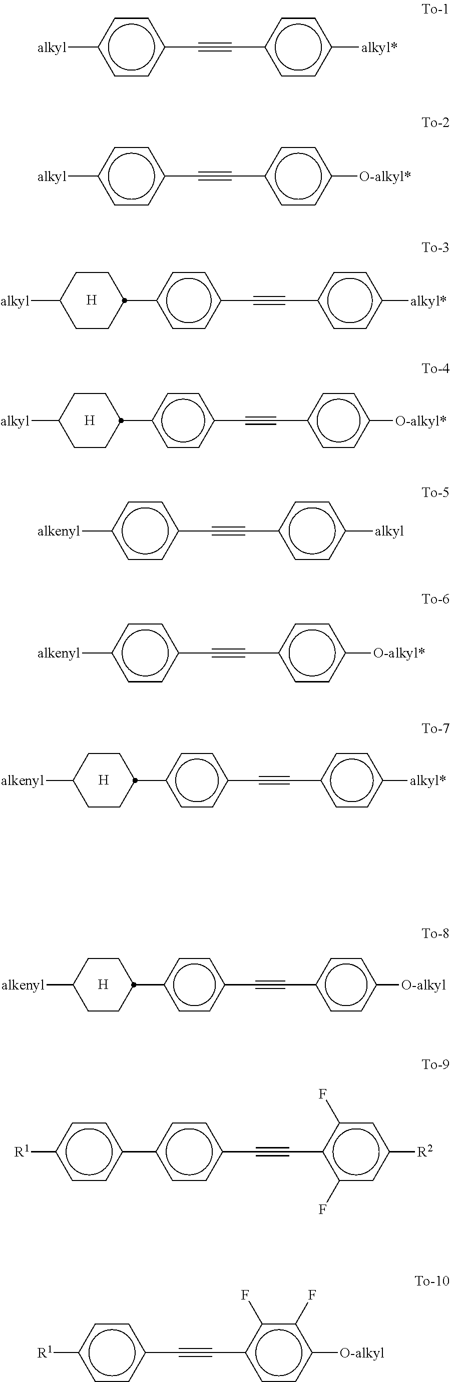

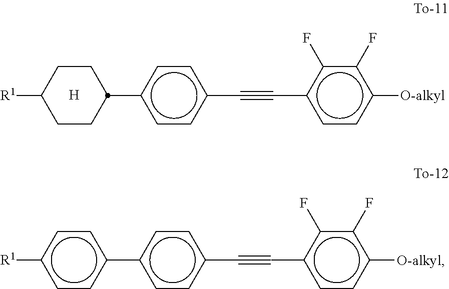

in which
R¹ and R² each, independently of one another, have the meaning of R¹ in Claim 1, preferably denote straight-chain alkyl, alkoxy or alkenyl, in particular straight-chain alkyl having 1 to 6 C atoms,
alkyl and alkyl* each, independently of one another, denote a straight-chain alkyl radical having 1-6 C atoms, alkoxy denotes a straight-chain alkoxy radical having 1-6 C atoms, and alkenyl denotes a straight-chain alkenyl radical having 2-6 C atoms.
Particularly preferred tolans are the compounds of the formulae To-1, To-2, To-4, To-9, To-10 and To-11.

Very particularly preferred mixture concepts are indicated below: (the acronyms used are explained in Table A. n and m here each, independently of one another, denote 1-6).

Preferred mixture concepts preferably comprise
the compound(s) of the formula I in which L¹=L²=F and R¹=alkyl and R¹*=alkoxy;
at least one compound of the formula I-1;
at least one compound of the formula I-73;
at least one compound of the formula I-1a (acronym: COY-n-Om);
at least one compound of the formula I-73a (acronym: CCOY-n-Om);
at least one compound of the formula I-1a (acronym: COY-n-Om) and at least one compound of the formula I-73a (acronym: CCOY-n-Om);
at least two compounds of the formula I-1a (acronym: COY-n-Om) and at least one compound of the formula I-73a (acronym: CCOY-n-Om);
at least 10% by weight of one or more compounds of the formula I-1a (acronym: COY-n-Om) and at least 10% by weight of one or more compounds of the formula I-73a (acronym: CCOY-n-Om), in each case based on the mixture;
COY-3-O2 and CCOY-3-O2;
COY-3-O2 and CCOY-2-O2;
COY-3-O2 and CCOY-3-O2 and CCOY-2-O2;
at least one compound of the formula I-1a and at least one compound of the formula CY-n-Om; preferably COY-3-O2 and CY-3-O2
at least one compound of the formula COY-n-Om and at least one compound of the formula CCY-n-Om, preferably COY-3-O2 in combination with at least one compound selected from the group of the compounds of the formulae CCY-3-O2, CCY-3-O1, CCY-3-O3 and CCY-4-O2;
at least one compound of the formula CCOY-n-Om and at least one compound of the formula CCY-n-Om, preferably CCOY-3-O2 in combination with at least one compound selected from the group of the compounds of the formulae CCY-3-O2, CCY-3-O1, CCY-3-O3 and CCY-4-O2;
at least one compound of the formula COY-n-Om and at least one compound of the formula CPY-n-Om, preferably COY-3-O2 and at least one compound selected from the group of the compounds of the formulae CPY-2-O2, CPY-3-O2, CPY-3-O3, CPY-3-O4, CPY-4-O3 and CPY-5-O3;
at least one compound of the formula CCOY-n-Om and at least one compound of the formula CPY-n-Om, preferably CCOY-3-O2 and at least one compound selected from the group of the compounds of the formulae CPY-2-O2, CPY-3-O2, CPY-3-O3, CPY-3-O4, CPY-4-O3 and CPY-5-O3;
at least one compound of the formula COY-n-Om and at least one compound of the formula CCOY-n-Om and at least one compound of the formula CPY-n-Om, preferably COY-3-O2 and CCOY-3-O2 and at least one compound selected from the group of the compounds CPY-2-O2, CPY-3-O2, CPY-3-O3, CPY-3-O4, CPY-4-O3 and CPY-5-O3;
COY-3-O2 in combination with CPY-2-O2 and/or CPY-3-O2;
CCOY-3-O2 in combination with CPY-2-O2 and/or CPY-3-O2;
COY-3-O2 and CCOY-3-O2 in combination with CPY-2-O2 and/or CPY-3-O2;
at least one compound of the formula COY-n-Om and at least one compound of the formula CCH-nm, preferably COY-3-O2 in combination with at least one compound selected from the group of the compounds of the formulae CCH-23, CCH-25, CCH-34 and CCH-35;
at least one compound of the formula CCOY-n-Om and at least one compound of the formula CCH-nm, preferably CCOY-3-O2 in combination with at least one compound selected from the group of the compounds of the formulae CCH-23, CCH-25, CCH-34 and CCH-35;
at least one compound of the formula COY-n-Om and at least one compound of the formula CCOY-n-Om and at least one compound of the formula CCP-nm, preferably COY-3-O2 and CCOY-3-O2 in combination with CCP-31 and/or CCP-33;
at least one compound of the formula COY-n-Om and at least one compound of the formula CCP-nm, preferably COY-3-O2 in combination with CCP-31 and/or CCP-33;
at least one compound of the formula CCOY-n-Om and at least one compound of the formula CCP-nm, preferably CCOY-3-O2 in combination with CCP-31 and/or CCP-33;
at least one compound of the formula COY-n-Om and at least one compound of the formula CCOY-n-Om and at least one compound of the formula CCP-nm, preferably COY-3-O2 and CCOY-3-O2 in combination with CCP-31 and/or CCP-33;
at least one compound of the formula COY-n-Om and at least one compound of the formula PYP-n-m, preferably COY-3-O2 in combination with PYP-2-3 and/or PYP-2-4;
at least one compound of the formula COY-n-Om and at least one compound of the formula CCOY-n-Om and at least one compound of the formula PYP-n-m, preferably COY-3-O2 and CCOY-3-O2 in combination with PYP-2-3 and/or PYP-2-4;
at least one compound of the formula COY-n-Om and at least one compound of the formula Y-nO-Om, preferably COY-3-O2 in combination with at least one compound selected from the group of the compounds of the formulae Y-2O-O3, Y-2O-O4, Y-2O-O5, Y-3O-O4, Y-3O-O5, Y-4O-O4, Y-4O-O5;
at least one compound of the formula CCOY-n-Om and at least one compound of the formula Y-nO-Om, preferably CCOY-3-O2 in combination with at least one compound selected from the group of the compounds of the formulae Y-2O-O3, Y-2O-O4, Y-2O-O5, Y-3O-O4, Y-3O-O5, Y-4O-O4, Y-4O-O5;
at least one compound of the formula COY-n-Om and at least one compound of the formula CCOY-n-Om and at least one compound of the formula Y-nO-Om, preferably COY-3-O2 and CCOY-3-O2 in combination with at least one compound selected from the group of the compounds of the formulae Y-2O-O3, Y-2O-O4, Y-2O-O5, Y-3O-O4, Y-3O-O5, Y-4O-O4, Y-4O-O5;
in each case at least one compound of the formulan CPY-n-Om+CCY-n-Om+COY-n-Om+CCOY-n-Om;
at least one compound of the formula COY-n-Om and at least one compound of the formula CLY-n-Om;
at least one compound of the formula CCOY-n-Om and at least one compound of the formula CLY-n-Om;
at least one compound of the formula COY-n-Om and at least one compound of the formula CCOY-n-Om and at least one compound of the formula CLY-n-Om;
at least one compound of the formula COY-n-Om in combination with PP-1-2V1;
at least one compound of the formula CCOY-n-Om in combination with PP-1-2V1;
at least one compound of the formula COY-n-Om and at least one compound of the formula CCOY-n-Om in combination with PP-1-2V1;
at least one compound of the formula COY-n-Om in combination with CC-n-V1, preferably CC-3-V1;
at least one compound of the formula CCOY-n-Om in combination with CC-n-V1, preferably CC-3-V1;
at least one compound of the formula COY-n-Om and at least one compound of the formula CCOY-n-Om in combination with CC-n-V1, preferably CC-3-V1;
at least one compound of the formula COY-n-Om in combination with PP-n-Om and/or PP-n-m;
at least one compound of the formula CCOY-n-Om in combination with PP-n-Om and/or PP-n-m;
at least one compound of the formula COY-n-Om and at least one compound of the formula CCOY-n-Om in combination with PP-n-Om and/or PP-n-m;
at least one compound of the formula COY-n-Om and at least one compound of the formula CLY-n-Om in combination with PP-n-Om and/or PP-n-m;
at least one compound of the formula COY-n-Om and at least one compound of the formula CLY-n-Om in combination with PP-n-Om and PP-n-m;
at least one compound of the formula COY-n-Om and at least one compound of the formula CEY-n-Om;

Preference is furthermore given to mixtures which comprise the following mixture components:
CPY-n-Om, in particular CPY-2-O2, CPY-3-O2 and/or CPY-5-O2, preferably in concentrations >5%, in particular 10-30%, based on the mixture as a whole,
CY-n-Om, preferably CY-3-O2, CY-3-O4, CY-5-O2 and/or CY-5-O4, preferably in concentrations >5%, in particular 15-50%, based on the mixture as a whole,
   and/or
CCY-n-Om, preferably CCY-4-O2, CCY-3-O2, CCY-3-O3, CCY-3-O1 and/or CCY-5-O2, preferably in concentrations >5%, in particular 10-30%, based on the mixture as a whole,
   and/or
CLY-n-Om, preferably CLY-2-O4, CLY-3-O2 and/or CLY-3-O3, preferably in concentrations >5%, in particular 10-30%, bezogen auf the mixture as a whole,
   and/or
CK-n-F, preferably CK-3-F, CK-4-F and/or CK-5-F, preferably >5%, in particular 5-25%, based on the mixture as a whole.

Preference is furthermore given to mixtures according to the invention which comprise the following mixture concepts:

(n and m each, independently of one another, denote 1-6.)
CPY-n-Om and CY-n-Om, preferably in concentrations von 10-80% based on the mixture as a whole,
   and/or
CPY-n-Om and CK-n-F, preferably in concentrations von 10-70% based on the mixture as a whole,
   and/or
CPY-n-Om and CLY-n-Om, preferably in concentrations von 10-80% based on the mixture as a whole.

The invention furthermore relates to an electro-optical display having active-matrix addressing based on the ECB, VA, PS-VA, PALC, IPS, PS-IPS, FFS or PS-FFS effect, characterised in that it contains, as dielectric, a liquid-crystalline medium according to one or more of Claims 1 to 9.

The liquid-crystalline medium according to the invention preferably has a nematic phase from ≤−20° C. to ≥70° C., particularly preferably from ≤−30° C. to ≥80° C., very particularly preferably from ≤−40° C. to ≥90° C.

The expression “have a nematic phase” here means on the one hand that no smectic phase and no crystallisation are observed at low temperatures at the corresponding temperature and on the other hand that clearing still does not occur on heating from the nematic phase. The investigation at low temperatures is carried out in a flow viscometer at the corresponding temperature and checked by storage in test cells having a layer thickness corresponding to the electro-optical use for at least 100 hours. If the storage stability at a temperature of −20° C. in a corresponding test cell is 1000 h or more, the medium is referred to as stable at this temperature. At temperatures of −30° C. and −40° C., the corresponding times are 500 h and 250 h respectively. At high temperatures, the clearing point is measured by conventional methods in capillaries.

The liquid-crystal mixture preferably has a nematic phase range of at least 60 K and a flow viscosity v₂₀ of at most 30 mm²·s⁻¹ at 20° C.

The values of the birefringence Δn in the liquid-crystal mixture are generally between 0.07 and 0.16, preferably between 0.08 and 0.12.

The liquid-crystal mixture according to the invention has a Δε of −0.5 to −8.0, in particular −2.5 to −6.0, where Δε denotes the dielectric anisotropy. The rotational viscosity γ₁ at 20° C. is preferably ≤165 mPa·s, in particular ≤140 mPa·s.

The liquid-crystal media according to the invention have relatively low values for the threshold voltage (V₀). They are preferably in the range from 1.7 V to 3.0 V, particularly preferably ≤2.5 V and very particularly preferably ≤2.3 V.

For the present invention, the term “threshold voltage” relates to the capacitive threshold (V₀), also known as the Freedericks threshold, unless explicitly indicated otherwise.

In addition, the liquid-crystal media according to the invention have relatively high values for the voltage holding ratio in liquid-crystal cells.

In general, liquid-crystal media having a low addressing voltage or threshold voltage exhibit a lower voltage holding ratio than those having a higher addressing voltage or threshold voltage and vice versa.

For the present invention, the term “dielectrically positive compounds” denotes compounds having a Δε>1.5, the term “dielectrically neutral compounds” denotes those having −1.5≤Δε≤1.5 and the term “dielectrically negative compounds” denotes those having Δε<−1.5. The dielectric anisotropy of the compounds is determined here by dissolving 10% of the compounds in a liquid-crystalline host and determining the capacitance of the resultant mixture in at least one test cell in each case having a layer thickness of 20 μm with homeotropic and with homogeneous surface alignment at 1 kHz. The measurement voltage is typically 0.5 V to 1.0 V, but is always lower than the capacitive threshold of the respective liquid-crystal mixture investigated.

All temperature values indicated for the present invention are in ° C.

The mixtures according to the invention are suitable for all VA-TFT applications, such as, for example, VAN, MVA, (S)-PVA, ASV, PSA (polymer sustained VA) and PS-VA (polymer stabilized VA). They are furthermore suitable for IPS (in-plane switching) and FFS (fringe field switching) applications having negative Δε.

The nematic liquid-crystal mixtures in the displays according to the invention generally comprise two components A and B, which themselves consist of one or more individual compounds.

Component A has significantly negative dielectric anisotropy and gives the nematic phase a dielectric anisotropy of ≤−0.5. Besides one or more compounds of the formula I, it preferably comprises the compounds of the formulae IIA, IIB and/or IIC, furthermore compounds of the formula III.

The proportion of component A is preferably between 45 and 100%, in particular between 60 and 100%.

For component A, one (or more) individual compound(s) which has (have) a value of Δε−0.8 is (are) preferably selected. This value must be more negative, the smaller the proportion A in the mixture as a whole.

Component B has pronounced nematogeneity and a flow viscosity of not greater than 30 mm²·s⁻¹, preferably not greater than 25 mm²·s⁻¹, at 20° C.

Particularly preferred individual compounds in component B are extremely low-viscosity nematic liquid crystals having a flow viscosity of not greater than 18 mm²·s⁻¹, preferably not greater than 12 mm²·s⁻¹, at 20° C.

Component B is monotropically or enantiotropically nematic, has no smectic phases and is able to prevent the occurrence of smectic phases down to very low temperatures in liquid-crystal mixtures. For example, if various materials of high nematogeneity are added to a smectic liquid-crystal mixture, the nematogeneity of these materials can be compared through the degree of suppression of smectic phases that is achieved.

The mixture may optionally also comprise a component C, comprising compounds having a dielectric anisotropy of Δε≥1.5. These so-called positive compounds are generally present in a mixture of negative dielectric anisotropy in amounts of ≤20% by weight, based on the mixture as a whole.

A multiplicity of suitable materials is known to the person skilled in the art from the literature. Particular preference is given to compounds of the formula III.

In addition, these liquid-crystal phases may also comprise more than 18 components, preferably 18 to 25 components.

Besides one or more compounds of the formula I, the phases preferably comprise 4 to 15, in particular 5 to 12, and particularly preferably <10, compounds of the formulae IIA, IIB and/or IIC and optionally III.

Besides compounds of the formula I and the compounds of the formulae IIA, IIB and/or IIC and optionally III, other constituents may also be present, for example in an amount of up to 45% of the mixture as a whole, but preferably up to 35%, in particular up to 10%.

The other constituents are preferably selected from nematic or nematogenic substances, in particular known substances, from the classes of the azoxybenzenes, benzylideneanilines, biphenyls, terphenyls, phenyl or cyclohexyl benzoates, phenyl or cyclohexyl cyclohexanecarboxylates, phenylcyclohexanes, cyclohexylbiphenyls, cyclohexylcyclohexanes, cyclohexylnaphthalenes, 1,4-biscyclohexylbiphenyls or cyclohexylpyrimidines, phenyl- or cyclohexyldioxanes, optionally halogenated stilbenes, benzyl phenyl ethers, tolans and substituted cinnamic acid esters.

The most important compounds which are suitable as constituents of liquid-crystal phases of this type can be characterised by the formula IV

R²⁰-L-G-E-R²¹ IV

in which L and E each denote a carbo- or heterocyclic ring system from the group formed by 1,4-disubstituted benzene and cyclohexane rings, 4,4′-disubstituted biphenyl, phenylcyclohexane and cyclohexylcyclohexane systems, 2,5-disubstituted pyrimidine and 1,3-dioxane rings, 2,6-disubstituted naphthalene, di- and tetrahydronaphthalene, quinazoline and tetra-hydroquinazoline,

G denotes —CH═CH— 13 N(O)═N—

—CH═CQ— —CH═N(O)—

—C≡C— —CH₂—CH₂—

—CO—O— —CH₂—O—

—CO—S— —CH₂—S—

—CH═N— —COO—Phe-COO—

—CF₂O— —CF═CF—

—OCF₂— —OCH₂—

—(CH₂)₄— —(CH₂)₃O—

or a C—C single bond, Q denotes halogen, preferably chlorine, or —CN, and R²⁰ and R²¹ each denote alkyl, alkenyl, alkoxy, alkoxyalkyl or alkoxycarbonyloxy having up to 18, preferably up to 8, carbon atoms, or one of these radicals alternatively denotes CN, NC, NO₂, NCS, CF₃, SF₅, OCF₃, F, Cl or Br.

In most of these compounds, R²⁰ and R²¹ are different from one another, one of these radicals usually being an alkyl or alkoxy group. Other variants of the proposed substituents are also common. Many such substances or also mixtures thereof are commercially available. All these substances can be prepared by methods known from the literature.

It goes without saying for the person skilled in the art that the VA, IPS or FFS mixture according to the invention may also comprise compounds in which, for example, H, N, O, Cl and F have been replaced by the corresponding isotopes.

The LC media which can be used in accordance with the invention are prepared in a manner which is conventional per se, for example by mixing one or more of the above-mentioned compounds with one or more polymerisable compounds, as defined above, and optionally with further liquid-crystalline compounds and/or additives. In general, the desired amount of the components used in smaller amount is dissolved in the components making up the principal constituent, advantageously at elevated temperature. It is also possible to mix solutions of the components in an organic solvent, for example in acetone, chloroform or methanol, and to remove the solvent again, for example by distillation, after thorough mixing. The invention furthermore relates to a process for the preparation of the LC media according to the invention.

The mixtures according to the invention may furthermore comprise conventional additives, such as, for example, stabilisers, antioxidants, UV absorbers, nanoparticles, microparticles, etc.

The structure of the liquid-crystal displays according to the invention corresponds to the usual geometry, as described, for example, in EP-A 0 240 379.

The structure of the LC displays according to the invention corresponds to the usual geometry for PSA displays, as described in the prior art cited in the introduction. Geometries without protrusions are preferred, in particular those in which, in addition, the electrode on the colour-filter side is unstructured and only the electrode on the TFT side has slots. Particularly suitable and preferred electrode structures for PS-VA displays are described, for example, in US 2006/0066793 A1.

Combination of liquid-crystal mixtures according to the invention with the polymerised compounds mentioned above and below effects low threshold voltages, low rotational viscosity values and very good low-temperature stabilities in the LC media according to the invention with retention of high clearing points and high HR values, and allows the rapid establishment of a particularly low pre-tilt angle in PSA displays. In particular, the LC media exhibit significantly reduced response times, in particular also grey-shade response times, compared with the media from the prior art in PSA displays.

Polymerisable compounds, so-called reactive mesogens (RMs), for example as disclosed in U.S. Pat. No. 6,861,107, may furthermore be added to the mixtures according to the invention in concentrations of preferably 0.12-5% by weight, particularly preferably 0.2-2% by weight, based on the mixture. These mixtures may optionally also comprise an initiator, as described, for example, in U.S. Pat. No. 6,781,665. The initiator, for example Irganox-1076 from Ciba Chemicals, is preferably added to the mixture comprising polymerisable compounds in amounts of 0-1%. Mixtures of this type can be used for so-called polymer-stabilised VA modes (PS-VA) or PSA (polymer sustained VA), in which polymerisation of the reactive mesogens is intended to take place in the liquid-crystalline mixture. The prerequisite for this is that the liquid-crystal mixture does not itself comprise any polymerisable components.

The IPS and PSA displays according to the invention have two electrodes, preferably in the form of transparent layers, which are applied to one or both of the substrates which form the LC cell. Either in each case one electrode is applied to each of the two substrates, as, for example, in PSA-VA, PSA-OCB or PSA-TN displays according to the invention, or both electrodes are applied to only one of the two substrates, while the other substrate has no electrode, as, for example, in PSA-IPS or PSA-FFS displays according to the invention.

The following meanings apply above and below:

The term “PSA” is, unless indicated otherwise, used to represent PS displays and PSA displays.

The terms “tilt” and “tilt angle” relate to a tilted alignment of the LC molecules of a liquid-crystalline medium relative to the surfaces of the cell in an LC display (here preferably a PS or PSA display). The tilt angle here denotes the average angle (<90°) between the longitudinal molecular axes of the LC molecules (LC director) and the surface of the plane-parallel outer plates which form the LC cell. A low value for the tilt angle (i.e. a large deviation from the 90° angle) corresponds to a large tilt here. A suitable method for measurement of the tilt angle is given in the examples. Unless indicated otherwise, tilt angle values disclosed above and below relate to this measurement method.

The term “mesogenic group” is known to the person skilled in the art and is described in the literature, and denotes a group which, due to the anisotropy of its attracting and repelling interactions, essentially contributes to causing a liquid-crystal (LC) phase in low-molecular-weight or polymeric substances. Compounds containing mesogenic groups (mesogenic compounds) do not necessarily have to have an LC phase themselves. It is also possible for mesogenic compounds to exhibit LC phase behaviour only after mixing with other compounds and/or after polymerisation. Typical mesogenic groups are, for example, rigid rod- or disc-shaped units. An overview of the terms and definitions used in connection with mesogenic or LC compounds is given in Pure Appl. Chem. 73(5), 888 (2001) and C. Tschierske, G. Pelzl, S. Diele, Angew. Chem. 2004, 116, 6340-6368.

The term “spacer group”, also referred to as “Sp” above and below, is known to the person skilled in the art and is described in the literature, see, for example, Pure Appl. Chem. 73(5), 888 (2001) and C. Tschierske, G. Pelzl, S. Diele, Angew. Chem. 2004, 116, 6340-6368. Unless indicated otherwise, the term “spacer group” or “spacer” above and below denotes a flexible group which connects the mesogenic group and the polymerisable group(s) to one another in a polymerisable mesogenic compound.

The term “reactive mesogen” or “RM” denotes a compound containing one mesogenic group and one or more functional groups which are suitable for polymerisation (also referred to as polymerisable group or group P).

The terms “low-molecular-weight compound” and “unpolymerisable compound” denote compounds, usually monomeric, which contain no functional group which is suitable for polymerisation under the usual conditions known to the person skilled in the art, in particular under the conditions used for the polymerisation of RMs.

For the purposes of this invention, the term “liquid-crystalline medium” is intended to denote a medium which comprises an LC mixture and one or more polymerisable compounds (such as, for example, reactive mesogens). The term “LC mixture” (or “host mixture”) is intended to denote a liquid-crystalline mixture which consists exclusively of unpolymerisable, low-molecular-weight compounds, preferably of two or more liquid-crystal-line compounds and optionally further additives, such as, for example, chiral dopants or stabilisers. “Unpolymerisable” means that the compounds are stable or unreactive to a polymerisation reaction, at least under the conditions used for polymerisation of the polymerisable compounds.

Particular preference is given to liquid-crystalline mixtures which have a nematic phase, in particular a nematic phase at room temperature.

Preferred PS mixtures comprising at least one compound of the formula I are distinguished, in particular, as follows:
The concentration of the polymerisable component, based on the mixture as a whole, is 0.01-5% by weight, in particular 0.01-1% by weight and particularly preferably 0.01-0.5% by weight.
The liquid-crystalline medium comprises no compounds containing a terminal vinyloxy group (—O—CH═CH₂).
A PS-VA or PSA display containing a PS mixture according to the invention preferably has a pre-tilt angle of ≤85°, particularly preferably ≤80°.

In the VA-type displays according to the invention, the molecules in the layer of the liquid-crystalline medium in the switched-off state are aligned perpendicular to the electrode surfaces (homeotropically) or have a tilted homeotropic alignment. On application of an electrical voltage to the electrodes, a realignment of the LC molecules with the longitudinal molecular axes parallel to the electrode surfaces takes place.

LC mixtures according to the invention for use in displays of the VA type have a negative dielectric anisotropy Δε, preferably of −0.5 to −10, in particular −2.5 to −7.5, at 20° C. and 1 kHz.

The birefringence Δn in LC mixtures according to the invention for use in displays of the VA type is preferably below 0.16, particularly preferably between 0.06 and 0.14, in particular between 0.07 and 0.12.

The LC mixtures and LC media according to the invention may also comprise further additives known to the person skilled in the art and described in the literature, such as, for example, polymerisation initiators, inhibitors, stabilisers, surface-active substances or chiral dopants. These may be polymerisable or unpolymerisable. Polymerisable additives are accordingly classed in the polymerisable component or component A). Unpolymerisable additives are accordingly classed in the LC mixture (host mixture) or the unpolymerisable component or component B).

The LC mixtures and LC media may comprise, for example, one or more chiral dopants, preferably selected from the group consisting of compounds from Table B below.

Furthermore, 0 to 15%, preferably 0 to 10%, of one or more additives selected from the group comprising pleochroic dyes, nanoparticles, conductive salts, complex salts and substances for modifying the dielectric anisotropy, the viscosity and/or the alignment of the nematic phases can be added to the LC media. Suitable and preferred conductive salts are, for example, ethyldimethyldodecylammonium 4-hexoxybenzoate, tetrabutyl-ammonium tetraphenylborate or complex salts of crown ethers (cf., for example, Haller et al., Mol. Cryst. Liq. Cryst. 24, 249-258, 1973). Substances of this type are described, for example, in DE-A-22 09 127, DE-A-22 40 864, DE-A-23 21 632, DE-A-23 38 281, DE-A-24 50 088, DE-A-26 37 430 and DE-A-28 53 728.

For the production of PSA displays, the polymerisable compounds are polymerised or crosslinked (if a compound contains two or more polymerisable groups) by in-situ polymerisation in the liquid-crystalline medium between the substrates of the LC display with application of a voltage. The polymerisation can be carried out in one step. It is also possible firstly to carry out the polymerisation in a first step with application of a voltage in order to generate a pretilt angle, and subsequently, in a second polymerisation step, to polymerise or crosslink the compounds which have not reacted in the first step without an applied voltage (end curing).

Suitable and preferred polymerisation methods are, for example, thermal or photopolymerisation, preferably photopolymerisation, in particular UV photopolymerisation. If necessary, one or more initiators may also be added here. Suitable conditions for the polymerisation, and suitable types and amounts of initiators, are known to the person skilled in the art and are described in the literature. For example, the commercially available photoinitiators Irgacure651®, Irgacure184®, Irgacure907®, Irgacure369® or Darocure1173® (Ciba AG) are suitable for free-radical polymerisation. If an initiator is employed, its proportion is preferably 0.001 to 5%, particularly preferably 0.001 to 1%. However, the polymerisation can also be carried out without addition of an initiator. In a further preferred embodiment, the liquid-crystalline medium comprises no polymerisation initiator.

The polymerisable component A) or the liquid-crystalline medium may also comprise one or more stabilisers in order to prevent undesired spontaneous polymerisation of the RMs, for example during storage or transport. Suitable types and amounts of stabilisers are known to the person skilled in the art and are described in the literature. For example, the commercially available stabilisers from the Irganox® series (Ciba AG), such as, for example, Irganox® 1076, are particularly suitable. If stabilisers are employed, their proportion, based on the total amount of the RMs or the polymerisable component A), is preferably 10-10,000 ppm, particularly preferably 50-500 ppm.

The polymerisable compounds are also suitable for polymerisation without initiator, which is accompanied by considerable advantages, such as, for example, lower material costs and in particular less contamination of the liquid-crystalline medium by possible residual amounts of the initiator or degradation products thereof.

The LC media according to the invention for use in PSA displays preferably comprise ≤5%, particularly preferably ≤1%, very particularly preferably ≤0.5%, and preferably ≥0.01%, particularly preferably ≥0.1%, of polymerisable compounds, in particular polymerisable compounds of the formulae given above and below.

Particular preference is given to LC media comprising one, two or three polymerisable compounds.

Preference is furthermore given to achiral polymerisable compounds and to LC media in which the compounds of component A) and/or B) are selected exclusively from the group consisting of achiral compounds.

Preference is furthermore given to LC media in which the polymerisable component or component A) comprises one or more polymerisable compounds containing one polymerisable group (monoreactive) and one or more polymerisable compounds containing two or more, preferably two, polymerisable groups (di- or multireactive).

Preference is furthermore given to PSA displays and LC media in which the polymerisable component or component A) comprises exclusively polymerisable compounds containing two polymerisable groups (direactive).

The polymerisable compounds can be added individually to the LC media, but it is also possible to use mixtures comprising two or more polymerisable compounds according to the invention. In the case of polymerisation of such mixtures, copolymers are formed. The invention furthermore relates to the polymerisable mixtures mentioned above and below. The polymerisable compounds can be mesogenic or non-mesogenic. Particular preference is given to polymerisable mesogenic compounds, also known as reactive mesogens (RMs).

Suitable and preferred RMs for use in LC media and PSA displays according to the invention are described below.

In a preferred embodiment of the invention, the polymerisable compounds are selected from the compounds of the formula I*

R^{a}-A¹-(Z¹-A²)ₘ-R^{b} I*

in which the individual radicals have the following meanings:
R^{a} and R^{b} each, independently of one another, denote P, P-Sp-, H, halogen, SF₅, NO₂, a carbon group or hydrocarbon group, where at least one of the radicals R^{a} and R^{b} denotes or contains a group P or P-Sp-,
P on each occurrence, identically or differently, denotes a polymerisable group,
Sp on each occurrence, identically or differently, denotes a spacer group or a single bond,
A¹ and A² each, independently of one another, denote an aromatic, heteroaromatic, alicyclic or heterocyclic group, preferably having 4 to 25 ring atoms, which may also contain fused rings, and which may also be mono- or polysubstituted by L,
L denotes P-Sp-, H, OH, CH₂OH, halogen, SF₅, NO₂, a carbon group or hydrocarbon group,
Z¹ on each occurrence, identically or differently, denotes —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, CR⁰R⁰⁰ or a single bond,
R⁰ and R⁰⁰ each, independently of one another, denote H or alkyl having 1 to 12 C atoms,
m denotes 0, 1, 2, 3 or 4,
n1 denotes 1, 2, 3 or 4.

Particularly preferred compounds of the formula I* are those in which
R^{a} and R^{b} each, independently of one another, denote P, P-Sp-, H, F, Cl, Br, I, —CN, —NO₂, —NCO, —NCS, —OCN, —SCN, SF₅ or straight-chain or branched alkyl having 1 to 25 C atoms, in which, in addition, one or more non-adjacent CH₂ groups may each be replaced, independently of one another, by —C(R⁰)═C(R⁰⁰)—, —C≡C—, —N(R⁰⁰)—, —O—, —S—, —CO—, —CO—O—, —O—CO—, —O—CO—O— in such a way that O and/or S atoms are not linked directly to one another, and in which, in addition, one or more H atoms may be replaced by F, Cl, Br, I, CN, P or P-Sp-, where at least one of the radicals R^{a} and R^{b} denotes or contains a group P or P-Sp-,
A¹ and A² each, independently of one another, denote 1,4-phenylene, naphthalene-1,4-diyl, naphthalene-2,6-diyl, phenanthrene-2,7-diyl, anthracene-2,7-diyl, fluorene-2,7-diyl, 2-oxo-2H-chromene-3,6-diyl, 2-oxo-2H-chromene-3,7-diyl, 4-oxo-4H-chromene-2,6-diyl, 4-oxo-4H-chromene-3,6-diyl, 4-oxo-4H-chromene-3,7-diyl (trivial name coumarine or flavone), where, in addition, one or more CH groups in these groups may be replaced by N, cyclohexane-1,4-diyl, in which, in addition, one or more non-adjacent CH₂ groups may be replaced by O and/or S, 1,4-cyclohexenylene, bicycle[1.1.1]pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indane-2,5-diyl or octahydro-4,7-methanoindane-2,5-diyl, where all these groups may be unsubstituted or mono- or polysubstituted by L,
L denotes P, P-Sp-, OH, CH₂OH, F, Cl, Br, I, —CN, —NO₂, —NCO, —NCS, —OCN, —SCN, —C(═O)N(R^{x})₂, —C(═O)Y¹, —C(═O)R^{x}, —N(R^{x})₂, optionally substituted silyl, optionally substituted aryl having 6 to 20 C atoms, or straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may be replaced by F, Cl, P or P-Sp-,
P denotes a polymerisable group,
Y¹ denotes halogen,
R^{x} denotes P, P-Sp-, H, halogen, straight-chain, branched or cyclic alkyl having 1 to 25 C atoms, in which, in addition, one or more non-adjacent CH₂ groups may be replaced by —O—, —S—, —CO—, —CO—O—, —O—CO—, —O—CO—O— in such a way that O and/or S atoms are not linked directly to one another, and in which, in addition, one or more H atoms may be replaced by F, Cl, P or P-Sp-, an optionally substituted aryl or aryloxy group having 6 to 40 C atoms, or an optionally substituted heteroaryl or heteroaryloxy group having 2 to 40 C atoms.

Further preferred compounds of the formula I* are those selected from one or more of the following sub-groups:
m is 2 or 3,
m is 2,
R^{a} and R^{b} denote identical or different groups P-Sp-,
R^{a} and R^{b} denote identical or different groups P-Sp- in which one or more groups Sp denote a single bond,
m is 2 or 3, and R^{a} and R^{b} denote identical groups P-Sp-,
one of the radicals R^{a} and R^{b} denotes P-Sp- and the other denotes an unpolymerisable group, preferably straight-chain or branched alkyl having 1 to 25 C atoms, in which, in addition, one or more non-adjacent CH₂ groups may each be replaced, independently of one another, by —C(R⁰⁰)═C(R⁰⁰⁰)—, —C≡C—, —N(R⁰⁰)—, —O—, —S—, —CO—, —CO—O—, —O—CO— or —O—CO—O— in such a way that O and/or S atoms are not linked directly to one another, and in which, in addition, one or more H atoms may be replaced by F, Cl, Br, I or CN,
one or more groups Sp denote a single bond,
one or more groups Sp denote —(CH₂)ₚ₁—, —(CH₂)ₚ₁—O—, —(CH₂)ₚ₁—OCO— or —(CH₂)ₚ₁—OCOO—, in which p1 denotes an integer from 1 to 12, and r1 denotes an integer from 1 to 8,
L does not denote and/or contain a polymerisable group,
A¹ and A² denote, independently of one another, 1,4-phenylene or naphthalene-2,6-diyl, in which, in addition, one or more CH groups in these groups may be replaced by N and which may, in addition, be mono- or polyfluorinated,
Z¹ is selected from the group consisting of —O—, —CO—O—, —OCO—, —OCH₂—, —CH₂O—, —CF₂O—, —OCF₂—, —CH₂CH₂—, —CH═CH—, —CF═CF—, —CH═CF—, —CF═CH—, —C≡C— and a single bond,
L is an unpolymerisable group, preferably selected from the group consisting of F, Cl, —CN, straight-chain and branched alkyl having 1 to 25 C atoms, in which, in addition, one or more non-adjacent CH₂ groups may each be replaced, independently of one another, by —C(R⁰⁰)═C(R⁰⁰⁰)—, —C≡C—, —N(R⁰⁰)—, —O—, —S—, —CO—, —CO—O—, —O—CO— or —O—CO—O— in such a way that O and/or S atoms are not linked directly to one another, and in which, in addition, one or more H atoms may be replaced by F, Cl, Br, I or CN.

Particularly preferred compounds of the formula I* are selected from the following sub-formulae:

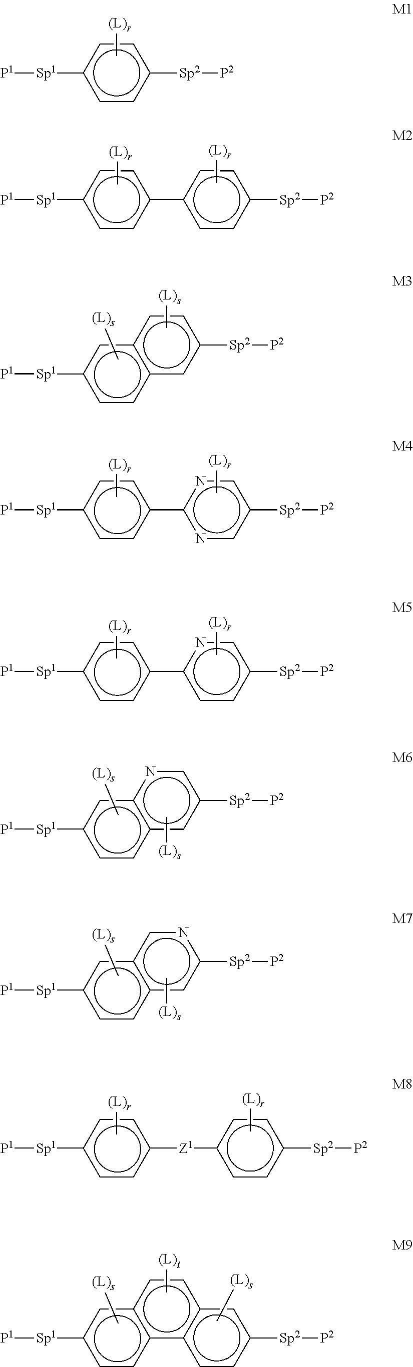

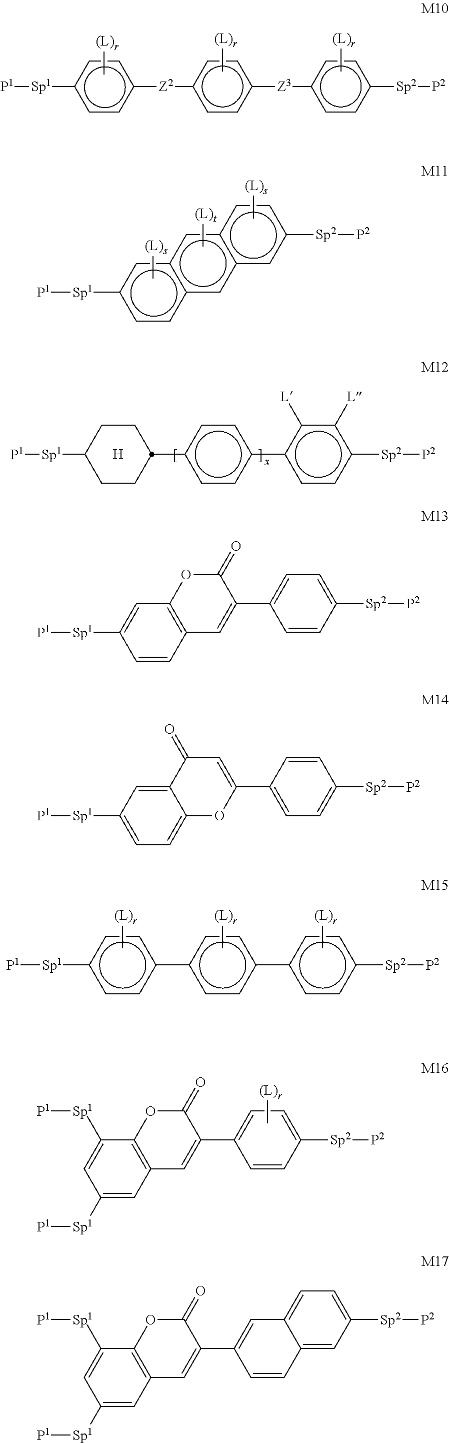

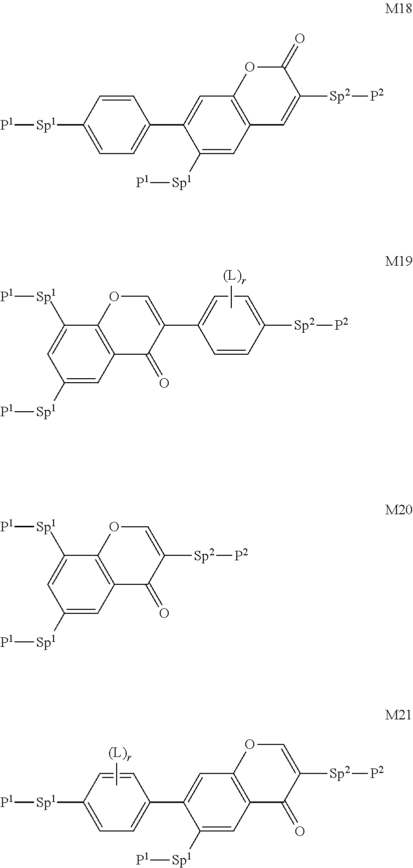

in which
P¹ and P² have one of the meanings indicated for P and preferably denote acrylate, methacrylate, fluoroacrylate, oxetane, vinyloxy or epoxy,
Sp¹ and Sp² each, independently of one another, have one of the meanings indicated for Sp or denote a single bond, where one or more of the radicals P¹-Sp¹- and P²-Sp² may also denote R^{aa}, where at least one of the radicals P¹-Sp¹- and P²-Sp² is different from R^{aa},
R^{aa} denotes F, Cl, —CN, straight-chain or branched alkyl having 1 to 25 C atoms, in which, in addition, one or more non-adjacent CH₂ groups may each be replaced, independently of one another, by —C(R⁰⁰)═C(R⁰⁰⁰)—, —C≡C—, —N(R⁰⁰)—, —O—, —S—, —CO—, —CO—O—, —O—CO— or —O—CO—O— in such a way that O and/or S atoms are not linked directly to one another, and in which, in addition, one or more H atoms may be replaced by F, Cl, Br, I or CN,
R⁰, R⁰⁰ have the meanings indicated in formula I*,
Z¹ denotes —O—, —CO—, —C(R^{y}R^{z})— or —CF₂CF₂—,
Z² and Z³ each, independently of one another, denote —CO—O—, —O—CO—, —CH₂O—, —OCH₂—, —CF₂O—, —OCF₂— or —(CH₂)ₙ—, in which n is 2, 3 or 4,
L has the meaning indicated above for formula I,
L′ and L″ each, independently of one another, denote H, F or Cl,
r denotes 0, 1, 2, 3 or 4,
s denotes 0, 1, 2 or 3,
t denotes 0, 1 or 2,
x denotes 0 or 1, and
R^{y} and R^{z} each, independently of one another, denote H, CH₃ or CF₃.

Further preferred compounds of the formula I* are selected from the following sub-formulae:

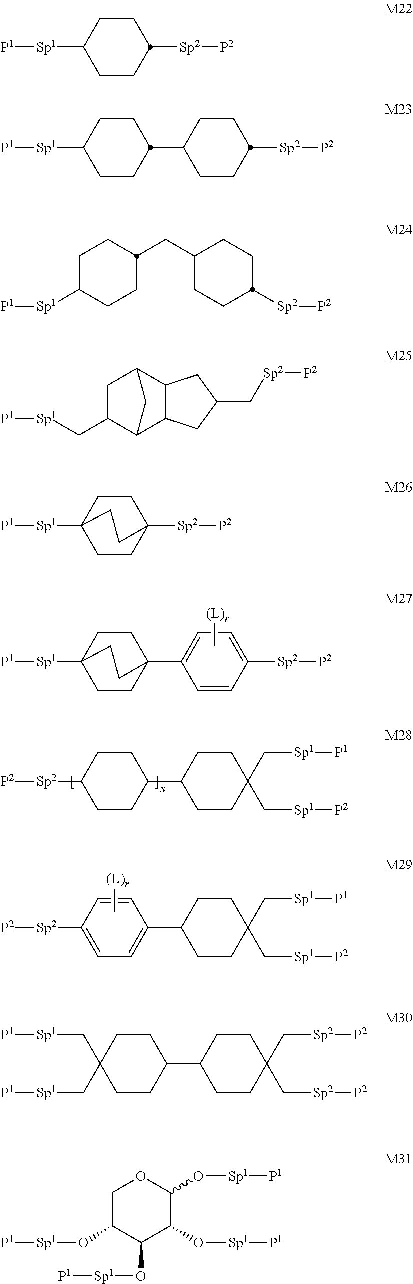

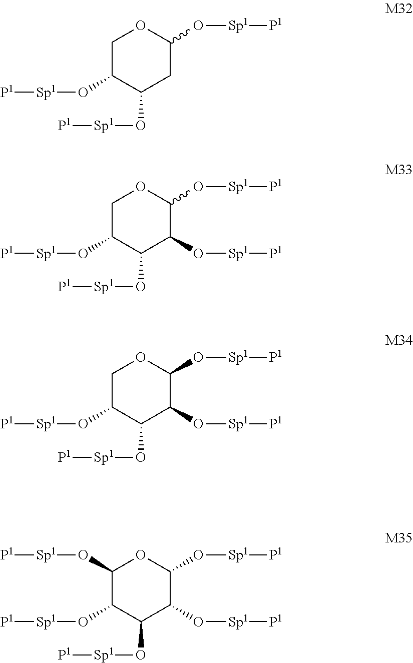

in which the individual radicals have the meanings indicated for formulae M1-M21.

In a further preferred embodiment of the invention, the polymerisable compounds are chiral or optically active compounds selected from formula II* (chiral RMs):

(R*-(A¹-Z¹)ₘ)ₖ-Q II*

in which A¹, Z¹ and m have on each occurrence, identically or differently, one of the meanings indicated in formula I*,
R* has on each occurrence, identically or differently, one of the meanings indicated for R^{a} in formula I*, where R* can be chiral or achiral,
Q denotes a k-valent chiral group, which is optionally mono- or polysubstituted by L, as defined in formula I*,
k is 1, 2, 3, 4, 5 or 6,

where the compounds contain at least one radical R* or L which denotes or contains a group P or P-Sp- as defined above.

Particularly preferred compounds of the formula II* contain a monovalent group Q of the formula III*

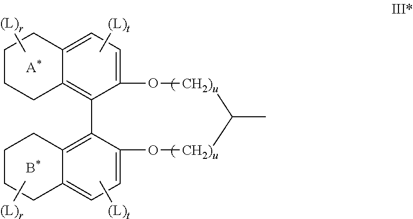

in which L and r have on each occurrence, identically or differently, the meanings indicated above,
A* and B* each, independently of one another, denote fused benzene, cyclohexane or cyclohexene,
t on each occurrence, identically or differently, denotes 0, 1 or 2, and
u on each occurrence, identically or differently, denotes 0, 1 or 2.

Particular preference is given to groups of the formula III* in which u denotes 1.

Further preferred compounds of the formula II* contain a monovalent group Q or one or more groups R* of the formula IV*

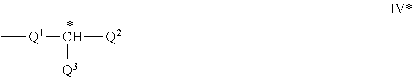

in which
Q¹ denotes alkylene or alkyleneoxy having 1 to 9 C atoms or a single bond,
Q² denotes optionally fluorinated alkyl or alkoxy having 1 to 10 C atoms, in which, in addition, one or two non-adjacent CH₂ groups may be replaced by —O—, —S—, —CH═CH—, —CO—, —OCO—, —COO—, —O—COO—, —S—CO—, —CO—S— or —C≡C— in such a way that O and/or S atoms are not linked directly to one another,
Q³ denotes F, Cl, CN or alkyl or alkoxy as defined for Q², but different from Q².

Preferred groups of the formula IV* are, for example, 2-butyl (=1-methylpropyl), 2-methylbutyl, 2-methylpentyl, 3-methylpentyl, 2-ethylhexyl, 2-propylpentyl, in particular 2-methylbutyl, 2-methylbutoxy, 2-methylpentoxy, 3-methylpentoxy, 2-ethylhexoxy, 1-methylhexoxy, 2-octyloxy, 2-oxa-3-methylbutyl, 3-oxa-4-methylpentyl, 4-methylhexyl, 2-hexyl, 2-octyl, 2-nonyl, 2-decyl, 2-dodecyl, 6-methoxyoctoxy, 6-methyloctoxy, 6-methyloctanoyloxy, 5-methylheptyloxycarbonyl, 2-methylbutyryloxy, 3-methylvaleroyloxy, 4-methylhexanoyloxy, 2-chloropropionyloxy, 2-chloro-3-methylbutyryloxy, 2-chloro-4-methylvaleryloxy, 2-chloro-3-methylvaleryloxy, 2-methyl-3-oxapentyl, 2-methyl-3-oxahexyl, 1-methoxypropyl-2-oxy, 1-ethoxypropyl-2-oxy, 1-propoxypropyl-2-oxy, 1-butoxypropyl-2-oxy, 2-fluorooctyloxy, 2-fluorodecyloxy, 1,1,1-trifluoro-2-octyloxy, 1,1,1-trifluoro-2-octyl, 2-fluoromethyloctyloxy.

Further preferred compounds of the formula II* contain a divalent group Q of the formula V*

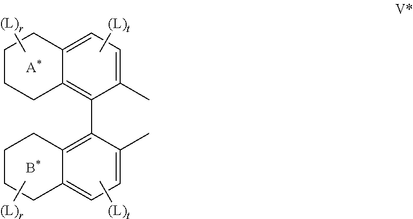

in which L, r, t, A* and B* have the meanings indicated above.

Further preferred compounds of the formula II* contain a divalent group Q selected from the following formulae:

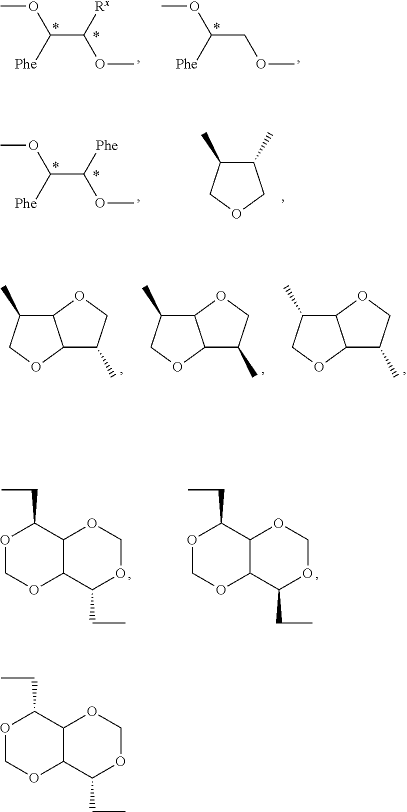

in which Phe denotes phenyl, which is optionally mono- or polysubstituted by L, and R^{x} denotes F or optionally fluorinated alkyl having 1 to 4 C atoms.

Suitable chiral RMs are described, for example, in GB 2 314 839 A, U.S. Pat. No. 6,511,719, U.S. Pat. No. 7,223,450, WO 02/34739 A1, U.S. Pat. No. 7,041,345, U.S. Pat. No. 7,060,331 or U.S. Pat. No. 7,318,950. Suitable RMs containing binaphthyl groups are described, for example, in U.S. Pat. No. 6,818,261, U.S. Pat. No. 6,916,940, U.S. Pat. No. 7,318,950 and U.S. Pat. No. 7,223,450.

The chiral structural elements shown above and below and polymerisable and polymerised compounds containing such chiral structural elements can be employed in optically active form, i.e. as pure enantiomers or as any desired mixture of the two enantiomers, or alternatively as a racemate. The use of racemates is preferred. The use of racemates has some advantages over the use of pure enantiomers, such as, for example, significantly lower synthesis complexity and lower material costs.

The compounds of the formula II* are preferably present in the LC medium in the form of the racemate.

Particularly preferred compounds of the formula II* are selected from the following sub-formulae:

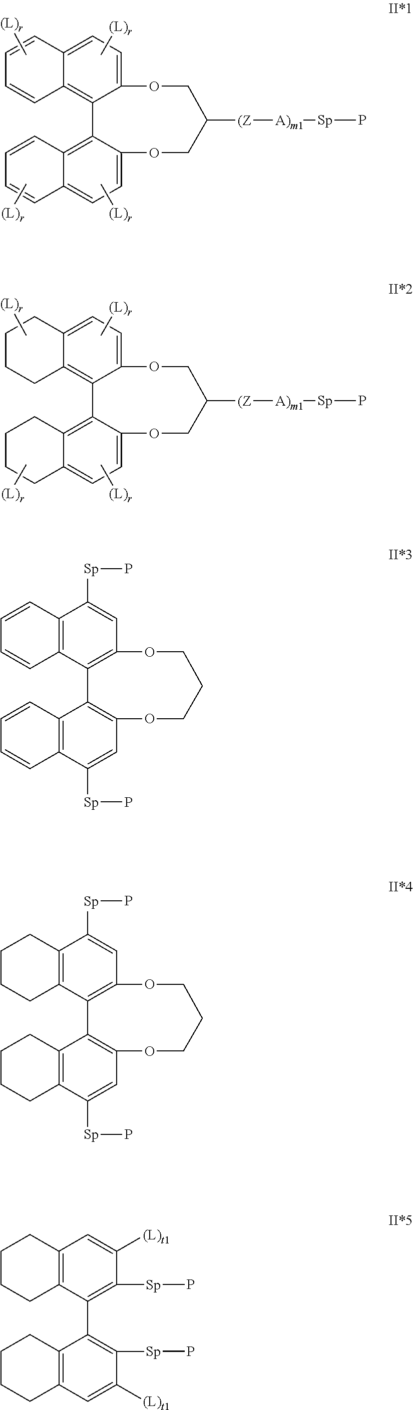

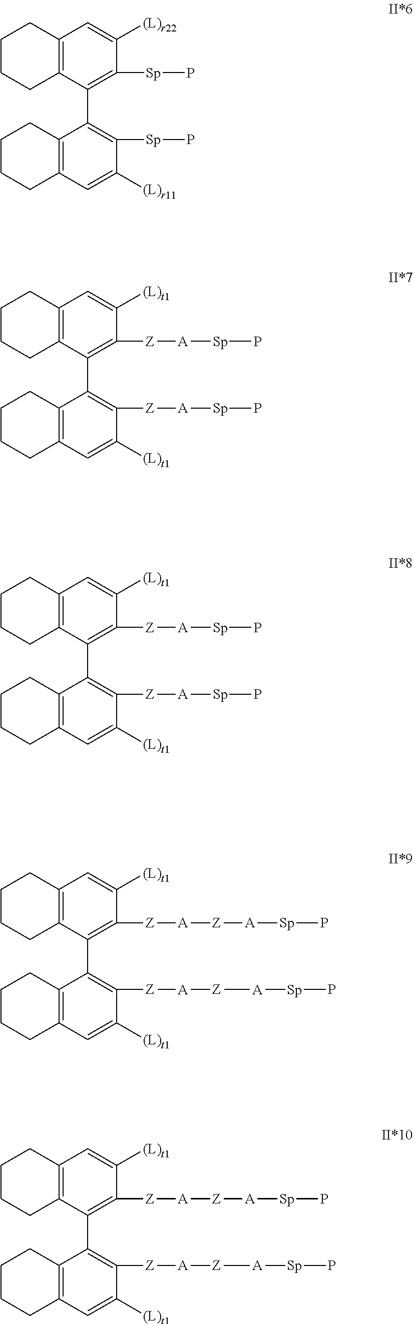

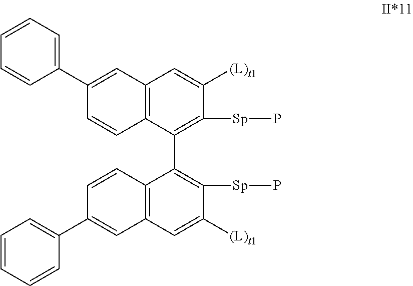

in which L, P, Sp, m, r and t have the meanings indicated above, Z and A have on each occurrence, identically or differently, one of the meanings indicated for Z¹ and A¹ respectively, and t1 on each occurrence, identically or differently, denotes 0 or 1.

The term “carbon group” denotes a mono- or polyvalent organic group containing at least one carbon atom, where this either contains no further atoms (such as, for example, —C≡C—) or optionally contains one or more further atoms, such as, for example, N, O, S, P, Si, Se, As, Te or Ge (for example carbonyl, etc.). The term “hydrocarbon group” denotes a carbon group which additionally contains one or more H atoms and optionally one or more heteroatoms, such as, for example, N, O, S, P, Si, Se, As, Te or Ge.

“Halogen” denotes F, Cl, Br or I.

A carbon or hydrocarbon group can be a saturated or unsaturated group. Unsaturated groups are, for example, aryl, alkenyl or alkynyl groups. A carbon or hydrocarbon radical having more than 3 C atoms can be straight-chain, branched and/or cyclic and may also contain spiro links or condensed rings.

The terms “alkyl”, “aryl”, “heteroaryl”, etc., also encompass polyvalent groups, for example alkylene, arylene, heteroarylene, etc.

The term “aryl” denotes an aromatic carbon group or a group derived therefrom. The term “heteroaryl” denotes “aryl” as defined above, containing one or more heteroatoms.

Preferred carbon and hydrocarbon groups are optionally substituted alkyl, alkenyl, alkynyl, alkoxy, alkylcarbonyl, alkoxycarbonyl, alkylcarbonyloxy and alkoxycarbonyloxy having 1 to 40, preferably 1 to 25, particularly preferably 1 to 18, C atoms, optionally substituted aryl or aryloxy having 6 to 40, preferably 6 to 25, C atoms, or optionally substituted alkylaryl, arylalkyl, alkylaryloxy, arylalkyloxy, arylcarbonyl, aryloxycarbonyl, arylcarbonyloxy and aryloxycarbonyloxy having 6 to 40, preferably 6 to 25, C atoms.

Further preferred carbon and hydrocarbon groups are C₁-C₄₀ alkyl, C₂-C₄₀ alkenyl, C₂-C₄₀ alkynyl, C₃-C₄₀ allyl, C₄-C₄₀ alkyldienyl, C₄-C₄₀ polyenyl, C₆-C₄₀ aryl, C₆-C₄₀ alkylaryl, C₆-C₄₀ arylalkyl, C₆-C₄₀ alkylaryloxy, C₆-C₄₀ arylalkyloxy, C₂-C₄₀ heteroaryl, C₄-C₄₀ cycloalkyl, C₄-C₄₀ cycloalkenyl, etc. Particular preference is given to C₁-C₂₂ alkyl, C₂-C₂₂ alkenyl, C₂-C₂₂ alkynyl, C₃-C₂₂ allyl, C₄-C₂₂ alkyldienyl, C₆-C₁₂ aryl, C₆-C₂₀ arylalkyl and C₂-C₂₀ heteroaryl.

Further preferred carbon and hydrocarbon groups are straight-chain, branched or cyclic alkyl radicals having 1 to 40, preferably 1 to 25, C atoms, which are unsubstituted or mono- or polysubstituted by F, Cl, Br, I or CN and in which one or more non-adjacent CH₂ groups may each be replaced, independently of one another, by —C(R^{x})═C(R^{x})—, —C≡C—, —N(R^{x})—, —O—, —S—, —CO—, —CO—O—, —O—CO—, —O—CO—O— in such a way that O and/or S atoms are not linked directly to one another.

R^{x} preferably denotes H, halogen, a straight-chain, branched or cyclic alkyl chain having 1 to 25 C atoms, in which, in addition, one or more non-adjacent C atoms may be replaced by —O—, —S—, —CO—, —CO—O—, —O—CO—, —O—CO—O— and in which one or more H atoms may be replaced by fluorine, an optionally substituted aryl or aryloxy group having 6 to 40 C atoms, or an optionally substituted heteroaryl or heteroaryloxy group having 2 to 40 C atoms.

Preferred alkoxy groups are, for example, methoxy, ethoxy, 2-methoxyethoxy, n-propoxy, i-propoxy, n-butoxy, i-butoxy, s-butoxy, t-butoxy, 2-methylbutoxy, n-pentoxy, n-hexoxy, n-heptoxy, n-octoxy, n-nonoxy, n-decoxy, n-undecoxy, n-dodecoxy, etc.

Preferred alkyl groups are, for example, methyl, ethyl, n-propyl, isopropyl, n-butyl, isobutyl, s-butyl, t-butyl, 2-methylbutyl, n-pentyl, s-pentyl, cyclopentyl, n-hexyl, cyclohexyl, 2-ethylhexyl, n-heptyl, cycloheptyl, n-octyl, cyclooctyl, n-nonyl, n-decyl, n-undecyl, n-dodecyl, dodecanyl, trifluoro-methyl, perfluoro-n-butyl, 2,2,2-trifluoroethyl, perfluorooctyl, perfluorohexyl, etc.

Preferred alkenyl groups are, for example, ethenyl, propenyl, butenyl, pentenyl, cyclopentenyl, hexenyl, cyclohexenyl, heptenyl, cycloheptenyl, octenyl, cyclooctenyl, etc.

Preferred alkynyl groups are, for example, ethynyl, propynyl, butynyl, pentynyl, hexynyl, octynyl, etc.

Preferred alkoxy groups are, for example, methoxy, ethoxy, 2-methoxy-ethoxy, n-propoxy, i-propoxy, n-butoxy, i-butoxy, s-butoxy, t-butoxy, 2-methylbutoxy, n-pentoxy, n-hexoxy, n-heptoxy, n-octoxy, n-nonoxy, n-decoxy, n-undecoxy, n-dodecoxy, etc.

Preferred amino groups are, for example, dimethylamino, methylamino, methylphenylamino, phenylamino, etc.

Aryl and heteroaryl groups can be monocyclic or polycyclic, i.e. they can contain one ring (such as, for example, phenyl) or two or more rings, which may also be fused (such as, for example, naphthyl) or covalently bonded (such as, for example, biphenyl), or contain a combination of fused and linked rings. Heteroaryl groups contain one or more heteroatoms, preferably selected from O, N, S and Se.

Particular preference is given to mono-, bi- or tricyclic aryl groups having 6 to 25 C atoms and mono-, bi- or tricyclic heteroaryl groups having 2 to 25 C atoms, which optionally contain fused rings and are optionally substituted.

Preference is furthermore given to 5-, 6- or 7-membered aryl and heteroaryl groups, in which, in addition, one or more CH groups may be replaced by N, S or O in such a way that O atoms and/or S atoms are not linked directly to one another.

Preferred aryl groups are, for example, phenyl, biphenyl, terphenyl, 1,1′:3′,1″-terphenyl-2′-yl, naphthyl, anthracene, binaphthyl, phenanthrene, pyrene, dihydropyrene, chrysene, perylene, tetracene, pentacene, benzo-pyrene, fluorene, indene, indenofluorene, spirobifluorene, etc.

Preferred heteroaryl groups are, for example, 5-membered rings, such as pyrrole, pyrazole, imidazole, 1,2,3-triazole, 1,2,4-triazole, tetrazole, furan, thiophene, selenophene, oxazole, isoxazole, 1,2-thiazole, 1,3-thiazole, 1,2,3-oxadiazole, 1,2,4-oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, 6-membered rings, such as pyridine, pyridazine, pyrimidine, pyrazine, 1,3,5-triazine, 1,2,4-triazine, 1,2,3-triazine, 1,2,4,5-tetrazine, 1,2,3,4-tetrazine, 1,2,3,5-tetrazine, or condensed groups, such as indole, isoindole, indolizine, indazole, benzimidazole, benzotriazole, purine, naphthimidazole, phenanthrimidazole, pyridimidazole, pyrazinimidazole, quinoxalin-imidazole, benzoxazole, naphthoxazole, anthroxazole, phenanthroxazole, isoxazole, benzothiazole, benzofuran, isobenzofuran, dibenzofuran, quinoline, isoquinoline, pteridine, benzo-5,6-quinoline, benzo-6,7-quinoline, benzo-7,8-quinoline, benzoisoquinoline, acridine, phenothiazine, phenoxazine, benzopyridazine, benzopyrimidine, quinoxaline, phenazine, naphthyridine, azacarbazole, benzocarboline, phenanthridine, phenanthroline, thieno[2,3b]thiophene, thieno[3,2b]thiophene, dithienothiophene, isobenzothiophene, dibenzothiophene, benzothiadiazothiophene, or combinations of these groups. The heteroaryl groups may also be substituted by alkyl, alkoxy, thioalkyl, fluorine, fluoroalkyl or further aryl or heteroaryl groups.

The (non-aromatic) alicyclic and heterocyclic groups encompass both saturated rings, i.e. those containing exclusively single bonds, and also partially unsaturated rings, i.e. those which may also contain multiple bonds. Heterocyclic rings contain one or more heteroatoms, preferably selected from Si, O, N, S and Se.

The (non-aromatic) alicyclic and heterocyclic groups can be monocyclic, i.e. contain only one ring (such as, for example, cyclohexane), or polycyclic, i.e. contain a plurality of rings (such as, for example, decahydronaphthalene or bicyclooctane). Particular preference is given to saturated groups. Preference is furthermore given to mono-, bi- or tricyclic groups having 3 to 25 C atoms, which optionally contain fused rings and are optionally substituted. Preference is furthermore given to 5-, 6-, 7- or 8-membered carbocyclic groups, in which, in addition, one or more C atoms may be replaced by Si and/or one or more CH groups may be replaced by N and/or one or more non-adjacent CH₂ groups may be replaced by —O— and/or —S—.

Preferred alicyclic and heterocyclic groups are, for example, 5-membered groups, such as cyclopentane, tetrahydrofuran, tetrahydrothiofuran, pyrrolidine, 6-membered groups, such as cyclohexane, silinane, cyclohexene, tetrahydropyran, tetrahydrothiopyran, 1,3-dioxane, 1,3-dithiane, piperidine, 7-membered groups, such as cycloheptane, and fused groups, such as tetrahydronaphthalene, decahydronaphthalene, indane, bicyclo[1.1.1]-pentane-1,3-diyl, bicyclo[2.2.2]octane-1,4-diyl, spiro[3.3]heptane-2,6-diyl, octahydro-4,7-methanoindane-2,5-diyl.

Preferred substituents are, for example, solubility-promoting groups, such as alkyl or alkoxy, electron-withdrawing groups, such as fluorine, nitro or nitrile, or substituents for increasing the glass transition temperature (Tg) in the polymer, in particular bulky groups, such as, for example, t-butyl or optionally substituted aryl groups.

Preferred substituents, also referred to as “L” above and below, are, for example, F, Cl, Br, I, —CN, —NO₂, —NCO, —NCS, —OCN, —SCN, —C(═O)N(R^{x})₂, —C(═O)Y¹, —C(═O)R^{x}, —N(R^{x})₂, in which R^{x} has the meaning indicated above, and Y¹ denotes halogen, optionally substituted silyl or aryl having 6 to 40, preferably 6 to 20, C atoms, and straight-chain or branched alkyl, alkoxy, alkylcarbonyl, alkoxycarbonyl, alkylcarbonyloxy or alkoxycarbonyloxy having 1 to 25 C atoms, in which one or more H atoms may optionally be replaced by F or Cl.

“Substituted silyl or aryl” preferably means substituted by halogen, —CN, R⁰, —OR⁰, —CO—R⁰, —CO—O—R⁰, —O—CO—R⁰ or —O—CO—O—R⁰, in which R⁰ has the meaning indicated above.

Particularly preferred substituents L are, for example, F, Cl, CN, NO₂, CH₃, C₂H₅, OCH₃, OC₂H₅, COCH₃, COC₂H₅, COOCH₃, COOC₂H₅, CF₃, OCF₃, OCHF₂, OC₂F₅, furthermore phenyl.

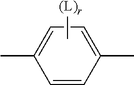

is preferably

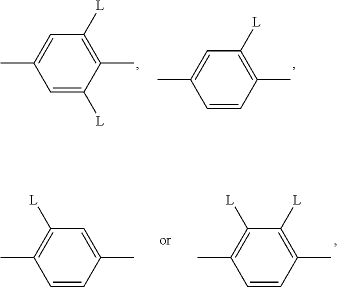

in which L has one of the meanings indicated above.

The polymerisable group P is a group which is suitable for a polymerisation reaction, such as, for example, free-radical or ionic chain polymerisation, polyaddition or polycondensation, or for a polymer-analogous reaction, for example addition or condensation onto a main polymer chain. Particular preference is given to groups for chain polymerisation, in particular those containing a C═C double bond or —C≡C— triple bond, and groups which are suitable for polymerisation with ring opening, such as, for example, oxetane or epoxide groups.

Preferred groups P are selected from CH₂═CW¹—COO—, CH₂═CW¹—CO—,

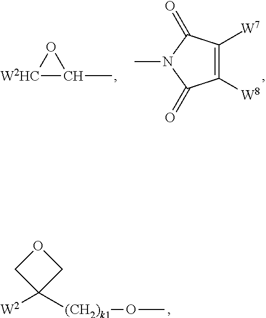

CH₂═CW²—(O)ₖ₃—, CW¹═CH—CO—(O)ₖ₃—, CW¹═CH—CO—NH—, CH₂═CW¹—CO—NH—, CH₃—CH═CH—O—, (CH₂═CH)₂CH—OCO—, (CH₂═CH—CH₂)₂CH—OCO—, (CH₂═CH)₂CH—O—, (CH₂═CH—CH₂)₂N—, (CH₂═CH—CH₂)₂N—CO—, HO—CW²W³—, HS—CW²W³—, HW²N—, HO—CW²W³—NH—, CH₂═CW¹—CO—NH—, CH₂═CH—(COO)ₖ₁-Phe-(O)ₖ₂—, CH₂═CH—(CO)ₖ₁-Phe-(O)ₖ₂—, Phe-CH═CH—, HOOC—, OCN— and W⁴W⁵W⁶Si—, in which W¹ denotes H, F, Cl, CN, CF₃, phenyl or alkyl having 1 to 5 C atoms, in particular H, F, Cl or CH₃, W² and W³ each, independently of one another, denote H or alkyl having 1 to 5 C atoms, in particular H, methyl, ethyl or n-propyl, W⁴, W⁵ and W⁶ each, independently of one another, denote Cl, oxaalkyl or oxacarbonylalkyl having 1 to 5 C atoms, W⁷ and W⁸ each, independently of one another, denote H, Cl or alkyl having 1 to 5 C atoms, Phe denotes 1,4-phenylene, which is optionally substituted by one or more radicals L as defined above which are different from P-Sp-, k₁, k₂ and k₃ each, independently of one another, denote 0 or 1, k₃ preferably denotes 1.

Particularly preferred groups P are CH₂═CW¹—COO—, in particular CH₂═CH—COO—, CH₂═C(CH₃)—COO— and CH₂═CF—COO—, furthermore CH₂═CH—O—, (CH₂═CH)₂CH—OCO—, (CH₂═CH)₂CH—O—,

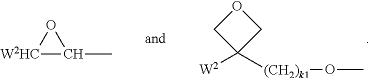

Very particularly preferred groups P are vinyloxy, acrylate, methacrylate, fluoroacrylate, chloroacrylate, oxetane and epoxide, in particular acrylate and methacrylate.

Preferred spacer groups Sp are selected from the formula Sp′-X′, so that the radical P-Sp- corresponds to the formula P-Sp′-X′-, where
Sp′ denotes alkylene having 1 to 20, preferably 1 to 12, C atoms, which is optionally mono- or polysubstituted by F, Cl, Br, I or CN and in which, in addition, one or more non-adjacent CH₂ groups may each be replaced, independently of one another, by —O—, —S—, —NH—, —NR⁰—, —SiR⁰⁰R⁰⁰⁰, —CO—, —COO—, —OCO—, —OCO—O—, —S—CO—, —CO—S—, —NR⁰⁰—CO—O—, —O—CO—NR⁰⁰—, —NR⁰⁰—CO—NR⁰⁰—, —CH═CH— or —C≡C— in such a way that O and/or S atoms are not linked directly to one another,
X′ denotes —O—, —S—, —CO—, —COO—, —OCO—, —O—COO—, —CO—NR⁰⁰—, —NR⁰⁰—CO—, —NR⁰⁰—CO—NR⁰⁰—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR⁰—, —CY²═CY³—, —C≡C—, —CH═CH—COO—, —OCO—CH═CH— or a single bond,
R⁰⁰ and R⁰⁰⁰ each, independently of one another, denote H or alkyl having 1 to 12 C atoms, and
Y² and Y³ each, independently of one another, denote H, F, Cl or CN.

X′ is preferably —O—, —S—, —CO—, —COO—, —OCO—, —O—COO—, —CO—NR⁰—, —NR⁰—CO—, —NR⁰—CO—NR⁰— or a single bond.

Typical spacer groups Sp′ are, for example, —(CH₂)ₚ₁—, —(CH₂CH₂O)_{q1}—CH₂CH₂—, —CH₂CH₂—S—CH₂CH₂—, —CH₂CH₂—NH—CH₂CH₂— or —(SiR⁰⁰R⁰⁰⁰—O)ₚ₁—, in which p1 is an integer from 1 to 12, q1 is an integer from 1 to 3, and R⁰⁰ and R⁰⁰⁰ have the meanings indicated above.

Particularly preferred groups —X′-Sp′- are —(CH₂)ₚ₁—, —O—(CH₂)ₚ₁—, —OCO—(CH₂)ₚ₁—, —OCOO—(CH₂)ₚ₁—.

Particularly preferred groups Sp′ are, for example, in each case straight-chain ethylene, propylene, butylene, pentylene, hexylene, heptylene, octylene, nonylene, decylene, undecylene, dodecylene, octadecylene, ethyl-eneoxyethylene, methyleneoxybutylene, ethylenethioethylene, ethylene-N-methyliminoethylene, 1-methylalkylene, ethenylene, propenylene and butenylene.

In a further preferred embodiment of the invention, P-Sp- denotes a radical containing two or more polymerisable groups (multifunctional polymerisable radicals). Suitable radicals of this type and polymerisable compounds containing them and the preparation thereof are described, for example, in U.S. Pat. No. 7,060,200 B1 or US 2006/0172090 A1. Particular preference is given to multifunctional polymerisable radicals P-Sp- selected from the following formulae:

—X-alkyl-CHP¹—CH₂—CH₂P² I*a

—X-alkyl-C(CH₂P¹)(CH₂P²)—CH₂P³ I*b

—X-alkyl-CHP¹CHP²—CH₂P³ I*c

—X-alkyl-C(CH₂P¹)(CH₂P²)—CₐₐH₂ₐₐ₊₁ I*d

—X-alkyl-CHP¹—CH₂P² I*e

—X-alkyl-CHP¹P² I*f

—X-alkyl-CP¹P²—CₐₐH₂ₐₐ₊₁ I*g

—X-alkyl-C(CH₂P¹)(CH₂P²)—CH₂OCH₂—C(CH₂P³)(CH₂P⁴)CH₂P⁵ I*h

—X-alkyl-CH((CH₂)ₐₐP¹)((CH₂)_{bb}P²) I*i

—X-alkyl-CHP¹CHP²—CₐₐH₂ₐₐ₊₁ I*k

—X′-alkyl-C(CH₃)(CH₂P¹)(CH₂P²) I*m

in which
alkyl denotes a single bond or straight-chain or branched alkylene having 1 to 12 C atoms, in which one or more non-adjacent CH₂ groups may each be replaced, independently of one another, by —C(R⁰⁰)═C(R⁰⁰⁰)—, —C≡C—, —N(R⁰⁰)—, —O—, —S—, —CO—, —CO—O—, —O—CO—, —O—CO—O— in such a way that O and/or S atoms are not linked directly to one another and in which, in addition, one or more H atoms may be replaced by F, Cl or CN, where R⁰⁰ and R⁰⁰⁰ have the meanings indicated above,

aa and bb each, independently of one another, denote 0, 1, 2, 3, 4, 5 or 6,
X has one of the meanings indicated for X′, and
P¹⁻⁵ each, independently of one another, have one of the meanings indicated for P.

The polymerisable compounds and RMs can be prepared analogously to processes known to the person skilled in the art and described in standard works of organic chemistry, such as, for example, in Houben-Weyl, Methoden der organischen Chemie [Methods of Organic Chemistry], Thieme-Verlag, Stuttgart. Further synthetic methods are given in the documents cited above and below. In the simplest case, the synthesis of such RMs is carried out, for example, by esterification or etherification of 2,6-dihydroxynaphthalene or 4,4′-dihydroxybiphenyl using corresponding acids, acid derivatives or halogenated compounds containing a group P, such as, for example, (meth)acryloyl chloride or (meth)acrylic acid, in the presence of a dehydrating reagent, such as, for example, DCC (dicyclohexylcarbodiimide).

The LC mixtures and LC media according to the invention are in principle suitable for any type of PS or PSA display, in particular those based on LC media having negative dielectric anisotropy, particularly preferably for PSA-VA, PSA-IPS or PS-FFS displays. However, the person skilled in the art will also be able, without inventive step, to employ suitable LC mixtures and LC media according to the invention in other displays of the PS or PSA type which differ from the above-mentioned displays, for example, through their basic structure or through the nature, arrangement or structure of the individual components used, such as, for example, the substrates, alignment layers, electrodes, addressing elements, backlighting, polarisers, coloured filters, compensation films optionally present, etc.

The following examples explain the present invention without limiting it. However, they show the person skilled in the art preferred mixture concepts with compounds preferably to be employed and the respective concentrations thereof as well as combinations thereof with one another. In addition, the examples illustrate what properties and property combinations are accessible.

The following examples are intended to explain the invention without limiting it. Above and below, per cent data denote per cent by weight; all temperatures are indicated in degrees Celsius.

Throughout the patent application, 1,4-cyclohexylene rings and 1,4-phenylene rings are depicted as follows:

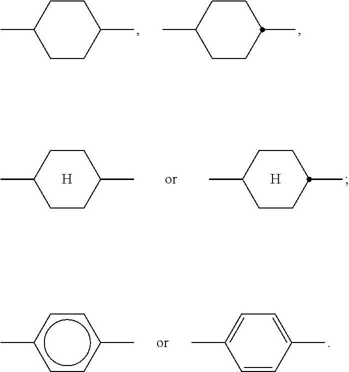

Besides the compounds of the formulae IIA and/or IIB and/or IIC, one or more compounds of the formula I, the mixtures according to the invention preferably comprise one or more of the compounds from Table A indicated below.

TABLE A
The following abbreviations are used:
(n, m, m′, z: each, independently of one another, 1, 2, 3, 4, 5 or 6;
(O)CₘH₂ₘ₊₁ means OCₘH₂ₘ₊₁ or CₘH₂ₘ₊₁)

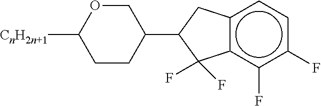

AIK-n-F

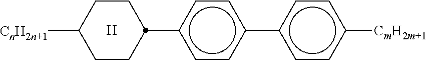

BCH-nm

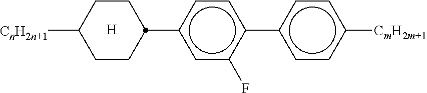

BCH-nmF

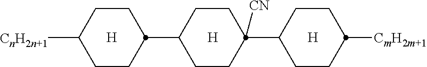

BCN-nm

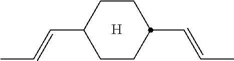

C—1V—V1

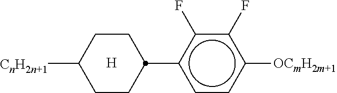

CY-n-Om

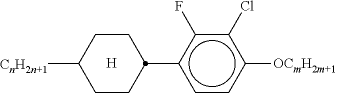

CY(F,Cl)n-Om

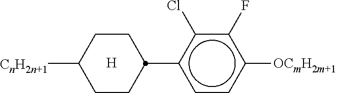

CY(Cl,F)-n-Om

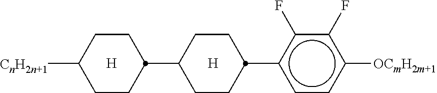

CCY-n-Om

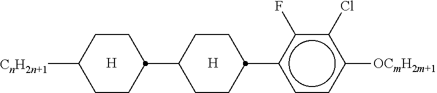

CCY(F,Cl)n-Om

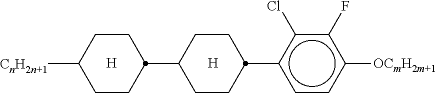

CCY(Cl,F)-n-Om

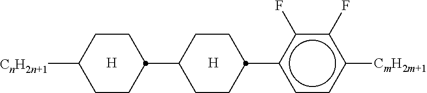

CCY-n-m

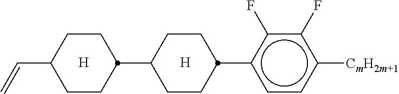

CCY—V-m

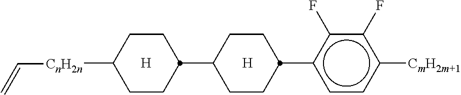

CCY—Vn-m

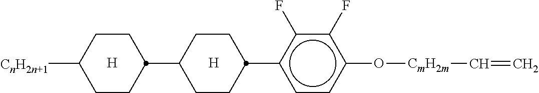

CCY-n-OmV

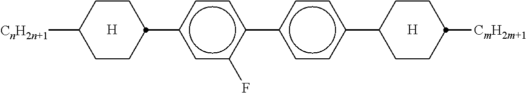

CBC-nmF

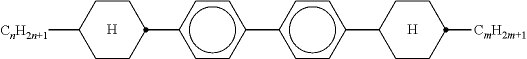

CBC-nm

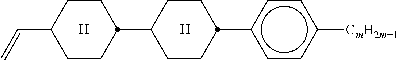

CCP—V-m

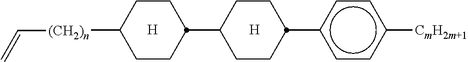

CCP—Vn-m

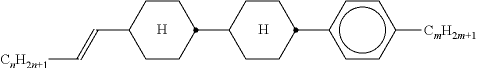

CCP-nV-m

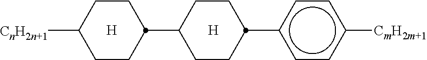

CCP-n-m

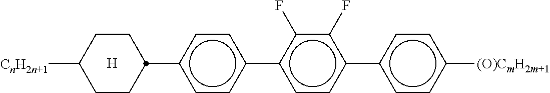

CPYP-n-(O)m

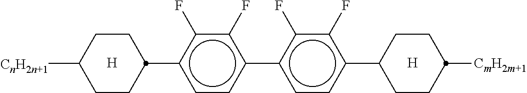

CYYC-n-m

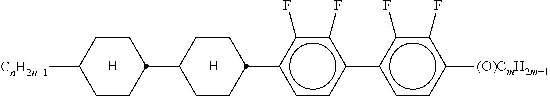

CCYY-n-(O)m

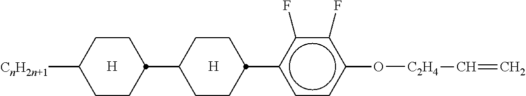

CCY-n-O2V

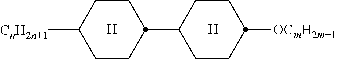

CCH-nOm

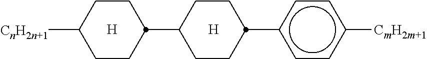

CCP-n-m

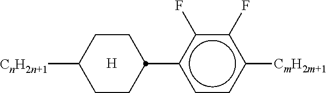

CY-n-m

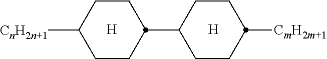

CCH-nm

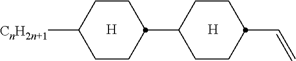

CC-n-V

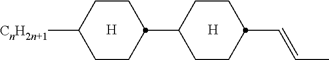

CC-n-V1

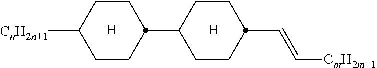

CC-n-Vm

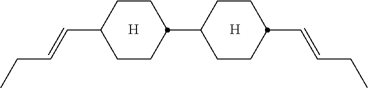

CC—2V—V2

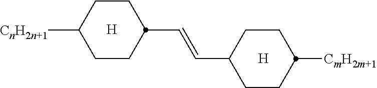

CVC-n-m

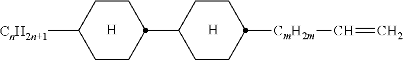

CC-n-mV

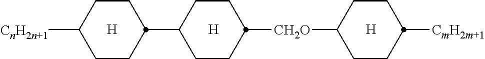

CCOC-n-m

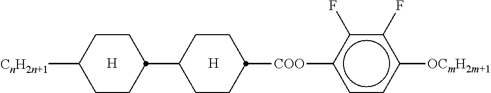

CP-nOmFF

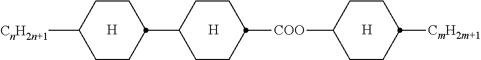

CH-nm

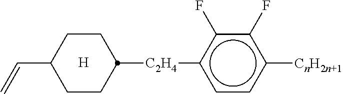

CEY—V-n

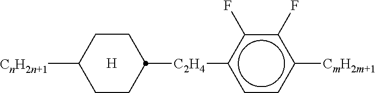

CEY-n-m

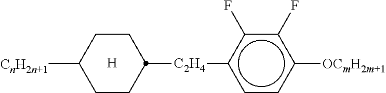

CEY-n-Om

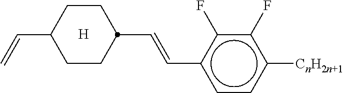

CVY—V-n

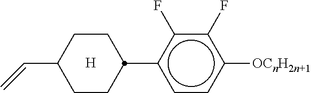

CY—V—On

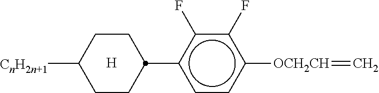

CY-n-O1V

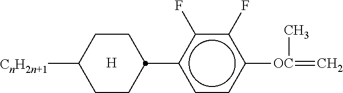

CY-n-OC(CH₃)═CH₂

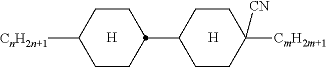

CCN-nm

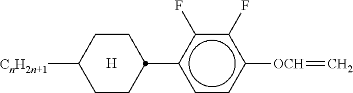

CY-n-OV

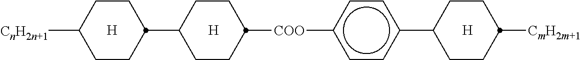

CCPC-nm

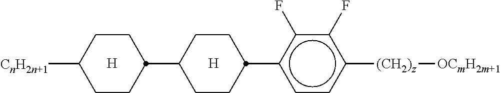

CCY-n-zOm

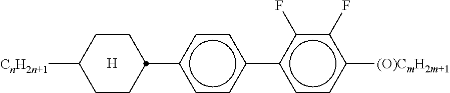

CPY-n-(O)m

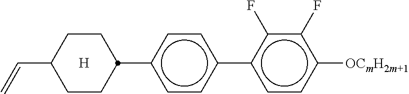

CPY—V—Om

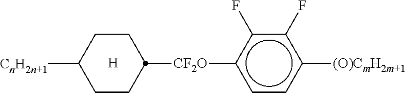

CQY-n-(O)m

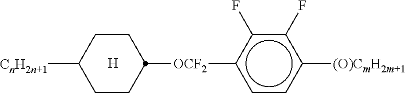

CQIY-n-(O)m

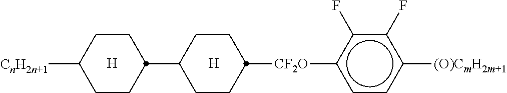

CCQY-n-(O)m

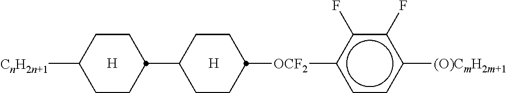

CCQIY-n-(O)m

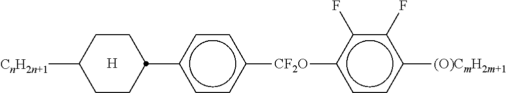

CPQY-n-(O)m

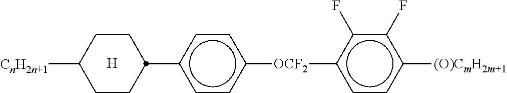

CPQIY-n-(O)m

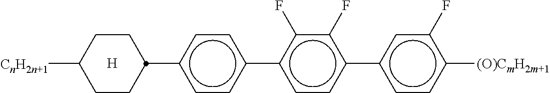

CPYG-n-(O)m

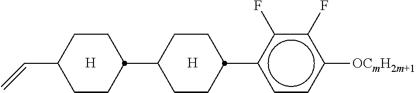

CCY—V—Om

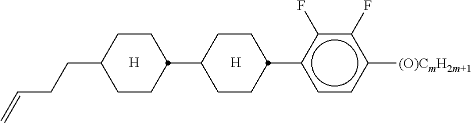

CCY—V2—(O)m

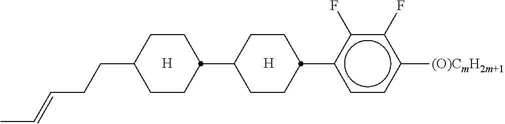

CCY—1V2—(O)m

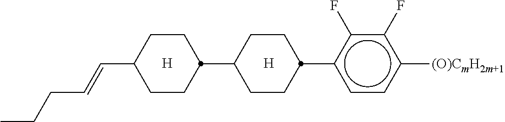

CCY—3V—(O)m

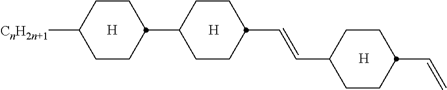

CCVC-n-V

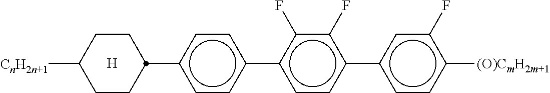

CPYG-n-(O)m

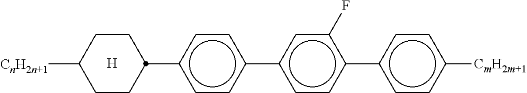

CPGP-n-m

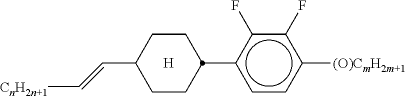

CY-nV—(O)m

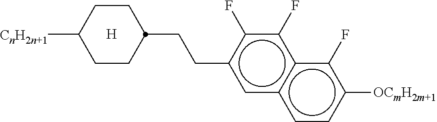

CENaph-n-Om

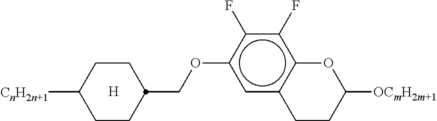

COChrom-n-Om

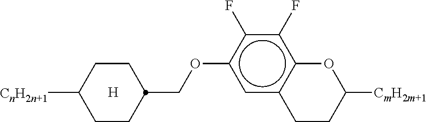

COChrom-n-m

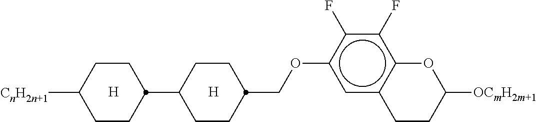

CCOChrom-n-Om

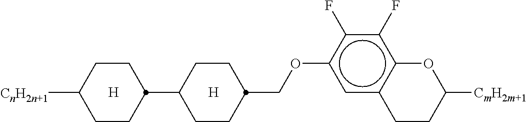

CCOChrom-n-m

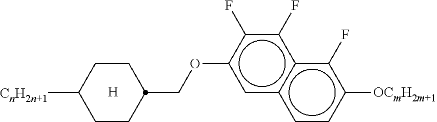

CONaph-n-Om

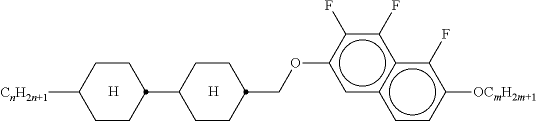

CCONaph-n-Om

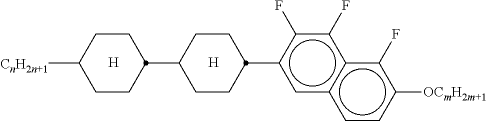

CCNaph-n-Om

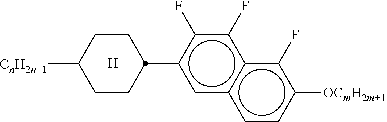

CNaph-n-Om

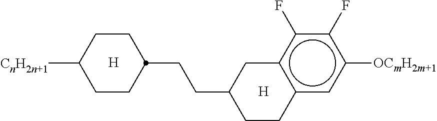

CETNaph-n-Om

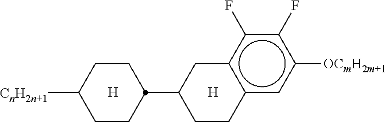

CTNaph-n-Om

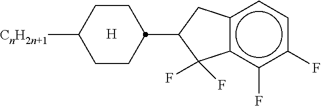

CK-n-F

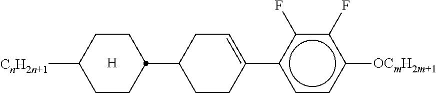

CLY-n-Om

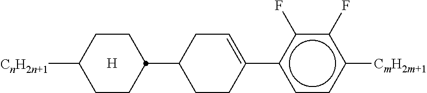

CLY-n-m

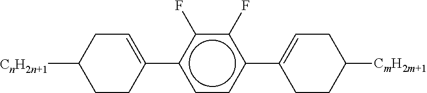

LYLI-n-m

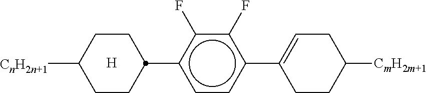

CYLI-n-m

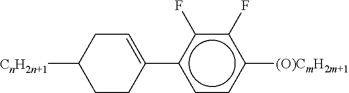

LY-n-(O)m

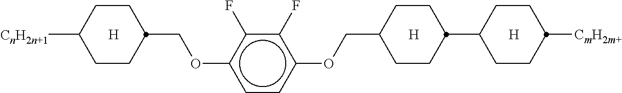

COYOICC-n-m

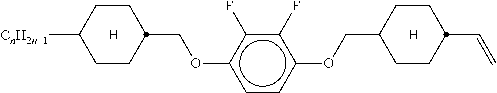

COYOIC-n-V

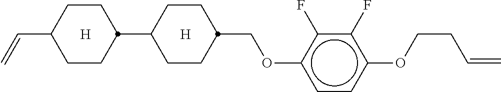

CCOY—V—O2V

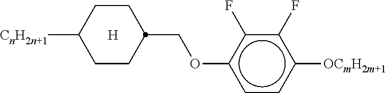

COY-n-Om

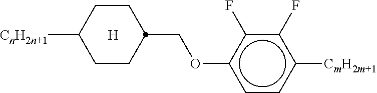

COY-n-m

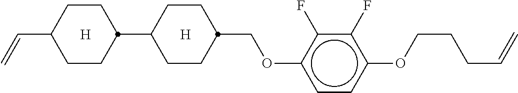

CCOY—V—O3V

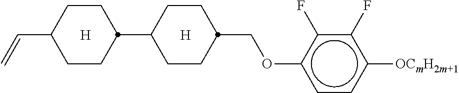

CCOY—V—Om

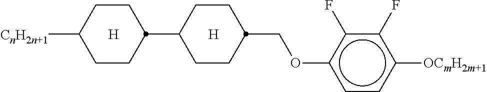

CCOY-n-Om

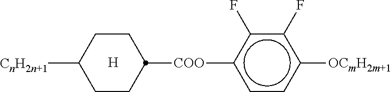

D-nOmFF

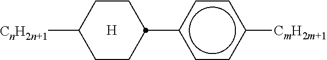

PCH-nm

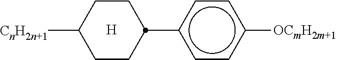

PCH-nOm

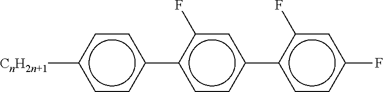

PGIGI-n-F

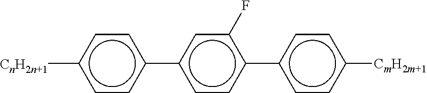

PGP-n-m

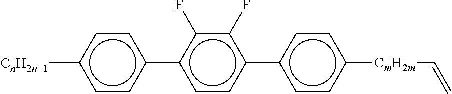

PYP-n-mV

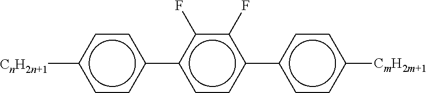

PYP-n-m

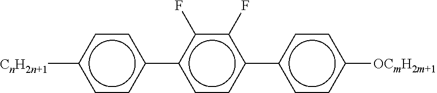

PYP-n-Om

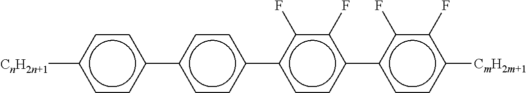

PPYY-n-m

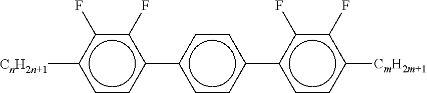

YPY-n-m

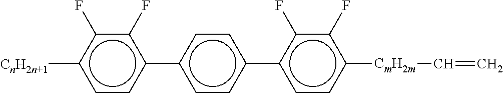

YPY-n-mV

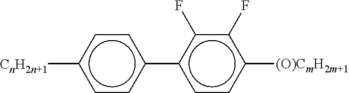

PY-n-(O)m

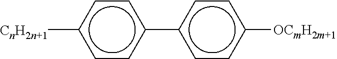

PP-n-Om

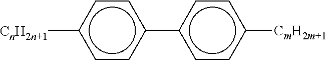

PP-n-m

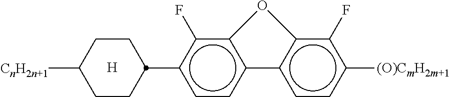

C—DFDBF-n-(O)m

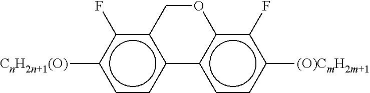

DFDBC-n(O)—(O)m

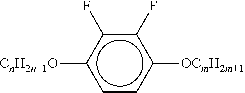

Y-nO—Om

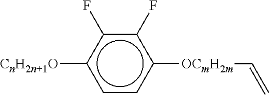

Y-nO—OmV

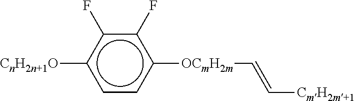

Y-nO—OmVm′

The liquid-crystal mixtures which can be used in accordance with the invention are prepared in a manner which is conventional per se. In general, the desired amount of the components used in lesser amount is dissolved in the components making up the principal constituent, advantageously at elevated temperature. It is also possible to mix solutions of the components in an organic solvent, for example in acetone, chloroform or methanol, and to remove the solvent again, for example by distillation, after thorough mixing.

By means of suitable additives, the liquid-crystal phases according to the invention can be modified in such a way that they can be employed in any type of, for example, ECB, VAN, IPS, GH or ASM-VA LCD display that has been disclosed to date.

The dielectrics may also comprise further additives known to the person skilled in the art and described in the literature, such as, for example, UV absorbers, antioxidants, nanoparticles and free-radical scavengers. For example, 0-15% of pleochroic dyes, stabilisers or chiral dopants may be added. Suitable stabilisers for the mixtures according to the invention are, in particular, those listed in Table B.

For example, 0-15% of pleochroic dyes may be added, furthermore conductive salts, preferably ethyldimethyldodecylammonium 4-hexoxybenzoate, tetrabutylammonium tetraphenylboranate or complex salts of crown ethers (cf., for example, Haller et al., Mol. Cryst. Liq. Cryst. Volume 24, pages 249-258 (1973)), may be added in order to improve the conductivity or substances may be added in order to modify the dielectric anisotropy, the viscosity and/or the alignment of the nematic phases. Substances of this type are described, for example, in DE-A 22 09 127, 22 40 864, 23 21 632, 23 38 281, 24 50 088, 26 37 430 and 28 53 728.

Table B shows possible dopants which can be added to the mixtures according to the invention. If the mixtures comprise a dopant, it is employed in amounts of 0.01-4% by weight, preferably 0.1-1.0% by weight.

TABLE B

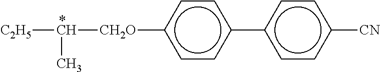

C15

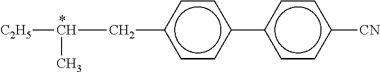

CB 15

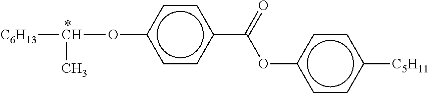

CM 21

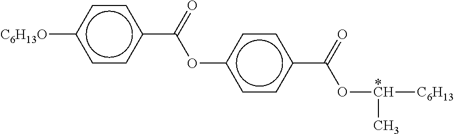

R/S-811

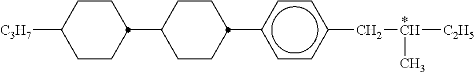

CM 44

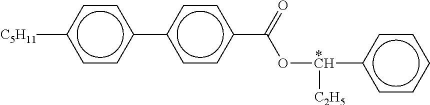

CM 45

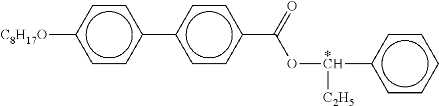

CM 47

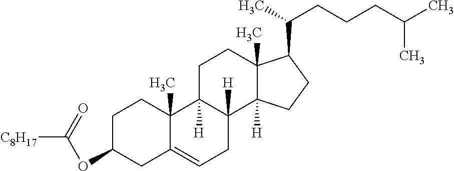

CN

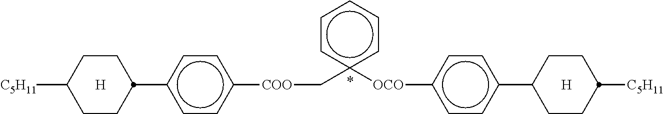

R/S-1011

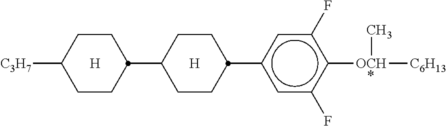

R/S-2011

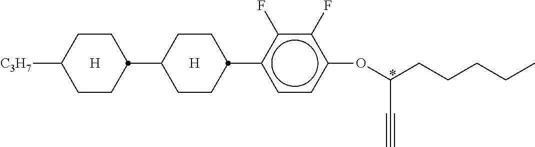

R/S-3011

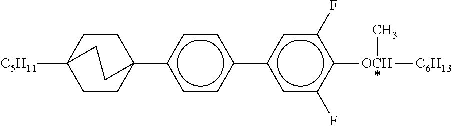

R/S-4011

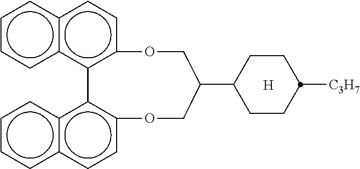

R/S-5011

Stabilisers which can be added, for example, to the mixtures according to the invention in amounts of up to 10% by weight, based on the total amount of the mixture, preferably 0.01 to 6% by weight, in particular 0.1 to 3% by weight, are shown below in Table C. Preferred stabilisers are, in particular, BHT derivatives, for example 2,6-di-tert-butyl-4-alkylphenols, and Tinuvin 770, as well as Tunivin P and Tempol.

TABLE C
(n = 1-12)

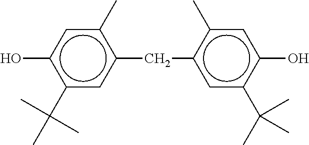

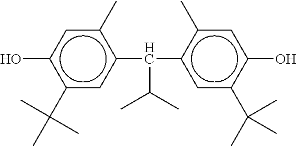

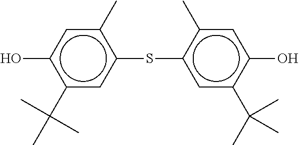

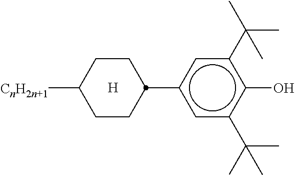

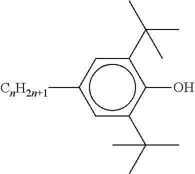

n = 1, 2, 3, 4, 5, 6 or 7

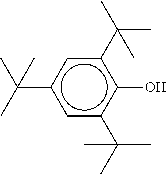

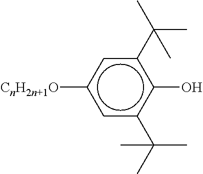

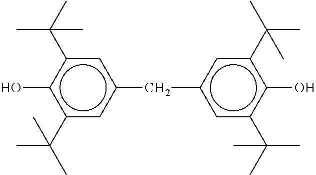

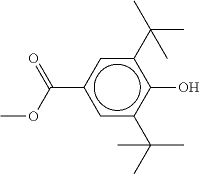

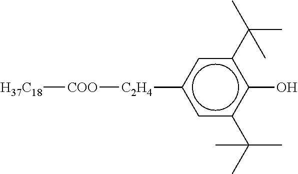

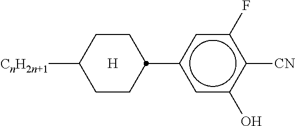

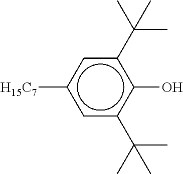

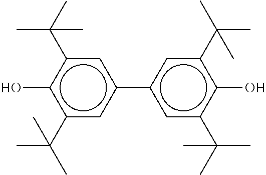

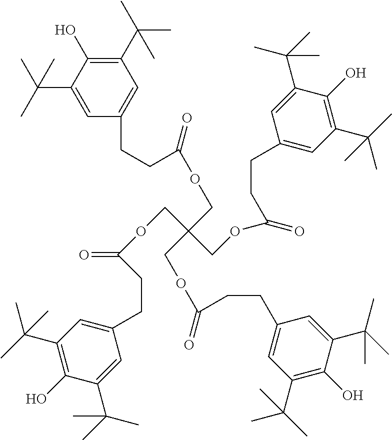 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

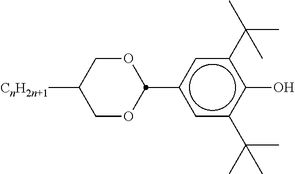

n = 1, 2, 3, 4, 5, 6 or 7

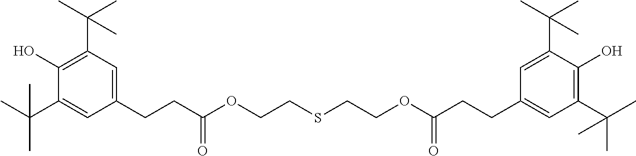 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

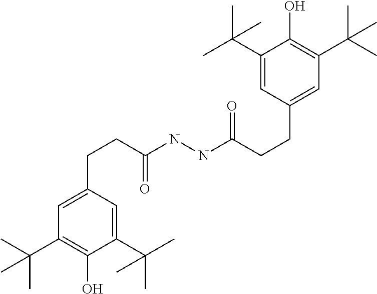 [SMILES: CC(C)(C)c1cc(CCC(=O)NNC(=O)CCc2cc(C(C)(C)C)c(O)c(C(C)(C)C)c2)cc(C(C)(C)C)c1O]

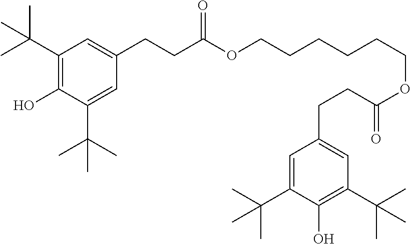 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

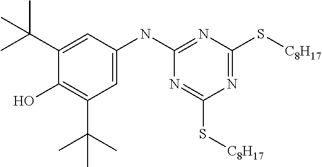

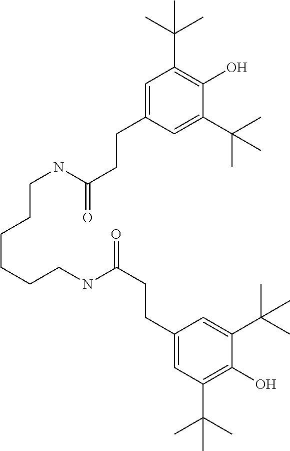 [SMILES: CC(C)(C)c1cc(CCC(=O)NCCCCCCNC(=O)CCc2cc(C(C)(C)C)c(O)c(C(C)(C)C)c2)cc(C(C)(C)C)c1O]

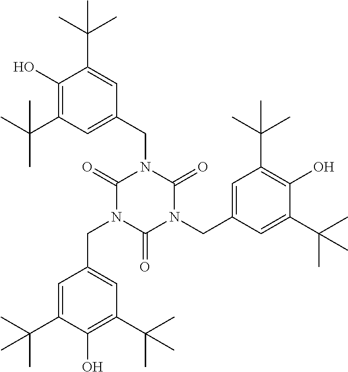 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

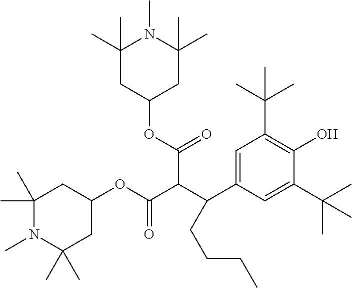 [SMILES: CCCCC(c1cc(C(C)(C)C)c(O)c(C(C)(C)C)c1)C(C(=O)OC1CC(C)(C)N(C)C(C)(C)C1)C(=O)OC1CC(C)(C)N(C)C(C)(C)C1]

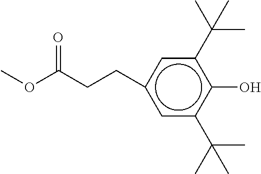

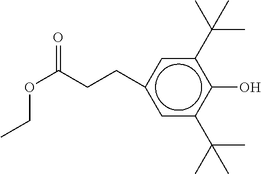

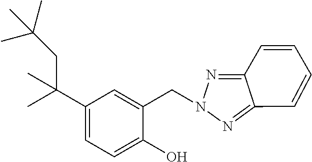 [SMILES: CC(C)(C)CC(C)(C)c1ccc(O)c(Cn2nc3ccccc3n2)c1]

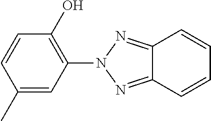 [SMILES: Cc1ccc(O)c(-n2nc3ccccc3n2)c1]

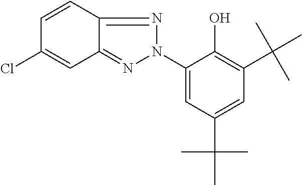 [SMILES: CC(C)(C)c1cc(-n2nc3ccc(Cl)cc3n2)c(O)c(C(C)(C)C)c1]

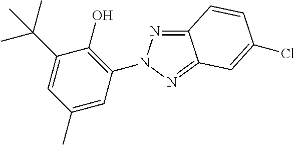 [SMILES: Cc1cc(-n2nc3ccc(Cl)cc3n2)c(O)c(C(C)(C)C)c1]

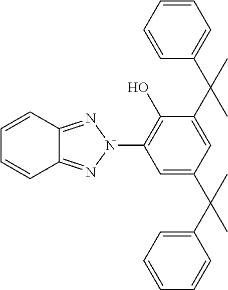 [SMILES: CC(C)(c1ccccc1)c1cc(-n2nc3ccccc3n2)c(O)c(C(C)(C)c2ccccc2)c1]

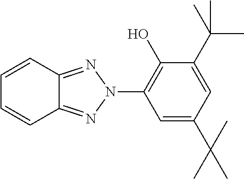 [SMILES: CC(C)(C)c1cc(-n2nc3ccccc3n2)c(O)c(C(C)(C)C)c1]

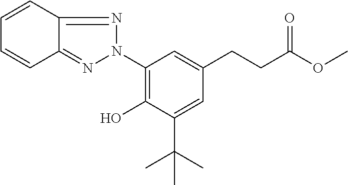 [SMILES: COC(=O)CCc1cc(-n2nc3ccccc3n2)c(O)c(C(C)(C)C)c1]

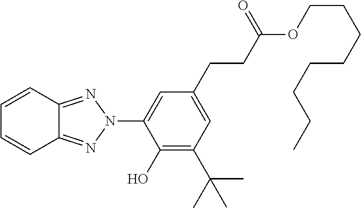 [SMILES: CCCCCCCCOC(=O)CCc1cc(-n2nc3ccccc3n2)c(O)c(C(C)(C)C)c1]

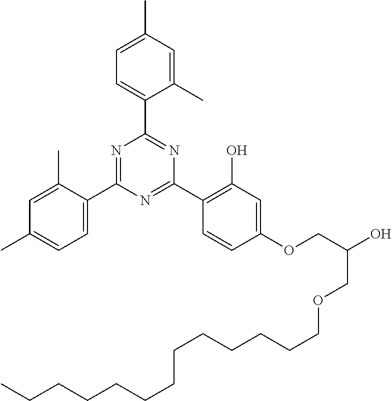 [SMILES: CCCCCCCCCCCCCOCC(O)COc1ccc(-c2nc(-c3ccc(C)cc3C)nc(-c3ccc(C)cc3C)n2)c(O)c1]

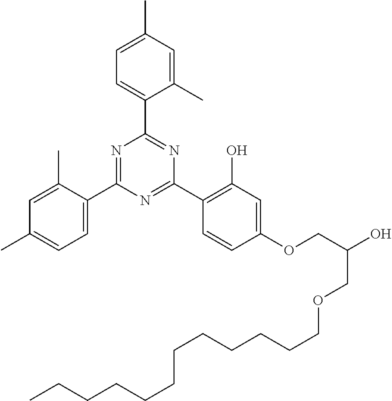 [SMILES: CCCCCCCCCCCCOCC(O)COc1ccc(-c2nc(-c3ccc(C)cc3C)nc(-c3ccc(C)cc3C)n2)c(O)c1]

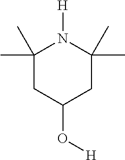

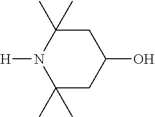

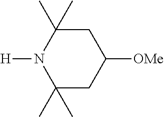

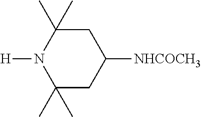

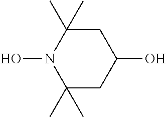

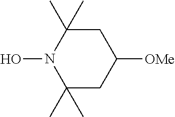

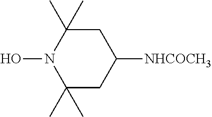

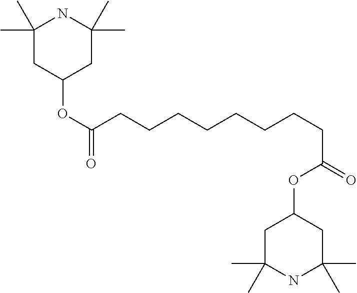

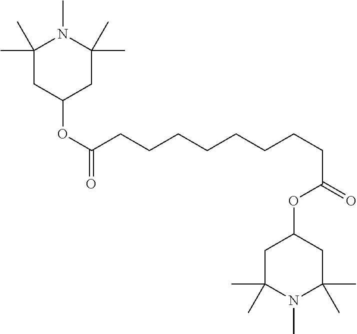

Suitable reactive mesogens (polymerisable compounds) for use in the mixtures according to the invention, preferably in PSA and PS-VA applications are shown in Table D below:

TABLE D

| | |
|---|---|
| 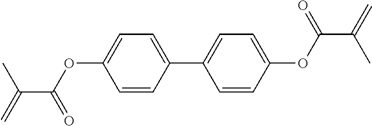 [SMILES: C=C(C)C(=O)Oc1ccc(-c2ccc(OC(=O)C(=C)C)cc2)cc1] | RM-1 |
| 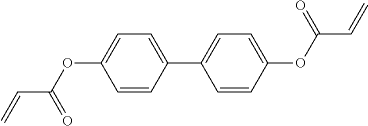 [SMILES: C=CC(=O)Oc1ccc(-c2ccc(OC(=O)C=C)cc2)cc1] | RM-2 |
| 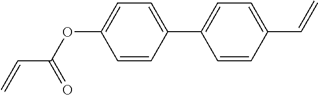 [SMILES: C=CC(=O)Oc1ccc(-c2ccc(C=C)cc2)cc1] | RM-3 |
| 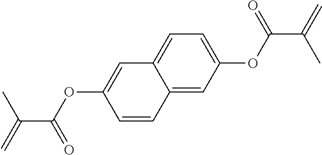 [SMILES: C=C(C)C(=O)Oc1ccc2cc(OC(=O)C(=C)C)ccc2c1] | RM-4 |
| 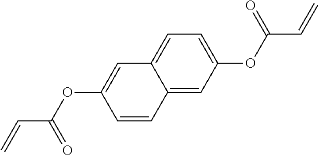 [SMILES: C=CC(=O)Oc1ccc2cc(OC(=O)C=C)ccc2c1] | RM-5 |
| 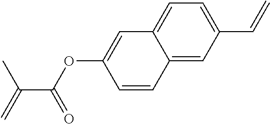 [SMILES: C=Cc1ccc2cc(OC(=O)C(=C)C)ccc2c1] | RM-6 |
| 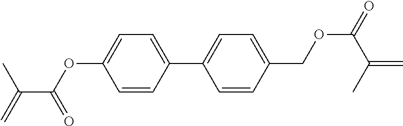 [SMILES: C=C(C)C(=O)OCc1ccc(-c2ccc(OC(=O)C(=C)C)cc2)cc1] | RM-7 |
| 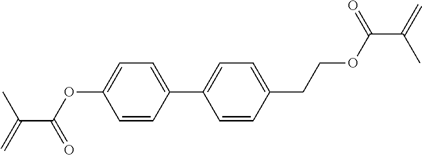 [SMILES: C=C(C)C(=O)OCCc1ccc(-c2ccc(OC(=O)C(=C)C)cc2)cc1] | RM-8 |
| 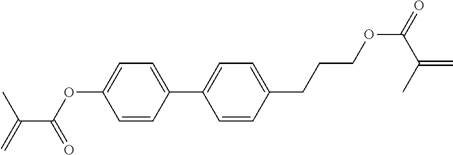 [SMILES: C=C(C)C(=O)OCCCc1ccc(-c2ccc(OC(=O)C(=C)C)cc2)cc1] | RM-9 |
| 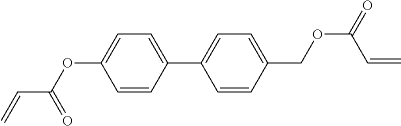 [SMILES: C=CC(=O)OCc1ccc(-c2ccc(OC(=O)C=C)cc2)cc1] | RM-10 |
| 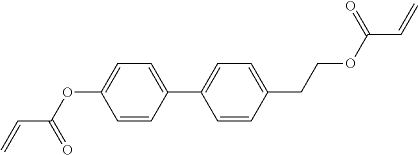 [SMILES: C=CC(=O)OCCc1ccc(-c2ccc(OC(=O)C=C)cc2)cc1] | RM-11 |
| 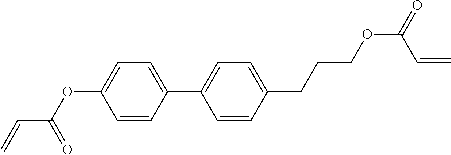 [SMILES: C=CC(=O)OCCCc1ccc(-c2ccc(OC(=O)C=C)cc2)cc1] | RM-12 |
| 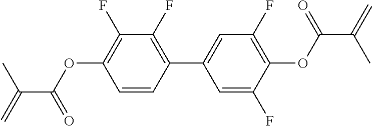 [SMILES: C=C(C)C(=O)Oc1ccc(-c2cc(F)c(OC(=O)C(=C)C)c(F)c2)c(F)c1F] | RM-13 |
| 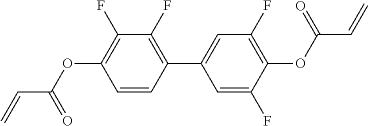 [SMILES: C=CC(=O)Oc1ccc(-c2cc(F)c(OC(=O)C=C)c(F)c2)c(F)c1F] | RM-14 |
| 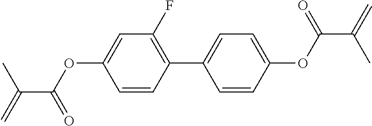 [SMILES: C=C(C)C(=O)Oc1ccc(-c2ccc(OC(=O)C(=C)C)cc2F)cc1] | RM-15 |
| 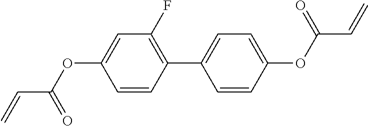 [SMILES: C=CC(=O)Oc1ccc(-c2ccc(OC(=O)C=C)cc2F)cc1] | RM-16 |
| 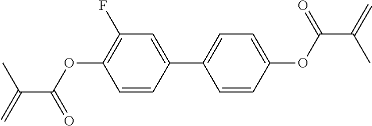 [SMILES: C=C(C)C(=O)Oc1ccc(-c2ccc(OC(=O)C(=C)C)c(F)c2)cc1] | RM-17 |
| 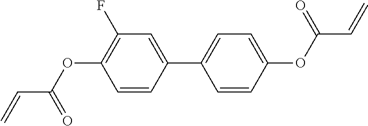 [SMILES: C=CC(=O)Oc1ccc(-c2ccc(OC(=O)C=C)c(F)c2)cc1] | RM-18 |
| 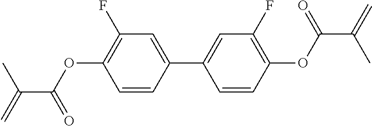 [SMILES: C=C(C)C(=O)Oc1ccc(-c2ccc(OC(=O)C(=C)C)c(F)c2)cc1F] | RM-19 |
| 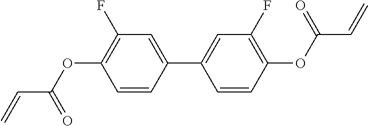 [SMILES: C=CC(=O)Oc1ccc(-c2ccc(OC(=O)C=C)c(F)c2)cc1F] | RM-20 |
| 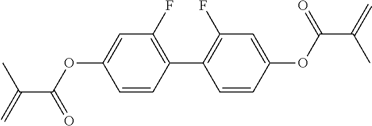 [SMILES: C=C(C)C(=O)Oc1ccc(-c2ccc(OC(=O)C(=C)C)cc2F)c(F)c1] | RM-21 |
| 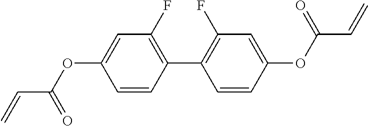 [SMILES: C=CC(=O)Oc1ccc(-c2ccc(OC(=O)C=C)cc2F)c(F)c1] | RM-22 |
| 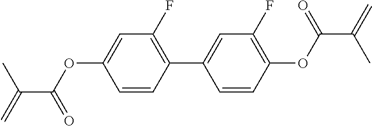 [SMILES: C=C(C)C(=O)Oc1ccc(-c2ccc(OC(=O)C(=C)C)c(F)c2)c(F)c1] | RM-23 |
| 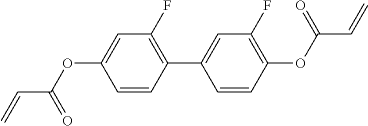 [SMILES: C=CC(=O)Oc1ccc(-c2ccc(OC(=O)C=C)c(F)c2)c(F)c1] | RM-24 |
| 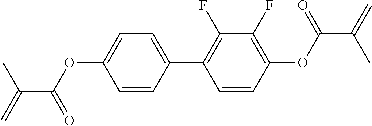 [SMILES: C=C(C)C(=O)Oc1ccc(-c2ccc(OC(=O)C(=C)C)c(F)c2F)cc1] | RM-25 |
| 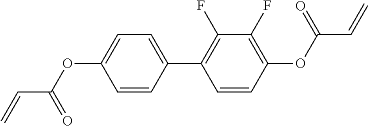 [SMILES: C=CC(=O)Oc1ccc(-c2ccc(OC(=O)C=C)c(F)c2F)cc1] | RM-26 |
| 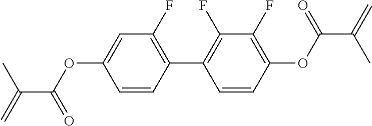 [SMILES: C=C(C)C(=O)Oc1ccc(-c2ccc(OC(=O)C(=C)C)c(F)c2F)c(F)c1] | RM-27 |
| 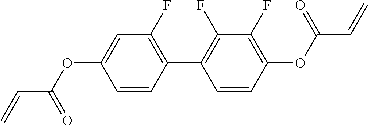 [SMILES: C=CC(=O)Oc1ccc(-c2ccc(OC(=O)C=C)c(F)c2F)c(F)c1] | RM-28 |
| 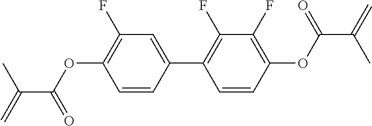 [SMILES: C=C(C)C(=O)Oc1ccc(-c2ccc(OC(=O)C(=C)C)c(F)c2F)cc1F] | RM-29 |
| 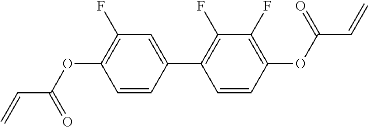 [SMILES: C=CC(=O)Oc1ccc(-c2ccc(OC(=O)C=C)c(F)c2F)cc1F] | RM-30 |
| 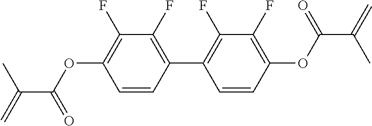 [SMILES: C=C(C)C(=O)Oc1ccc(-c2ccc(OC(=O)C(=C)C)c(F)c2F)c(F)c1F] | RM-31 |
| 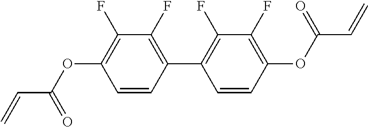 [SMILES: C=CC(=O)Oc1ccc(-c2ccc(OC(=O)C=C)c(F)c2F)c(F)c1F] | RM-32 |
| 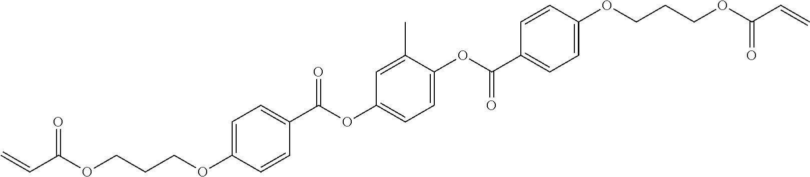 [SMILES: C=CC(=O)OCCCOc1ccc(C(=O)Oc2ccc(OC(=O)c3ccc(OCCCOC(=O)C=C)cc3)c(C)c2)cc1] | RM-33 |
| 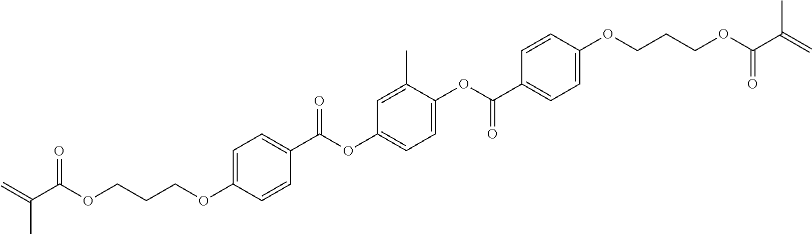 [SMILES: C=C(C)C(=O)OCCCOc1ccc(C(=O)Oc2ccc(OC(=O)c3ccc(OCCCOC(=O)C(=C)C)cc3)c(C)c2)cc1] | RM-34 |
| 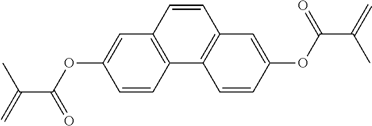 [SMILES: C=C(C)C(=O)Oc1ccc2c(ccc3cc(OC(=O)C(=C)C)ccc32)c1] | RM-35 |
| 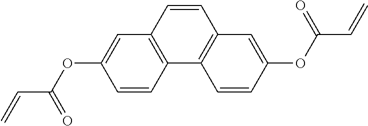 [SMILES: C=CC(=O)Oc1ccc2c(ccc3cc(OC(=O)C=C)ccc32)c1] | RM-36 |
| 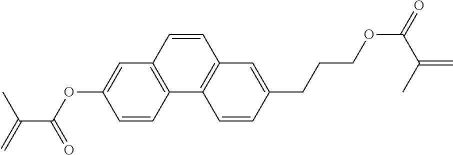 [SMILES: C=C(C)C(=O)OCCCc1ccc2c(ccc3cc(OC(=O)C(=C)C)ccc32)c1] | RM-37 |
| 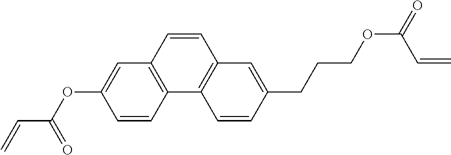 [SMILES: C=CC(=O)OCCCc1ccc2c(ccc3cc(OC(=O)C=C)ccc32)c1] | RM-38 |
| 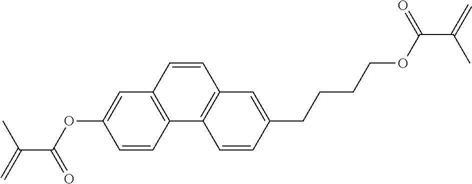 [SMILES: C=C(C)C(=O)OCCCCc1ccc2c(ccc3cc(OC(=O)C(=C)C)ccc32)c1] | RM-39 |
| 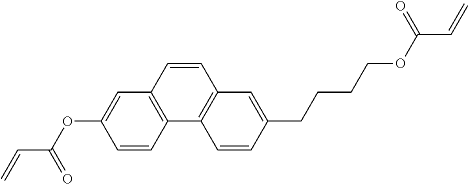 [SMILES: C=CC(=O)OCCCCc1ccc2c(ccc3cc(OC(=O)C=C)ccc32)c1] | RM-40 |
| 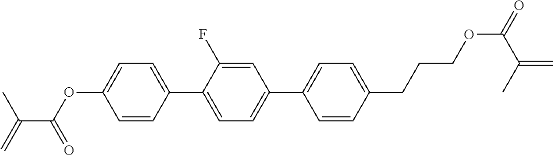 [SMILES: C=C(C)C(=O)OCCCc1ccc(-c2ccc(-c3ccc(OC(=O)C(=C)C)cc3)c(F)c2)cc1] | RM-41 |
| 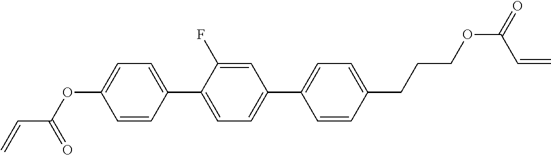 [SMILES: C=CC(=O)OCCCc1ccc(-c2ccc(-c3ccc(OC(=O)C=C)cc3)c(F)c2)cc1] | RM-42 |
| 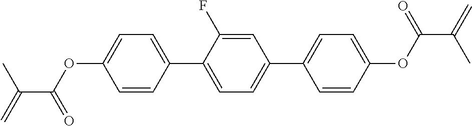 [SMILES: C=C(C)C(=O)Oc1ccc(-c2ccc(-c3ccc(OC(=O)C(=C)C)cc3)c(F)c2)cc1] | RM-43 |
| 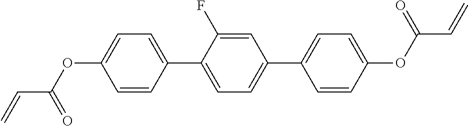 [SMILES: C=CC(=O)Oc1ccc(-c2ccc(-c3ccc(OC(=O)C=C)cc3)c(F)c2)cc1] | RM-44 |
| 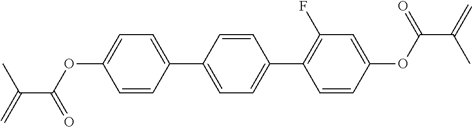 [SMILES: C=C(C)C(=O)Oc1ccc(-c2ccc(-c3ccc(OC(=O)C(=C)C)cc3F)cc2)cc1] | RM-45 |
| 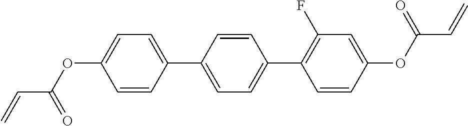 [SMILES: C=CC(=O)Oc1ccc(-c2ccc(-c3ccc(OC(=O)C=C)cc3F)cc2)cc1] | RM-46 |
| 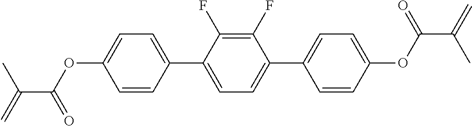 [SMILES: C=C(C)C(=O)Oc1ccc(-c2ccc(-c3ccc(OC(=O)C(=C)C)cc3)c(F)c2F)cc1] | RM-47 |
| 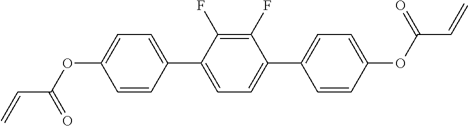 [SMILES: C=CC(=O)Oc1ccc(-c2ccc(-c3ccc(OC(=O)C=C)cc3)c(F)c2F)cc1] | RM-48 |
| 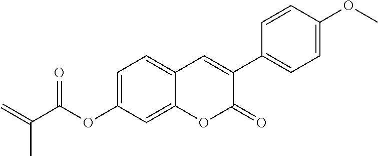 [SMILES: C=C(C)C(=O)Oc1ccc2cc(-c3ccc(OC)cc3)c(=O)oc2c1] | RM-49 |
| 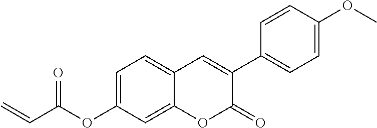 [SMILES: C=CC(=O)Oc1ccc2cc(-c3ccc(OC)cc3)c(=O)oc2c1] | RM-50 |
| 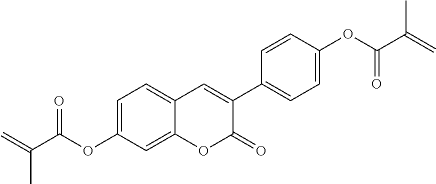 [SMILES: C=C(C)C(=O)Oc1ccc(-c2cc3ccc(OC(=O)C(=C)C)cc3oc2=O)cc1] | RM-51 |
| 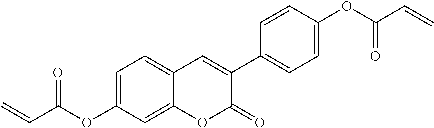 [SMILES: C=CC(=O)Oc1ccc(-c2cc3ccc(OC(=O)C=C)cc3oc2=O)cc1] | RM-52 |
| 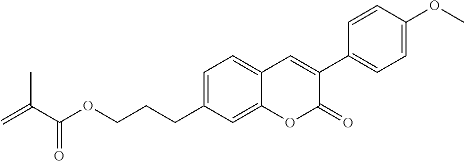 [SMILES: C=C(C)C(=O)OCCCc1ccc2cc(-c3ccc(OC)cc3)c(=O)oc2c1] | RM-53 |
| 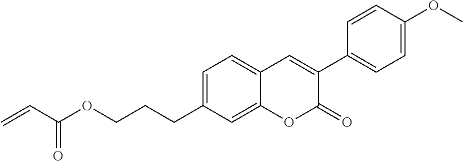 [SMILES: C=CC(=O)OCCCc1ccc2cc(-c3ccc(OC)cc3)c(=O)oc2c1] | RM-54 |
| 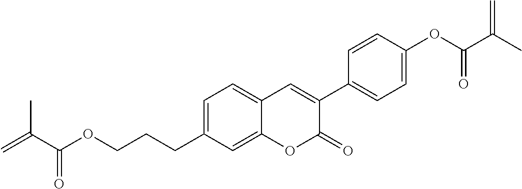 [SMILES: C=C(C)C(=O)OCCCc1ccc2cc(-c3ccc(OC(=O)C(=C)C)cc3)c(=O)oc2c1] | RM-55 |
| 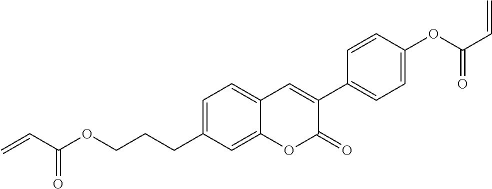 [SMILES: C=CC(=O)OCCCc1ccc2cc(-c3ccc(OC(=O)C=C)cc3)c(=O)oc2c1] | RM-56 |
| 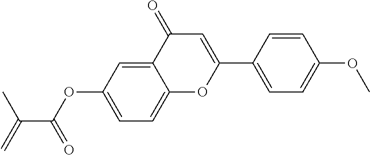 [SMILES: C=C(C)C(=O)Oc1ccc2oc(-c3ccc(OC)cc3)cc(=O)c2c1] | RM-57 |
| 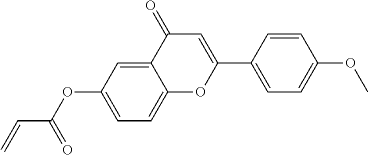 [SMILES: C=CC(=O)Oc1ccc2oc(-c3ccc(OC)cc3)cc(=O)c2c1] | RM-58 |
| 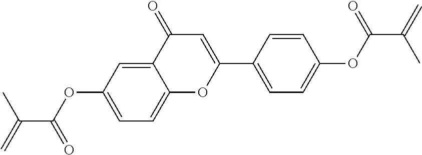 [SMILES: C=C(C)C(=O)Oc1ccc(-c2cc(=O)c3cc(OC(=O)C(=C)C)ccc3o2)cc1] | RM-59 |
| 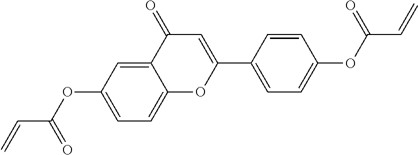 [SMILES: C=CC(=O)Oc1ccc(-c2cc(=O)c3cc(OC(=O)C=C)ccc3o2)cc1] | RM-60 |
| 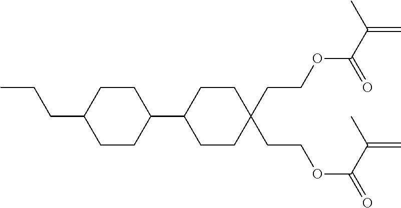 [SMILES: C=C(C)C(=O)OCCC1(CCOC(=O)C(=C)C)CCC(C2CCC(CCC)CC2)CC1] | RM-61 |
| 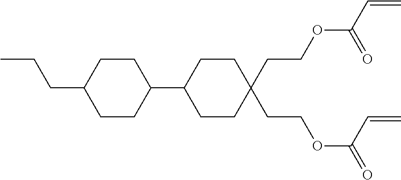 [SMILES: C=CC(=O)OCCC1(CCOC(=O)C=C)CCC(C2CCC(CCC)CC2)CC1] | RM-62 |
| 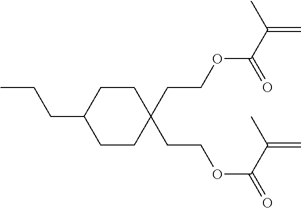 [SMILES: C=C(C)C(=O)OCCC1(CCOC(=O)C(=C)C)CCC(CCC)CC1] | RM-63 |
| 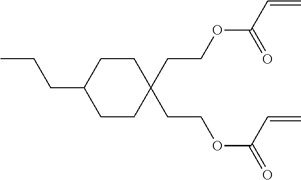 [SMILES: C=CC(=O)OCCC1(CCOC(=O)C=C)CCC(CCC)CC1] | RM-64 |
| 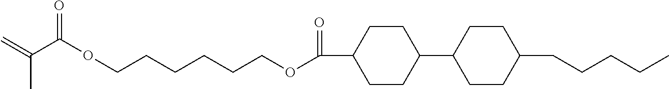 [SMILES: C=C(C)C(=O)OCCCCCCOC(=O)C1CCC(C2CCC(CCCCC)CC2)CC1] | RM-65 |
| 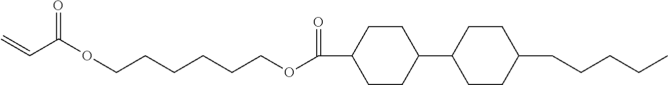 [SMILES: C=CC(=O)OCCCCCCOC(=O)C1CCC(C2CCC(CCCCC)CC2)CC1] | RM-66 |
| 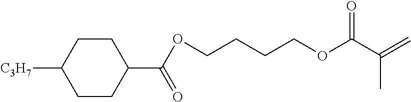 | RM-67 |
| 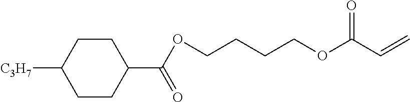 | RM-68 |
| 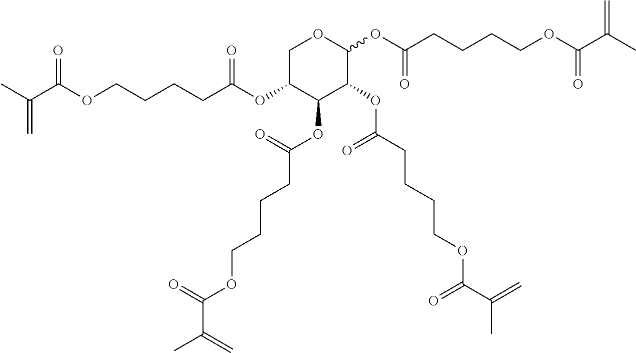 [SMILES: C=C(C)C(=O)OCCCCC(=O)OC1OC[C@@H](OC(=O)CCCCOC(=O)C(=C)C)[C@H](OC(=O)CCCCOC(=O)C(=C)C)[C@H]1OC(=O)CCCCOC(=O)C(=C)C] | RM-69 |
| 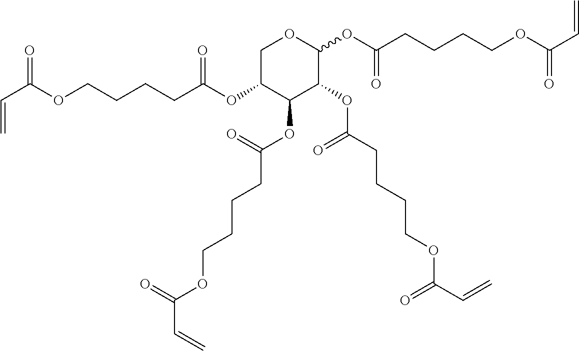 [SMILES: C=CC(=O)OCCCCC(=O)OC1OC[C@@H](OC(=O)CCCCOC(=O)C=C)[C@H](OC(=O)CCCCOC(=O)C=C)[C@H]1OC(=O)CCCCOC(=O)C=C] | RM-70 |
| 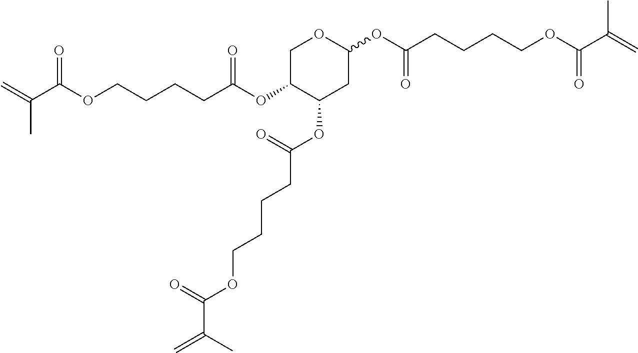 [SMILES: C=C(C)C(=O)OCCCCC(=O)OC1C[C@H](OC(=O)CCCCOC(=O)C(=C)C)[C@H](OC(=O)CCCCOC(=O)C(=C)C)CO1] | RM-71 |
| 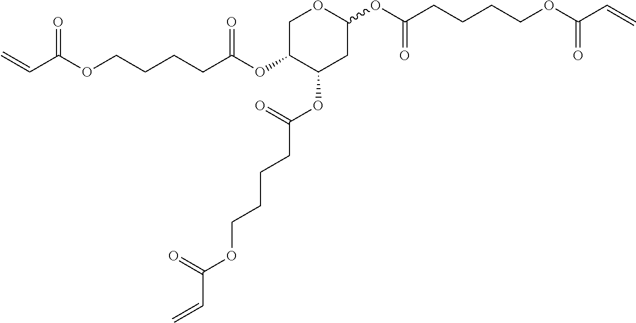 [SMILES: C=CC(=O)OCCCCC(=O)OC1C[C@H](OC(=O)CCCCOC(=O)C=C)[C@H](OC(=O)CCCCOC(=O)C=C)CO1] | RM-72 |
| 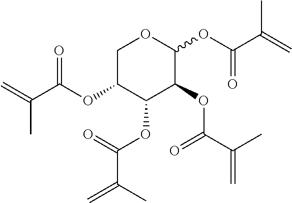 [SMILES: C=C(C)C(=O)OC1OC[C@@H](OC(=O)C(=C)C)[C@@H](OC(=O)C(=C)C)[C@@H]1OC(=O)C(=C)C] | RM-73 |
| 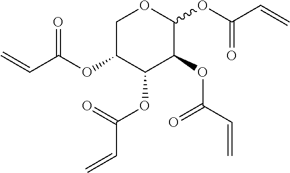 [SMILES: C=CC(=O)OC1OC[C@@H](OC(=O)C=C)[C@@H](OC(=O)C=C)[C@@H]1OC(=O)C=C] | RM-74 |

### WORKING EXAMPLES

The following examples are intended to explain the invention without restricting it.

Unless explicitly noted otherwise, all temperature values indicated in the present application, for example the melting point T(C,N), the transition from the smectic (S) phase to the nematic (N) phase T(S,N) and the clearing point T(N,I), are indicated in degrees Celsius (° C.). M.p. denotes melting point, cl.p.=clearing point. Furthermore, C=crystalline state, N=nematic phase, S=smectic phase and I=isotropic phase. The figures between these symbols represent the transition temperatures.

The host mixture used for determination of the optical anisotropy Δn of the compounds of the formula I is the commercial mixture ZLI-4792 (Merck KGaA). The dielectric anisotropy Δε is determined using commercial mixture ZLI-2857. The physical data of the compound to be investigated are obtained from the change in the dielectric constants of the host mixture after addition of the compound to be investigated and extrapolation to 100% of the compound employed. In general, 10% of the compound to be investigated are dissolved in the host mixture, depending on the solubility.

Unless indicated otherwise, parts or per cent data denote parts by weight or per cent by weight.

Above and below,
V₀ denotes threshold voltage, capacitive [V] at 20° C.
nₑ denotes extraordinary refractive index at 20° C. and 589 nm,
nₒ denotes ordinary refractive index at 20° C. and 589 nm,
Δn denotes optical anisotropy at 20° C. and 589 nm
ε_{⊥} denotes dielectric susceptability perpendicular to the director at 20° C. and 1 kHz,
ε_{∥} denotes dielectric susceptability parallel to the director at 20° C. and 1 kHz,
Δε denotes dielectric anisotropy at 20° C. and 1 kHz
cl.p., T(N,I) denotes clearing point [° C.]
γ₁ denotes he rotational viscosity measured at 20° C. [mPa·s], determined by the rotation method in a magnetic field
K₁ denotes elastic constant, “splay” deformation at 20° C. [pN]
K₃ denotes elastic constant, “bend” deformation at 20° C. [pN]
LTS denotes low-temperature stability (nematic phase), determined in test cells,
HR₂₀ denotes voltage holding ratio at 20° C. [%] and
HR₁₀₀ denotes voltage holding ratio at 100° C. [%].

The display used for measurement of the threshold voltage has two plane-parallel outer plates at a separation of 20 μm and electrode layers with overlying alignment layers of SE-1211 (Nissan Chemicals) on the insides of the outer plates, which effect a homeotropic alignment of the liquid crystals.

All concentrations in this application relate to the corresponding mixture or mixture component, unless explicitly indicated otherwise. All physical properties are determined as described in “Merck Liquid Crystals, Physical Properties of Liquid Crystals”, status November 1997, Merck KGaA, Germany, and apply for a temperature of 20° C., unless explicitly indicated otherwise.

Unless explicitly noted otherwise, all concentrations and % values (with the exception of the values for HR, contrast and transmission) in the present application are indicated in per cent by weight and relate to the corresponding mixture as a whole comprising all solid or liquid-crystalline components, without solvent.

The term “threshold voltage” for the present invention relates to the capacitive threshold (V₀), also called the Freedericks threshold, unless explicitly indicated otherwise. In the examples, as generally usual, the optical threshold for 10% relative contrast (V₁₀) may also be indicated.

The display used for measurement of the capacitive threshold voltage consists of two plane-parallel glass outer plates at a separation of 20 μm, each of which has, on the inside, an electrode layer and an unrubbed polyimide alignment layer on top, which effect a homeotropic edge alignment of the liquid-crystal molecules.

The display or test cell used for measurement of the tilt angles consists of two plane-parallel glass outer plates at a separation of 4 μm, each of which has, on the inside, an electrode layer and a polyimide alignment layer on top, where the two polyimide layers are rubbed antiparallel to one another and effect a homeotropic edge alignment of the liquid-crystal molecules.

The polymerisable compounds are polymerised in the display or test cell by irradiation with UVA light for a pre-specified time, with a voltage simultaneously being applied to the display (usually 10 V to 30 V alternating current, 1 kHz). In the examples, unless indicated otherwise, a metal halide lamp and an intensity of 100 mW/cm² are used for the polymerisation, and the intensity is measured using a standard UVA meter (Hoenle high end UV meter with UVA sensor).

The tilt angle is determined by rotational crystal experiment (Autronic-Melchers TBA-105). A low value (i.e. a large deviation from the 90° angle) corresponds to a large tilt here.

The VHR value is measured as follows: 0.3% of a polymerisable monomeric compound is added to the LC host mixture, and the resultant mixture is introduced into VA-VHR test cells (unrubbed at 90°, VA-polyimide alignment layer, layer thickness d≈6 μm). The HR value is determined after 5 min at 100° C. before and after UV exposure at 1 V, 60 Hz, 64 μs pulse (measuring instrument: Autronic-Melchers VHRM-105).

### MIXTURE EXAMPLES

### Example M1

| | | | |
|---|---|---|---|
| CY-3-O2 | 22.00% | Clearing point [° C.]: | 79.5 |
| CY-5-O2 | 2.00% | Δn [589 nm, 20° C.]: | 0.0942 |
| CCOY-3-O2 | 8.00% | Δε [1 kHz, 20° C.]: | −3.0 |
| CPY-2-O2 | 7.00% | ε_{∥} [1 kHz, 20° C.]: | 3.4 |
| CPY-3-O2 | 10.00% | K₃ [pN, 20° C.]: | 15.5 |
| CCH-34 | 6.00% | K₃/K₁ [20° C.]: | 1.08 |
| CCH-23 | 22.00% | γ₁ [mPa · s, 20° C.]: | 112 |
| CCP-3-3 | 7.50% | V₀ [20° C., V]: | 2.41 |
| CCP-3-1 | 7.00% | VHR (initial): | 98.6% |
| BCH-32 | 6.00% | VHR (15 min UVA): | 94.5% |
| PCH-301 | 2.50% | VHR (2 min UVA + 2 h suntest): | 91.6% |

### Example M2

| | | | |
|---|---|---|---|
| CY-3-O2 | 12.00% | Clearing point [° C.]: | 79.5 |
| COY-3-O2 | 12.00% | Δn [589 nm, 20° C.]: | 0.0955 |
| CCY-3-O2 | 4.00% | Δε [1 kHz, 20° C.]: | −3.0 |
| CPY-2-O2 | 9.00% | ε_{∥} [1 kHz, 20° C.]: | 3.4 |
| CPY-3-O2 | 10.00% | K₃ [pN, 20° C.]: | 15.3 |
| CCH-34 | 6.00% | K₃/K₁ [20° C.]: | 1.03 |
| CCH-23 | 22.00% | γ₁ [mPa · s, 20° C.]: | 108 |
| CCP-3-3 | 8.00% | V₀ [20° C., V]: | 2.39 |
| CCP-3-1 | 8.00% | VHR (initial): | 98.4% |
| BCH-32 | 6.00% | VHR (15 min UVA): | 93.5% |
| PCH-301 | 3.00% | VHR (2 min UVA + 2 h suntest): | 89.0% |

### Example M3

| | | | |
|---|---|---|---|
| COY-3-O2 | 21.00% | Clearing point [° C.]: | 79.5 |
| CCY-3-O2 | 3.00% | Δn [589 nm, 20° C.]: | 0.0959 |
| CPY-2-O2 | 10.00% | Δε [1 kHz, 20° C.]: | −3.0 |
| CPY-3-O2 | 10.00% | ε_{∥} [1 kHz, 20° C.]: | 3.5 |
| CCH-34 | 6.00% | K₃ [pN, 20° C.]: | 14.9 |
| CCH-23 | 22.00% | K₃/K₁ [20° C.]: | 1.03 |
| CCP-3-3 | 8.00% | γ₁ [mPa · s, 20° C.]: | 108 |
| CCP-3-1 | 8.00% | VHR (initial): | 98.4% |
| BCH-32 | 6.00% | VHR (15 min UVA): | 91.0% |
| PCH-301 | 6.00% | VHR (2 min UVA + 2 h suntest): | 86.4% |

### Example M4

For the preparation of a PS-VA mixture, 0.3% of RM1 (biphenyl 4,4′-dimethacrylate)

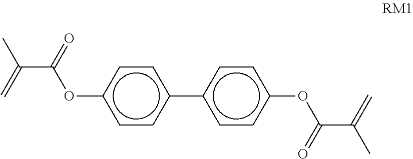

is added to the liquid-crystal mixture in accordance with Example M1.

The PS-VA mixture is introduced into a cell having homeotropic alignment. After application of a voltage of 24 V, the cell is irradiated with UV light with a power of 100 mW/cm². The following tilt angles have then become established:

| Irradiation | |
|---|---|
| duration/min | Tilt angle/° |
| 0 | 89.4 |
| 0.5 | 89.1 |
| 1 | 87.0 |
| 2 | 83.4 |
| 4 | 79.6 |
| 6 | 77.1 |

The values measured for the holding ratio are

VHR (initial): 98.4%

VHR (15 min UVA): 97.8%

VHR (2 min UVA+2 h suntest): 97.8%.

### Example M5

For the preparation of a PS-VA mixture, 0.3% of RM1 (biphenyl 4,4′-dimethacrylate)

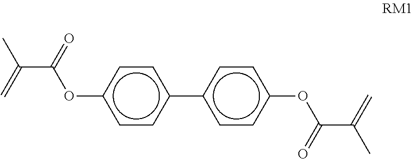

is added to the liquid-crystal mixture in accordance with Example M2.

The PS-VA mixture is introduced into a cell having homeotropic alignment. After application of a voltage of 24 V, the cell is irradiated with UV light with a power of 100 mW/cm². The following tilt angles have then become established:

| Irradiation | |
|---|---|
| duration/min | Tilt angle/° |
| 0 | 89.4 |
| 0.5 | 89.0 |
| 1 | 86.8 |
| 2 | 83.5 |
| 4 | 79.3 |
| 6 | 76.9 |

The values measured for the holding ratio are

VHR (initial): 98.1%

VHR (15 min UVA): 97.7%

VHR (2 min UVA+2 h suntest): 97.5%.

### Example M6

For the preparation of a PS-VA mixture, 0.3% of RM1 (biphenyl 4,4′-dimethacrylate)

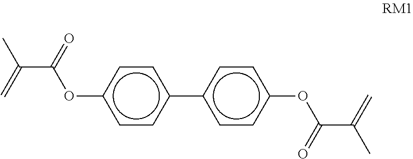

is added to the liquid-crystal mixture in accordance with Example M3.

The PS-VA mixture is introduced into a cell having homeotropic alignment. After application of a voltage of 24 V, the cell is irradiated with UV light with a power of 100 mW/cm². The following tilt angles have then become established:

| Irradiation | |
|---|---|
| duration/min | Tilt angle/° |
| 0 | 89.3 |
| 0.5 | 89.0 |
| 1 | 86.8 |
| 2 | 83.2 |
| 4 | 78.7 |
| 6 | 76.5 |

The values measured for the holding ratio are

VHR (initial): 98.2%

VHR (15 min UVA): 97.6%

VHR (2 min UVA+2 h suntest): 97.1%.

### Example M7

| | | | |
|---|---|---|---|
| COY-3-O2 | 12.00% | Clearing point [° C.]: | 85.5 |
| COY-3-O4 | 12.00% | Δn [589 nm, 20° C.]: | 0.0963 |
| CCY-3-O2 | 9.00% | Δε [1 kHz, 20° C.]: | −4.2 |
| CCY-3-O3 | 8.00% | K₁ [pN, 20° C.]: | 13.6 |
| CCY-4-O2 | 9.00% | K₃ [pN, 20° C.]: | 15.5 |
| CPY-2-O2 | 7.00% | γ₁ [mPa · s, 20° C.]: | 164 |
| CPY-3-O2 | 7.00% | V₀ [20° C., V]: | 2.04 |
| BCH-32 | 6.00% | | |
| CCH-34 | 14.00% | | |
| CCH-35 | 6.00% | | |
| PCH-301 | 10.00% | | |

### Example M8

| | | | |
|---|---|---|---|
| COY-3-O2 | 11.00% | Clearing point [° C.]: | 85.5 |
| COY-3-O4 | 11.00% | Δn [589 nm, 20° C.]: | 0.0961 |
| CCOY-3-O2 | 8.00% | Δε [1 kHz, 20° C.]: | −4.2 |
| CCY-3-O2 | 10.00% | K₁ [pN, 20° C.]: | 14.1 |
| CCY-4-O2 | 10.00% | K₃ [pN, 20° C.]: | 16.5 |
| CPY-2-O2 | 5.00% | γ₁ [mPa · s, 20° C.]: | 164 |
| CPY-3-O2 | 7.00% | V₀ [20° C., V]: | 2.13 |
| BCH-32 | 6.00% | | |
| CCH-34 | 14.00% | | |
| CCH-35 | 6.00% | | |
| PCH-301 | 12.00% | | |

### Example M9

| | | | |
|---|---|---|---|
| CC-3-V | 38.50% | Clearing point [° C.]: | 74.5 |
| CCY-4-O2 | 10.50% | Δn [589 nm, 20° C.]: | 0.1056 |
| CPY-2-O2 | 11.00% | Δε [1 kHz, 20° C.]: | −3.1 |
| CPY-3-O2 | 11.00% | K₁ [pN, 20° C.]: | 12.4 |
| COY-3-O2 | 13.00% | K₃ [pN, 20° C.]: | 13.7 |
| COY-3-O4 | 4.00% | γ₁ [mPa · s, 20° C.]: | 98 |
| PYP-2-4 | 9.00% | V₀ [20° C., V]: | 2.19 |
| PYP-2-3 | 3.00% | | |

### Example M10

| | | | |
|---|---|---|---|
| BCH-32 | 11.00% | Clearing point [° C.]: | 75.5 |
| CCH-23 | 20.00% | Δn [589 nm, 20° C.]: | 0.1037 |
| CCH-301 | 1.50% | Δε [1 kHz, 20° C.]: | −3.2 |
| CCH-34 | 6.00% | K₁ [pN, 20° C.]: | 14.7 |
| CCH-35 | 7.00% | K₃ [pN, 20° C.]: | 14.6 |
| CCY-3-O2 | 12.00% | γ₁ [mPa · s, 20° C.]: | 116 |
| CPY-2-O2 | 5.00% | V₀ [20° C., V]: | 2.24 |
| CPY-3-O2 | 12.00% | | |
| PY-3-O2 | 12.00% | | |
| COY-3-O2 | 13.50% | | |

### Example M11

For the preparation of a PS-VA mixture, 0.3% of RM1

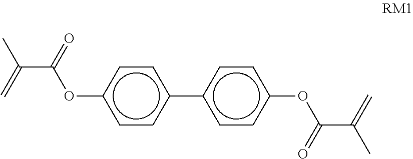

is added to the liquid-crystal mixture in accordance with Example M10.

The PS-VA mixture is introduced into a cell having homeotropic alignment. After application of a voltage of 24 V, the cell is irradiated with UV light with a power of 100 mW/cm². The tilt angles have then become established:

### Example M12

| | | | |
|---|---|---|---|
| BCH-32 | 7.50% | Clearing point [° C.]: | 75.0 |
| CC-3-V1 | 10.00% | Δn [589 nm, 20° C.]: | 0.1040 |
| CCH-23 | 10.00% | Δε [1 kHz, 20° C.]: | −3.1 |
| CCH-301 | 3.00% | K₁ [pN, 20° C.]: | 14.8 |
| CCH-34 | 5.00% | K₃ [pN, 20° C.]: | 15.5 |
| CCH-35 | 9.00% | γ₁ [mPa · s, 20° C.]: | 111 |
| CCY-3-O2 | 10.50% | V₀ [20° C., V]: | 2.35 |
| CPY-2-O2 | 7.00% | | |
| CPY-3-O2 | 11.00% | | |
| PCH-301 | 3.00% | | |
| PY-3-O2 | 13.00% | | |
| COY-3-O2 | 11.00% | | |

### Example M13

For the preparation of a PS-VA mixture, 0.3% of RM25

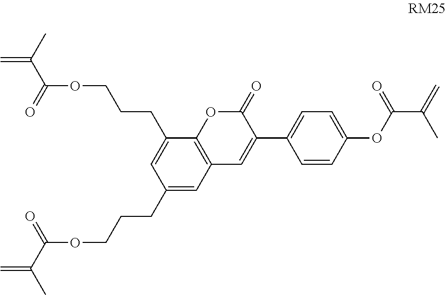 [SMILES: C=C(C)C(=O)OCCCc1cc(CCCOC(=O)C(=C)C)c2oc(=O)c(-c3ccc(OC(=O)C(=C)C)cc3)cc2c1]

is added to the liquid-crystal mixture in accordance with Example M12.

The PS-VA mixture is introduced into a cell having homeotropic alignment. After application of a voltage of 24 V, the cell is irradiated with UV light with a power of 100 mW/cm². The tilt angles have then become established:

### Example M14

| | | | |
|---|---|---|---|
| CC-3-V | 39.00% | Clearing point [° C.]: | 76.0 |
| CCY-3-O2 | 13.00% | Δn [589 nm, 20° C.]: | 0.1092 |
| CCY-3-O3 | 2.00% | Δε [1 kHz, 20° C.]: | −3.4 |
| CPY-2-O2 | 11.00% | K₁ [pN, 20° C.]: | 13.7 |
| CPY-3-O2 | 12.00% | K₃ [pN, 20° C.]: | 15.0 |
| PY-3-O2 | 13.50% | γ₁ [mPa · s, 20° C.]: | 100 |
| PYP-2-4 | 4.50% | V₀ [20° C., V]: | 2.24 |
| COY-3-O2 | 5.00% | | |

### Example M15

| | | | |
|---|---|---|---|
| COY-3-O2 | 16.00% | Clearing point [° C.]: | 81.0 |
| CCY-3-O2 | 9.00% | Δn [589 nm, 20° C.]: | 0.0931 |
| CPY-2-O2 | 5.00% | Δε [1 kHz, 20° C.]: | −2.9 |
| CPY-3-O2 | 10.00% | K₁ [pN, 20° C.]: | 15.0 |
| CCH-34 | 7.00% | K₃ [pN, 20° C.]: | 15.6 |
| CCH-23 | 21.00% | γ₁ [mPa · s, 20° C.]: | 108 |
| CCP-3-3 | 6.00% | V₀ [20° C., V]: | 2.42 |
| CCP-3-1 | 10.00% | | |
| BCH-32 | 6.00% | | |
| Y-4O-O4 | 7.00% | | |
| CBC-33 | 3.00% | | |

### Example M16

| | | | |
|---|---|---|---|
| COY-3-O2 | 5.00% | Clearing point [° C.]: | 75.0 |
| CCY-3-O2 | 8.00% | Δn [589 nm, 20° C.]: | 0.1061 |
| CLY-3-O2 | 8.00% | Δε [1 kHz, 20° C.]: | −3.0 |
| CPY-2-O2 | 7.00% | K₁ [pN, 20° C.]: | 13.1 |
| CPY-3-O2 | 10.00% | K₃ [pN, 20° C.]: | 14.6 |
| PYP-2-3 | 10.00% | γ₁ [mPa · s, 20° C.]: | 83 |
| PYP-2-4 | 2.00% | V₀ [20° C., V]: | 2.33 |
| CC-3-V | 36.00% | | |
| CC-3-V1 | 4.00% | | |
| CCP-V-1 | 3.00% | | |
| Y-4O-O4 | 7.00% | | |

### Example M17

| | | | |
|---|---|---|---|
| COY-3-O2 | 5.00% | Clearing point [° C.]: | 75.0 |
| CCOY-3-O2 | 4.00% | Δn [589 nm, 20° C.]: | 0.1071 |
| CCY-3-O2 | 4.00% | Δε [1 kHz, 20° C.]: | −3.0 |
| CLY-3-O2 | 8.00% | K₁ [pN, 20° C.]: | 13.3 |
| CPY-2-O2 | 6.00% | K₃ [pN, 20° C.]: | 14.8 |
| CPY-3-O2 | 10.00% | γ₁ [mPa · s, 20° C.]: | 85 |
| PYP-2-3 | 10.00% | V₀ [20° C., V]: | 2.36 |
| PYP-2-4 | 3.00% | | |
| CC-3-V | 34.00% | | |
| CC-3-V1 | 6.00% | | |
| CCP-V-1 | 3.00% | | |
| Y-4O-O4 | 7.00% | | |

### Example M18

| | | | |
|---|---|---|---|
| COY-3-O2 | 18.00% | Clearing point [° C.]: | 74.0 |
| CCY-3-O3 | 4.00% | Δn [589 nm, 20° C.]: | 0.1280 |
| CPY-2-O2 | 10.00% | Δε [1 kHz, 20° C.]: | −3.2 |
| CPY-3-O2 | 12.00% | K₁ [pN, 20° C.]: | 13.0 |
| CCH-34 | 10.00% | K₃ [pN, 20° C.]: | 12.9 |
| CCH-23 | 19.00% | γ₁ [mPa · s, 20° C.]: | 128 |
| PYP-2-3 | 14.00% | V₀ [20° C., V]: | 2.06 |
| PYP-2-4 | 13.00% | | |

### Example M19

| | | | |
|---|---|---|---|
| COY-3-O2 | 17.00% | Clearing point [° C.]: | 74.0 |
| CCOY-3-O2 | 4.00% | Δn [589 nm, 20° C.]: | 0.1280 |
| CPY-2-O2 | 10.00% | Δε [1 kHz, 20° C.]: | −3.2 |
| CPY-3-O2 | 12.00% | K₁ [pN, 20° C.]: | 13.3 |
| CCH-34 | 10.00% | K₃ [pN, 20° C.]: | 13.1 |
| CCH-23 | 20.00% | γ₁ [mPa · s, 20° C.]: | 127 |
| PYP-2-3 | 14.00% | V₀ [20° C., V]: | 2.10 |
| PYP-2-4 | 13.00% | | |

### Example M20

For the preparation of a PS-VA mixture, 0.3% of RM10

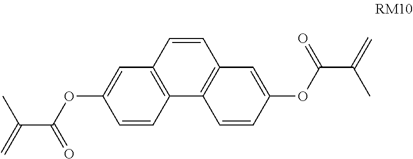 [SMILES: C=C(C)C(=O)Oc1ccc2c(ccc3cc(OC(=O)C(=C)C)ccc32)c1]

is added to the liquid-crystal mixture in accordance with Example M19.

The PS-VA mixture is introduced into a cell having homeotropic alignment. After application of a voltage of 24 V, the cell is irradiated with UV light with a power of 100 mW/cm². The tilt angles have then become established:

### Example M21

| | | | |
|---|---|---|---|
| CY-3-O2 | 10.00% | Clearing point [° C.]: | 74.5 |
| COY-3-O2 | 7.00% | Δn [589 nm, 20° C.]: | 0.1069 |
| CCY-3-O2 | 11.00% | Δε [1 kHz, 20° C.]: | −3.1 |
| CPY-2-O2 | 9.00% | K₁ [pN, 20° C.]: | 13.6 |
| CPY-3-O2 | 10.00% | K₃ [pN, 20° C.]: | 14.3 |
| CCH-23 | 24.00% | γ₁ [mPa · s, 20° C.]: | 105 |
| CCH-34 | 5.00% | V₀ [20° C., V]: | 2.26 |
| PYP-2-3 | 7.00% | | |
| PYP-2-4 | 7.00% | | |
| CC-3-V1 | 8.00% | | |
| PCH-301 | 2.00% | | |

### Example M22

| | | | |
|---|---|---|---|
| COY-3-O2 | 16.00% | Clearing point [° C.]: | 74.5 |
| CCY-3-O2 | 11.00% | Δn [589 nm, 20° C.]: | 0.1068 |
| CPY-2-O2 | 8.00% | Δε [1 kHz, 20° C.]: | −3.0 |
| CPY-3-O2 | 10.00% | K₁ [pN, 20° C.]: | 13.8 |
| CCH-23 | 24.00% | K₃ [pN, 20° C.]: | 14.5 |
| CCH-34 | 6.00% | γ₁ [mPa · s, 20° C.]: | 105 |
| PYP-2-3 | 10.00% | V₀ [20° C., V]: | 2.29 |
| PYP-2-4 | 5.00% | | |
| CC-3-V1 | 8.00% | | |
| PCH-301 | 2.00% | | |

Example M23

| | | | |
|---|---|---|---|
| COY-3-O2 | 15.00% | Clearing point [° C.]: | 74.5 |
| CCOY-3-O2 | 5.00% | Δn [589 nm, 20° C.]: | 0.1069 |
| CCY-3-O2 | 6.00% | Δε [1 kHz, 20° C.]: | −3.0 |
| CPY-2-O2 | 8.00% | K₁ [pN, 20° C.]: | 14.0 |
| CPY-3-O2 | 10.00% | K₃ [pN, 20° C.]: | 14.7 |
| CCH-23 | 24.00% | γ₁ [mPa · s, 20° C.]: | 104 |
| CCH-34 | 5.00% | V₀ [20° C., V]: | 2.34 |
| PYP-2-3 | 10.00% | | |
| PYP-2-4 | 5.00% | | |
| CC-3-V1 | 10.00% | | |
| PCH-301 | 2.00% | | |

Example M24

| | | | |
|---|---|---|---|
| COY-3-O2 | 19.00% | Clearing point [° C.]: | 70.0 |
| CPY-2-O2 | 9.00% | Δn [589 nm, 20° C.]: | 0.1186 |
| CPY-3-O2 | 11.00% | Δε [1 kHz, 20° C.]: | −3.1 |
| CLY-3-O2 | 5.00% | K₁ [pN, 20° C.]: | 12.1 |
| PYP-2-3 | 11.00% | K₃ [pN, 20° C.]: | 13.5 |
| PYP-2-4 | 5.50% | γ₁ [mPa · s, 20° C.]: | 115 |
| CCH-35 | 6.00% | V₀ [20° C., V]: | 2.17 |
| CCH-23 | 19.00% | | |
| PCH-301 | 11.50% | | |
| CPGP-4-3 | 3.00% | | |

Example M25

| | | | |
|---|---|---|---|
| COY-3-O2 | 24.00% | Clearing point [° C.]: | 70.0 |
| CPY-2-O2 | 11.00% | Δn [589 nm, 20° C.]: | 0.1183 |
| CPY-3-O2 | 11.00% | Δε [1 kHz, 20° C.]: | −3.0 |
| CLY-3-O2 | 3.00% | K₁ [pN, 20° C.]: | 13.0 |
| PGP-2-3 | 5.00% | K₃ [pN, 20° C.]: | 14.1 |
| PGP-2-4 | 6.00% | γ₁ [mPa · s, 20° C.]: | 114 |
| PGP-2-5 | 6.00% | V₀ [20° C., V]: | 2.17 |
| CCH-35 | 6.00% | | |
| CCH-23 | 19.00% | | |
| PCH-301 | 6.50% | | |
| CPGP-4-3 | 2.50% | | |

Example M26

| | | | |
|---|---|---|---|
| CCH-23 | 15.50% | Clearing point [° C.]: | 74.5 |
| PCH-301 | 7.00% | Δn [589 nm, 20° C.]: | 0.1416 |
| PGP-2-3 | 4.00% | Δε [1 kHz, 20° C.]: | −2.9 |
| PGP-2-4 | 7.00% | K₁ [pN, 20° C.]: | 12.4 |
| PGP-2-5 | 7.00% | K₃ [pN, 20° C.]: | 14.1 |
| COY-3-O2 | 10.50% | γ₁ [mPa · s, 20° C.]: | 147 |
| CY-3-O2 | 10.00% | V₀ [20° C., V]: | 2.24 |
| CCY-3-O2 | 9.00% | | |
| CPY-2-O2 | 7.00% | | |
| CPY-3-O2 | 8.00% | | |
| PYP-2-3 | 7.00% | | |
| PYP-2-4 | 8.00% | | |

1-19. (canceled)

20. Liquid-crystalline medium based on a mixture of polar compounds, which comprises:
at least one compound of the formula I, 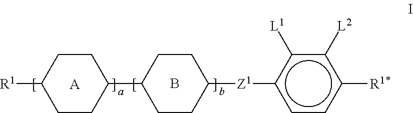
in which
R¹ and R¹* each, independently of one another, denote an alkyl or alkoxy radical having 1 to 15 C atoms, where, in addition, one or more CH₂ groups in these radicals are optionally replaced, independently of one another, by —C≡C—, —CF₂O—, —CH═CH—, 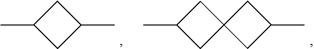
—O—, —CO—O—, —O—CO— in such a way that O atoms are not linked directly to one another, and in which, in addition, one or more H atoms are optionally replaced by halogen,
Z¹ denotes —CH₂O— or —OCH₂—
a denotes 0, 1 or 2
b denotes 1 or 2, 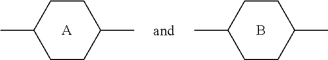
each, independently of one another, denote 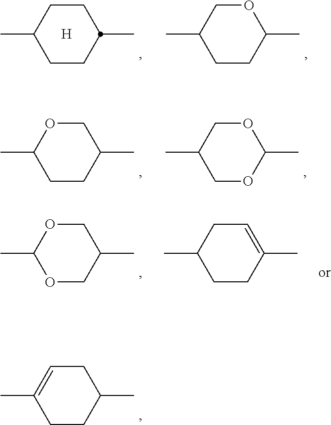
and
L¹ and L² each, independently of one another, denote F, Cl, CF₃, OCF₃ or CHF₂; and
one or more polymerizable compounds selected from the compounds of the formula I* or one or more polymers obtained by polymerizing compounds selected from the compounds of the formula I*
R^{a}-A¹-(Z¹-A²)ₘ-R^{b} I*
in which the individual radicals have the following meanings:
R^{a} and R^{b} each, independently of one another, denote P, P-Sp-, H, halogen, SF₅, NO₂, a carbon group or hydrocarbon group, where at least one of the radicals R^{a} and R^{b} denotes or contains a group P or P-Sp-,
P on each occurrence, identically or differently, denotes a polymerisable group,
Sp on each occurrence, identically or differently, denotes a spacer group or a single bond,
A¹ and A² each, independently of one another, denote an aromatic, heteroaromatic, alicyclic or heterocyclic group, which may also contain fused rings, and which may also be mono- or polysubstituted by L,
L denotes P-Sp-, H, OH, CH₂OH, halogen, SF₅, NO₂, a carbon group or hydrocarbon group,
Z¹ on each occurrence, identically or differently, denotes —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, CR⁰R⁰⁰ or a single bond,
R⁰ and R⁰⁰ each, independently of one another, denote H or alkyl having 1 to 12 C atoms,
m denotes 0, 1, 2, 3 or 4, and
n1 denotes 1, 2, 3 or 4.

21. Liquid-crystalline medium based on a mixture of polar compounds, which comprises:
at least one compound of the formula I, 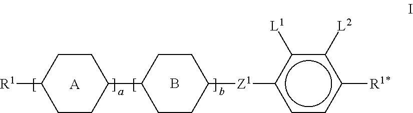
in which
R¹ and R¹* each, independently of one another, denote an alkyl or alkoxy radical having 1 to 15 C atoms, where, in addition, one or more CH₂ groups in these radicals are optionally replaced, independently of one another, by —C≡C—, —CF₂O—, —CH═CH—, 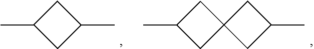
—O—, —CO—O—, —O—CO— in such a way that O atoms are not linked directly to one another, and in which, in addition, one or more H atoms are optionally replaced by halogen,
Z¹ denotes —CH₂O— or —OCH₂—
a denotes 0, 1 or 2
b denotes 1 or 2, 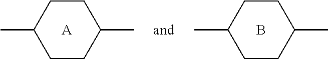
each, independently of one another, denote 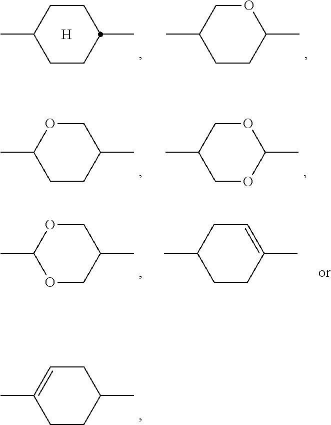
and
L¹ and L² each, independently of one another, denote F, Cl, CF₃, OCF₃ or CHF₂; and
one or more polymerizable compounds selected from the reactive mesogen compounds of formulae RM-1 to RM-74 or one or more polymers obtained by polymerizing compounds selected from the compounds of the formulae RM-1 to RM-74:

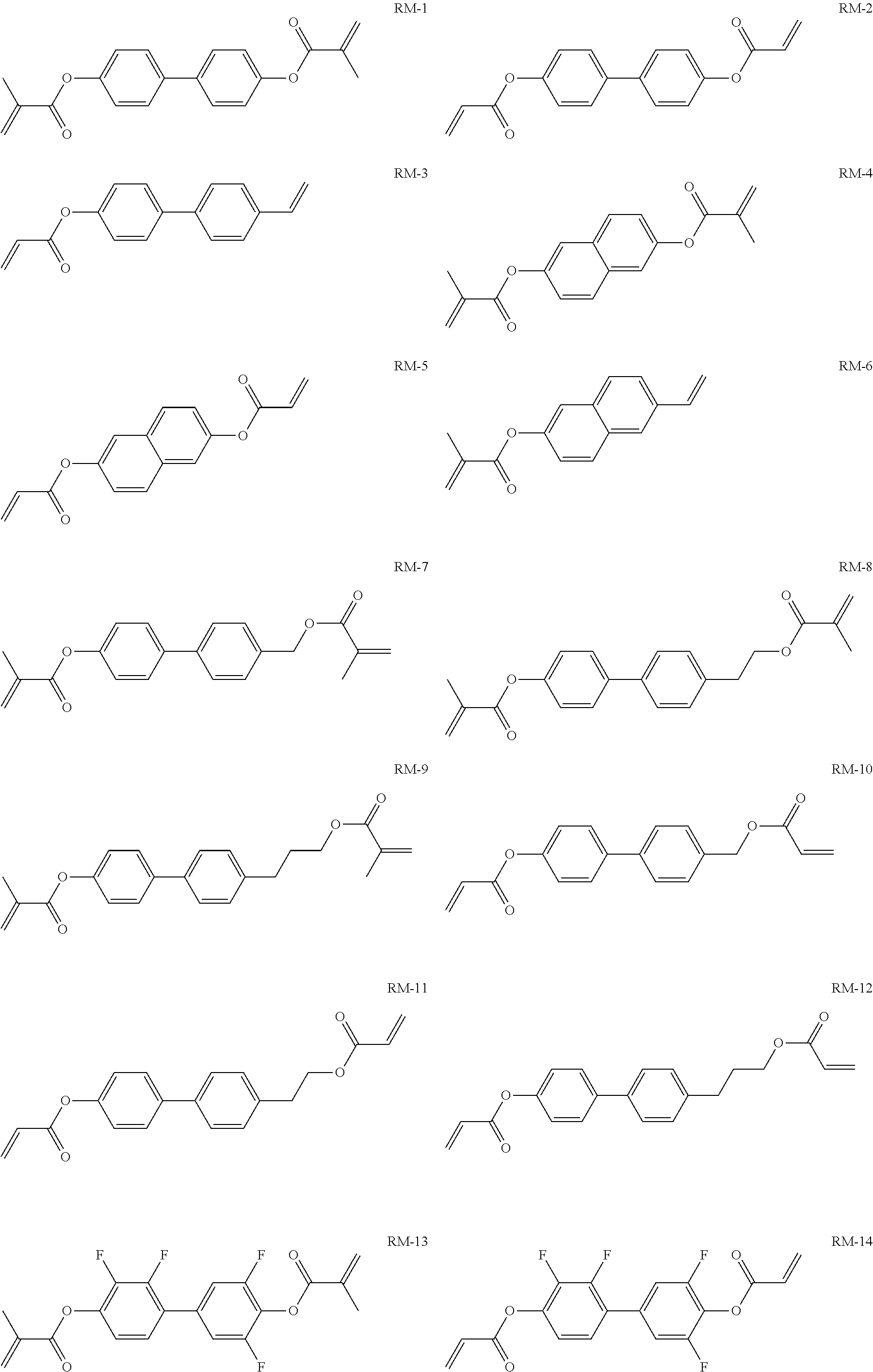

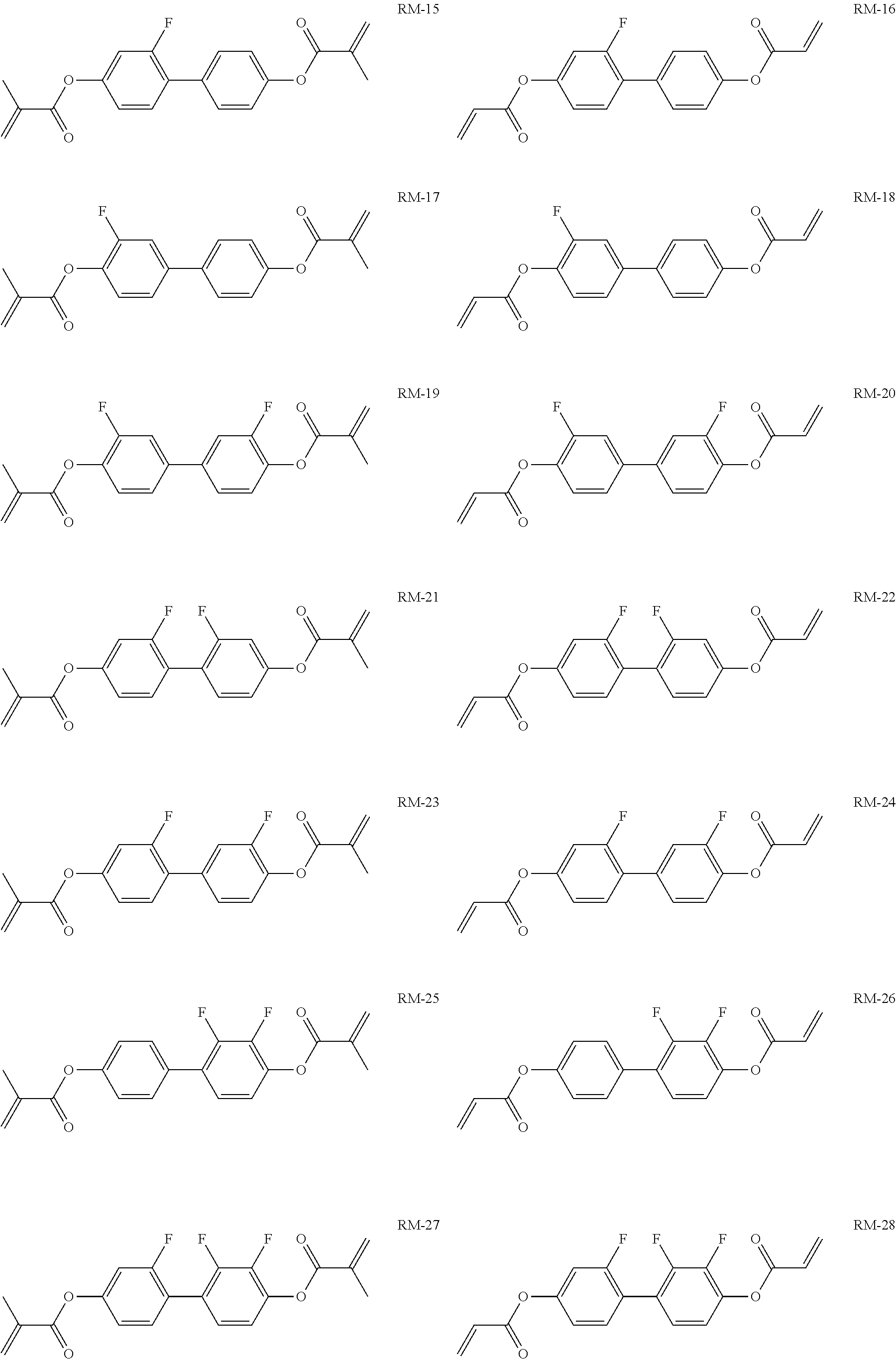

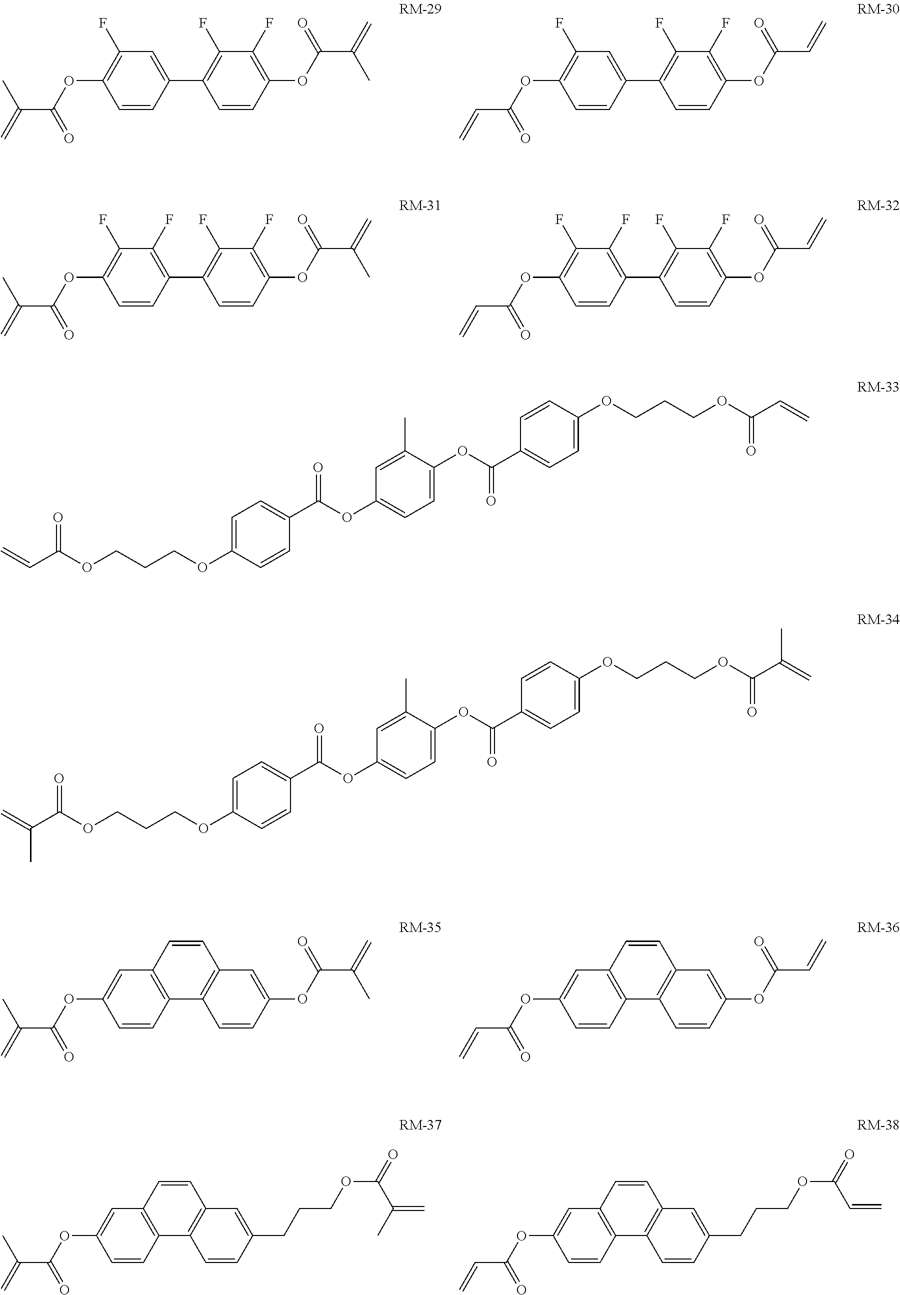

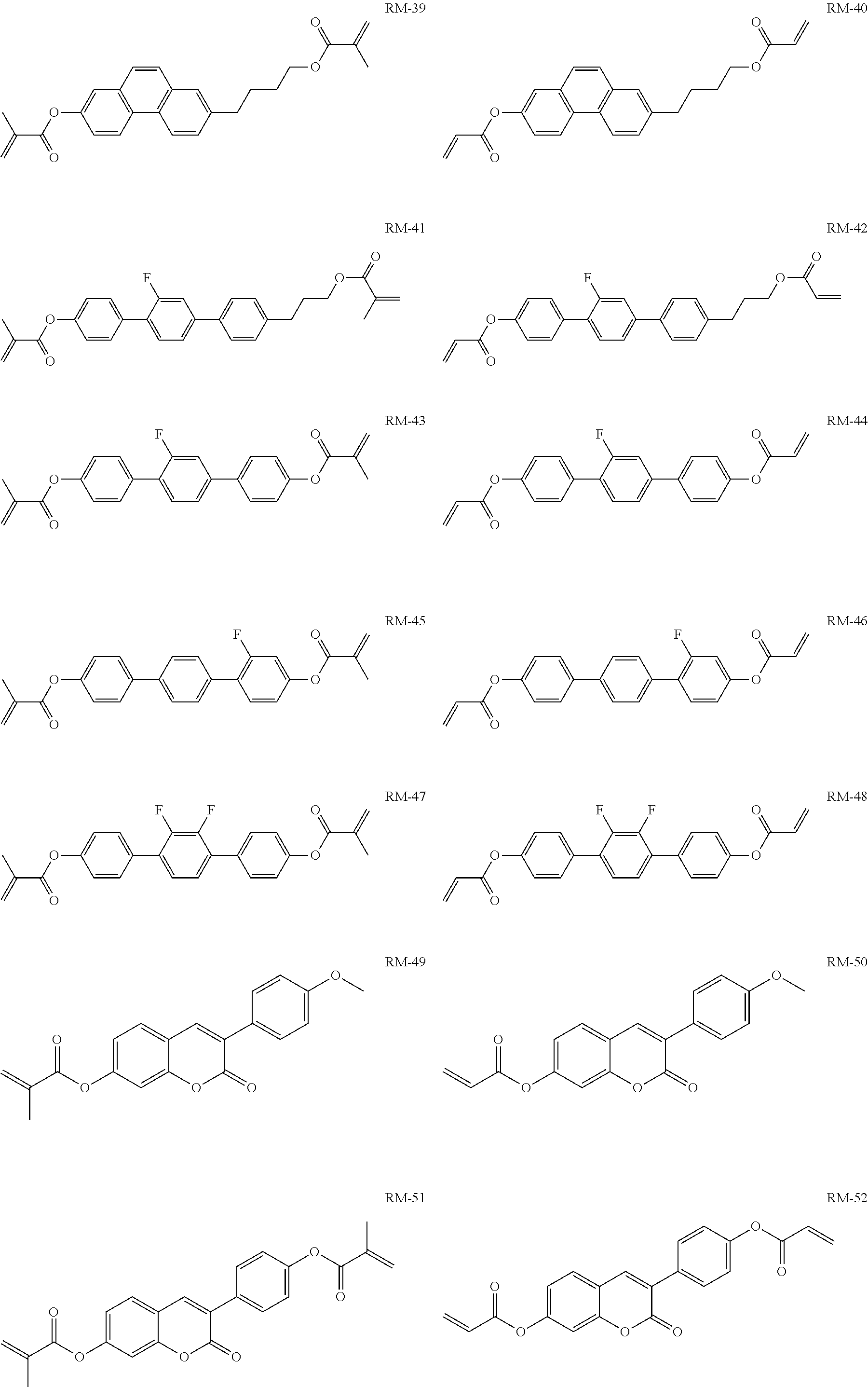

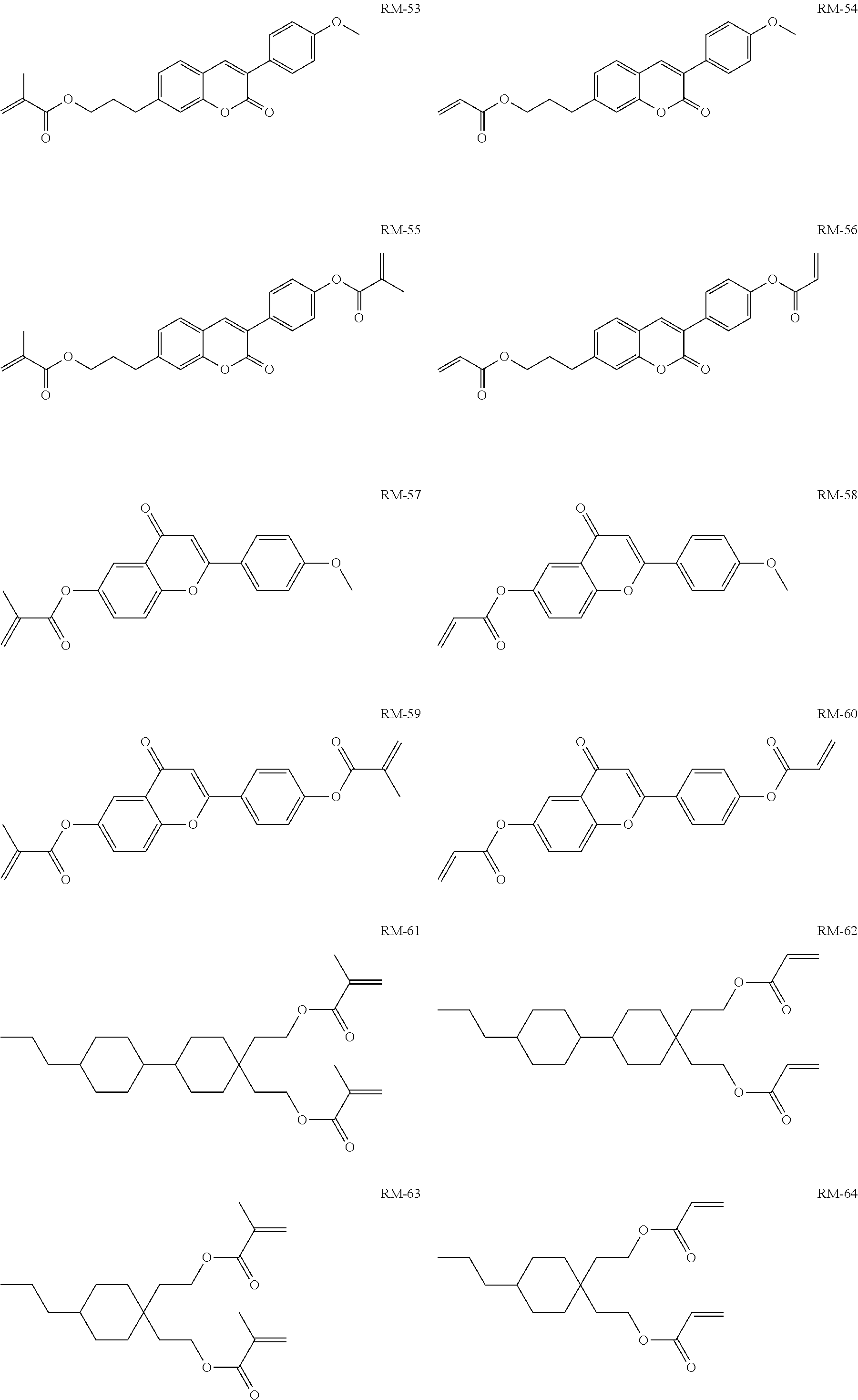

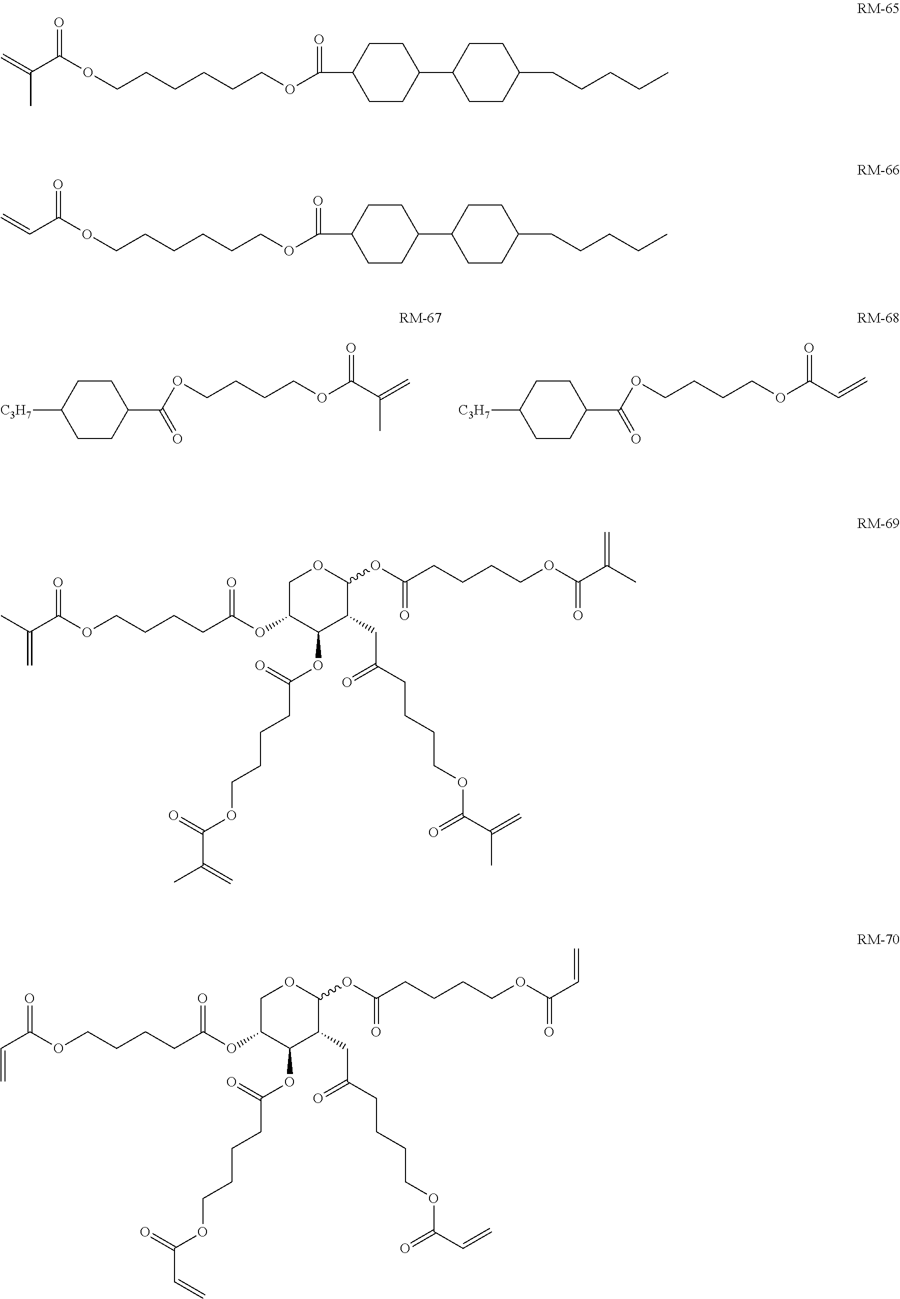

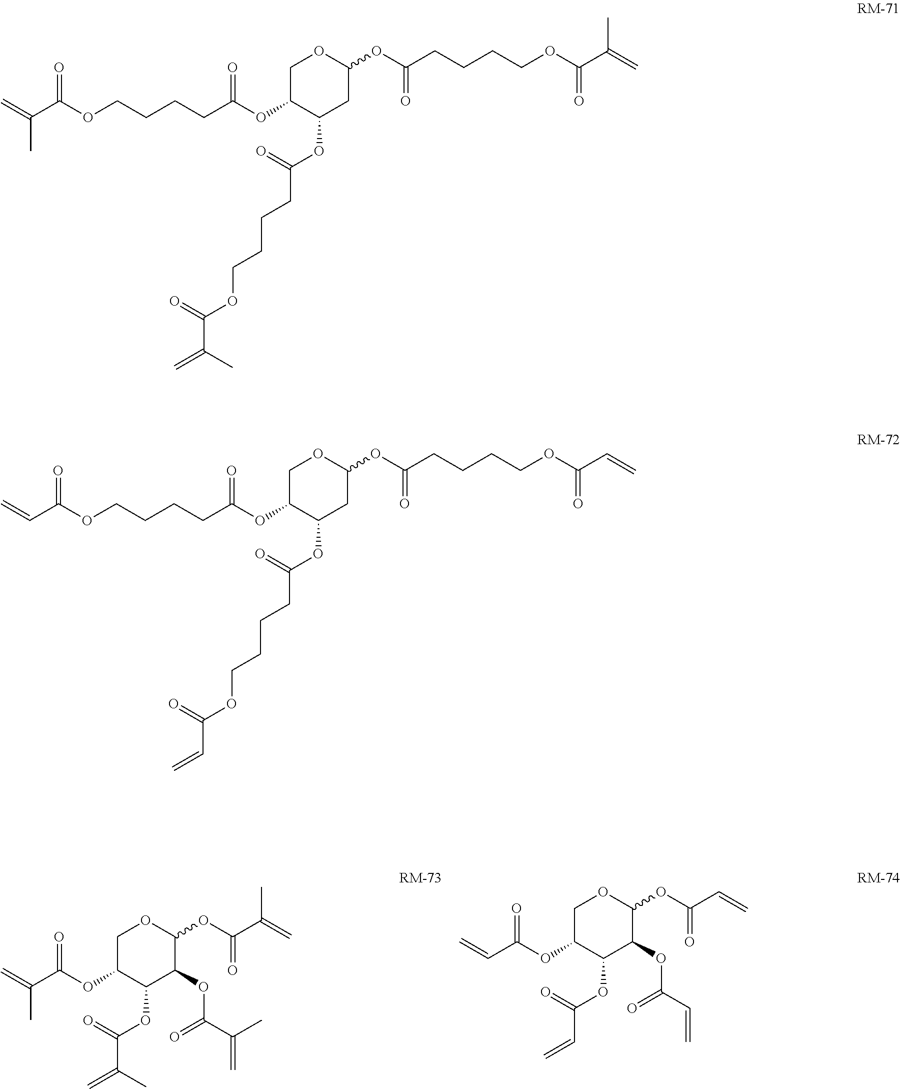

22. Liquid-crystalline medium based on a mixture of polar compounds, which comprises:
at least one compound of the formula I, 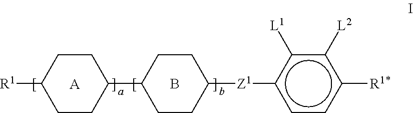
in which
R¹ and R¹* each, independently of one another, denote an alkyl or alkoxy radical having 1 to 15 C atoms, where, in addition, one or more CH₂ groups in these radicals are optionally replaced, independently of one another, by —C≡C—, —CF₂O—, —CH═CH—, 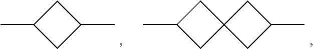
—O—, —CO—O—, —O—CO— in such a way that O atoms are not linked directly to one another, and in which, in addition, one or more H atoms are optionally replaced by halogen,
Z¹ denotes —CH₂O— or —OCH₂—
a denotes 0, 1 or 2
b denotes 1 or 2, 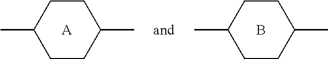
each, independently of one another, denote 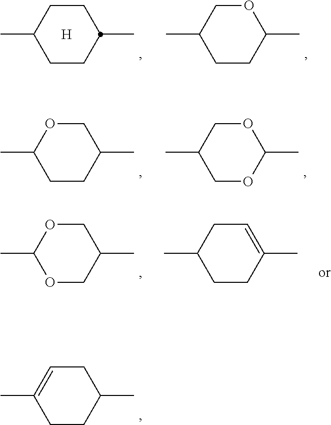
and
L¹ and L² each, independently of one another, denote F, Cl, CF₃, OCF₃ or CHF₂; and
which additionally comprises one or more compounds selected from the group of the compounds of the formulae III, L1-L12, T1-T21, O1-O16 and In: 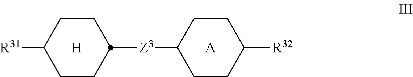
in which
R³¹ and R³² each, independently of one another, denote a straight-chain alkyl, alkoxyalkyl or alkoxy radical having 1 to 12 C atoms, and 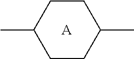
denotes 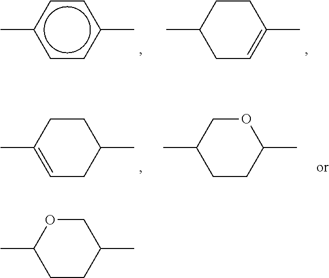
Z³ denotes a single bond, —CH₂CH₂—, —CH═CH—, —CF₂O—, —OCF₂—, —CH₂O—, —OCH₂—, —COO—, —OCO—, —C₂F₄—, —C₄H₈—, or —CF═CF—, 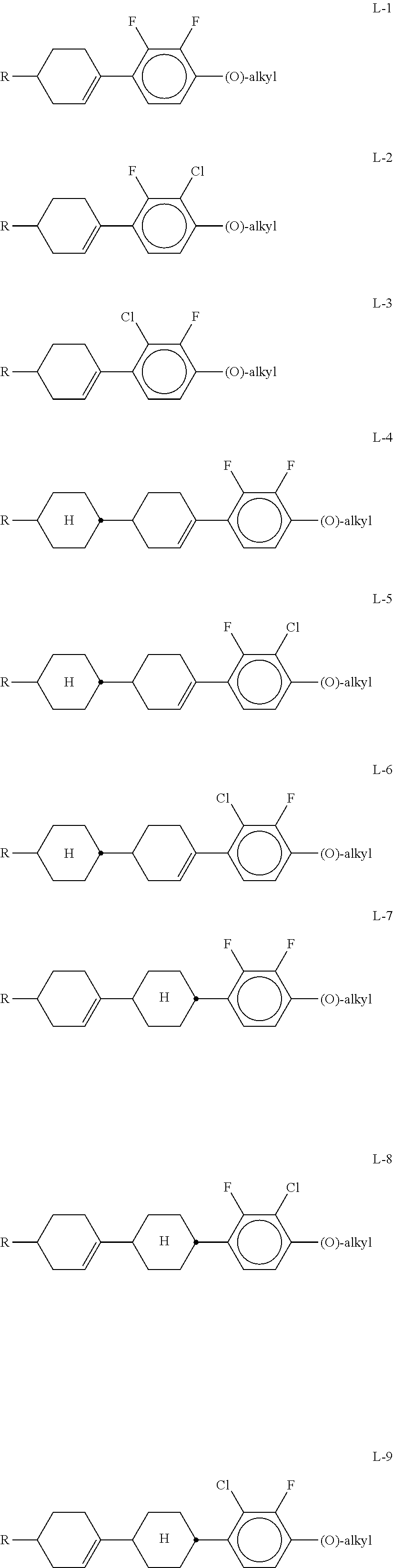 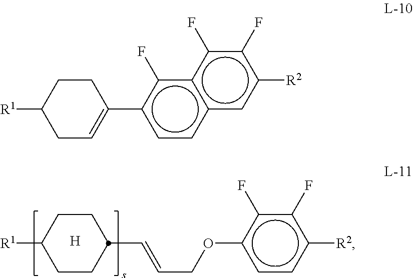
in which
R, R¹ and R² each, independently of one another, denote H, an alkyl radical having up to 15 C atoms which is unsubstituted, monosubstituted by CN or CF₃ or at least monosubstituted by halogen, where, in addition, one or more CH₂ groups in these radicals are optionally replaced by —O—, —S—, 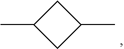
—C≡C—, —CF₂O—, —OCF₂—, —OC—O— or —O—CO— in such a way that O atoms are not linked directly to one another, alkyl denotes an alkyl radical having 1-6 C atoms, and
s denotes 1 or 2, 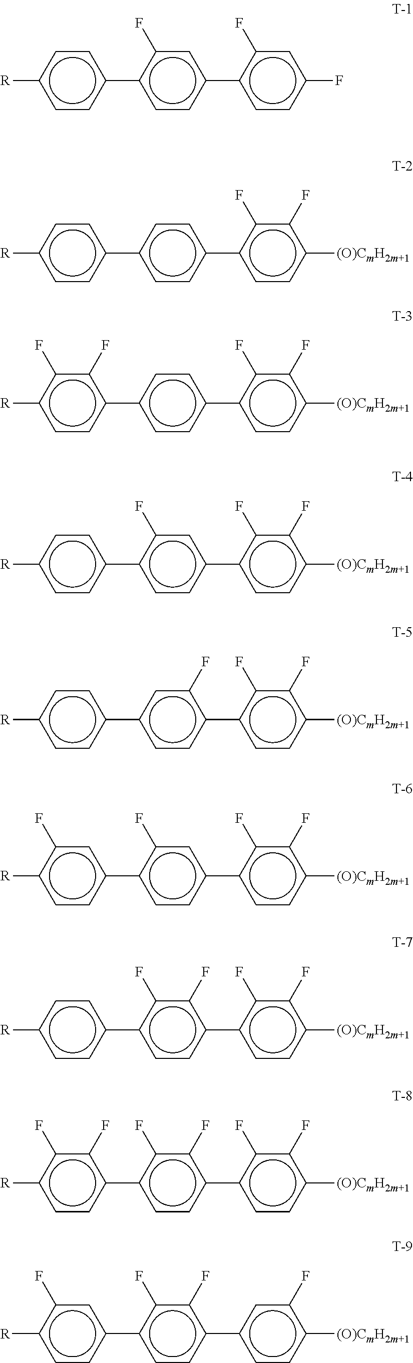 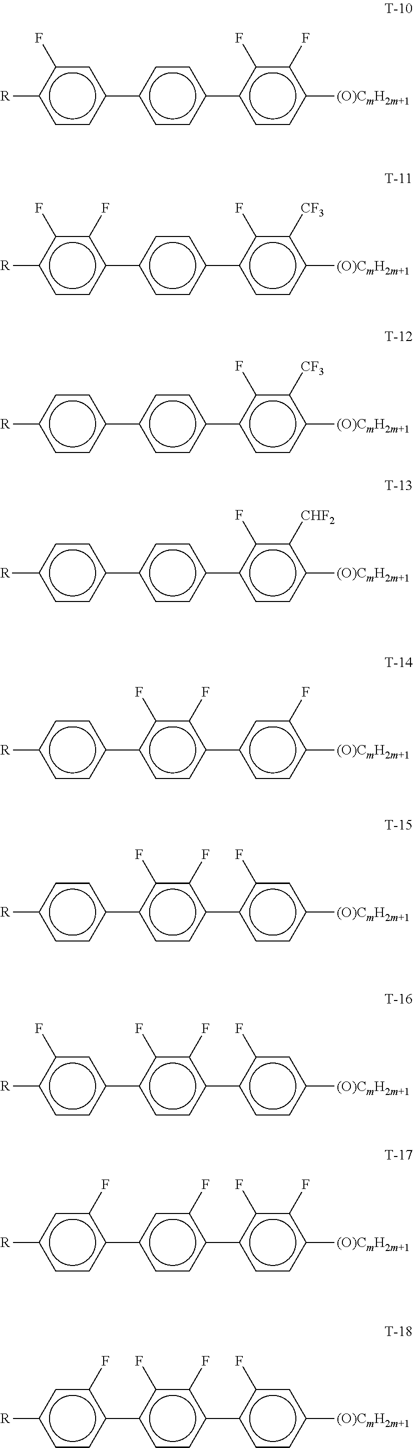 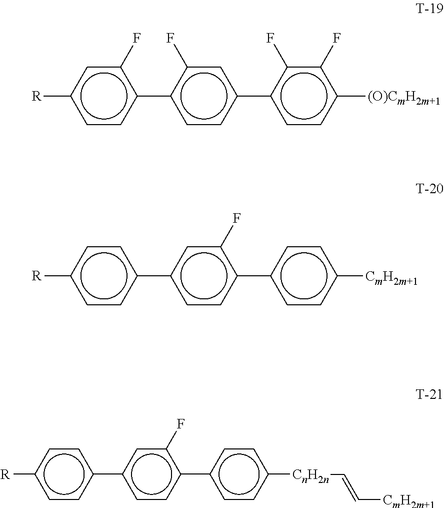
in which
R denotes a straight-chain alkyl or alkoxy radical having 1-7 C atoms, and
m denotes 1-6, 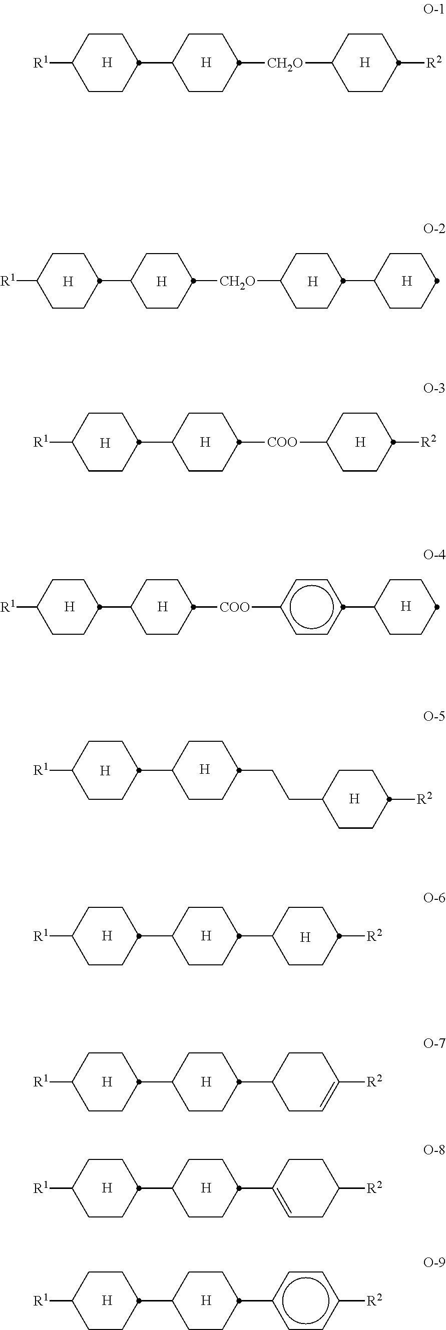 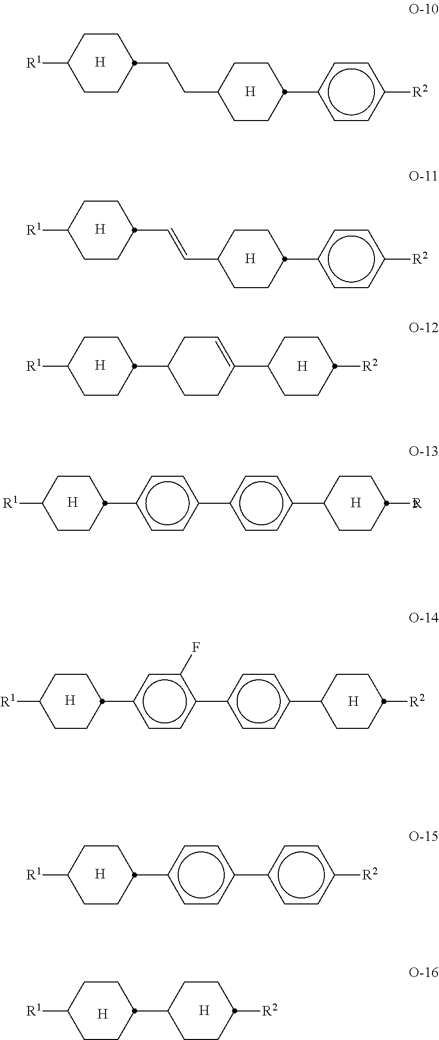
in which
R¹ and R² each, independently of one another, denote H, an alkyl radical having up to 15 C atoms which is unsubstituted, monosubstituted by CN or CF₃ or at least monosubstituted by halogen, where, in addition, one or more CH₂ groups in these radicals are optionally replaced by —O—, —S—, 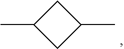
—C≡—, —CF₂O—, —OCF₂—, —OC—O— or —O—CO— in such a way that O atoms are not linked directly to one another, 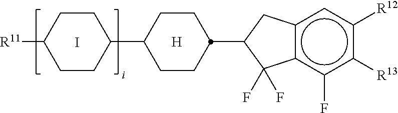
In in which
R¹¹, R¹², R¹³ denote a straight-chain alkyl, alkoxy, alkoxyalkyl or alkenyl radical having 1-5 C atoms,
R¹² and R¹³ additionally also denote halogen or hydrogen, 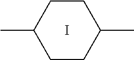
denotes 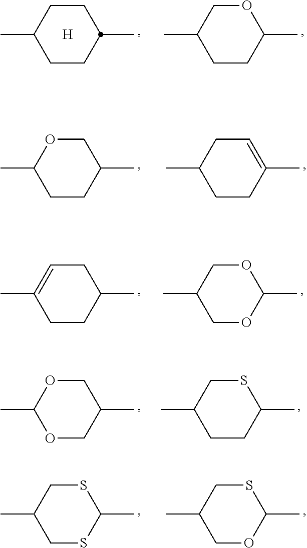
and
i denotes 0, 1 or 2.

23. Liquid-crystalline medium based on a mixture of polar compounds, which exhibits the following combination of properties:
a clearing point ≥70° C.; threshold voltage from 1.7 V to 3.0 V; voltage holding ratio (VHR after 15 min. exposure to UVA measured after 5 min. at 100° C. at 1V, 60 Hz, 64 μs pulse) is 97.6% or more; low-temperature stability at −20° C. and −30° C.; rotational viscosity at 20° C.≤165 mPa·s; optical anisotropy Δn at 20° C. and 589 nm of 0.07 to 0.16; and dielectric anisotropy Δε at 20° C. and 1 kHz of −0.5 to −8.0; and
which comprises:
at least one compound of the formula I, 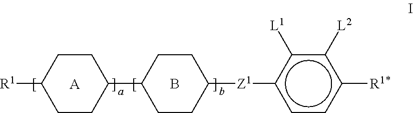
in which
R¹ and R¹* each, independently of one another, denote an alkyl or alkoxy radical having 1 to 15 C atoms, where, in addition, one or more CH₂ groups in these radicals are optionally replaced, independently of one another, by —C≡C—, —CF₂O—, —CH═CH—, 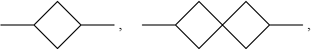
—O—, —CO—O—, —O—CO— in such a way that O atoms are not linked directly to one another, and in which, in addition, one or more H atoms are optionally replaced by halogen,
Z¹ denotes —CH₂O— or —OCH₂—
a denotes 0, 1 or 2
b denotes 1 or 2, 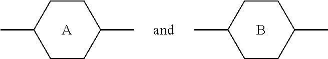
each, independently of one another, denote 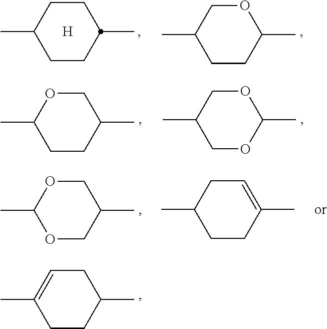
and
L¹ and L² each, independently of one another, denote F, Cl, CF₃, OCF₃ or CHF₂.

24. A PS-VA or PSA display having a low pre-tilt angle of ≤85° which comprises a liquid-crystalline medium based on a mixture of polar compounds, including one or more polymerizable reactive mesogen compounds and at least one compound of the formula I and not containing a photoinitiator: 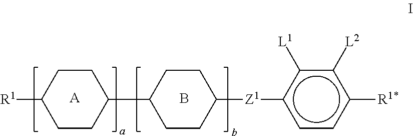
in which
R¹ and R¹* each, independently of one another, denote an alkyl or alkoxy radical having 1 to 15 C atoms, where, in addition, one or more CH₂ groups in these radicals are optionally replaced, independently of one another, by —C≡C—, —CF₂O—, —CH═CH—, 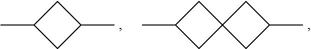
—O—, —CO—O—, —O—CO— in such a way that O atoms are not linked directly to one another, and in which, in addition, one or more H atoms are optionally replaced by halogen,
Z¹ denotes —CH₂O— or —OCH₂—
a denotes 0, 1 or 2
b denotes 1 or 2, 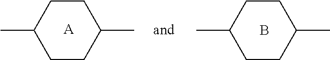
each, independently of one another, denote 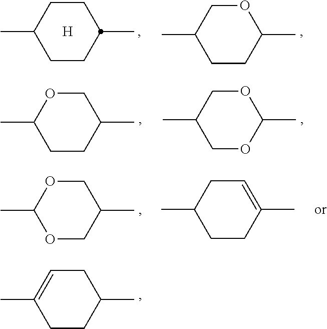
and
L¹ and L² each, independently of one another, denote F, Cl, CF₃, OCF₃ or CHF₂.

25. A liquid-crystalline medium according to claim 20, further comprising one or more compounds selected from the group of the compounds of the formulae IIA, IIB and IIC, 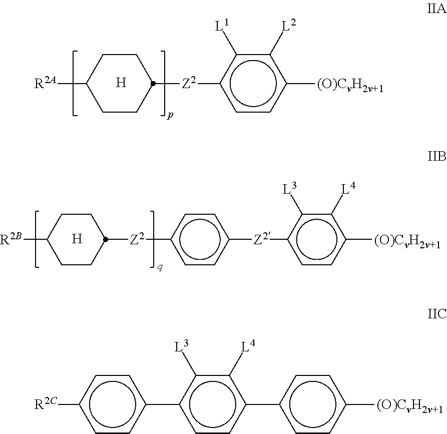
in which
R^{2A}, R^{2B} and R^{2C} each, independently of one another, denote H, an alkyl radical having up to 15 C atoms which is unsubstituted, monosubstituted by CN or CF₃ or at least monosubstituted by halogen, where, in addition, one or more CH₂ groups in these radicals may be replaced by —O—, —S—, 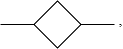
—C≡C—, —CF₂O—, —OCF₂—, —OC—O— or —O—CO— in such a way that O atoms are not linked directly to one another,
L¹⁻⁴ each, independently of one another, denote F, Cl, CF₃ or CHF₂,
Z² and Z^{2′} each, independently of one another, denote a single bond, —CH₂CH₂—, —CH═CH—, —CF₂O—, —OCF₂—, —COO—, —OCO—, —C₂F₄—, —CF═CF—, —CH═CHCH₂O—,
p denotes 1 or 2,
q denotes 0 or 1, and
v denotes 1 to 6.

26. A liquid-crystalline medium according to claim 21, further comprising one or more compounds selected from the group of the compounds of the formulae IIA, IIB and IIC, 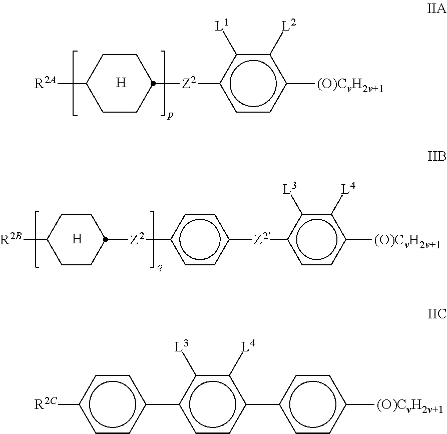
in which
R^{2A}, R^{2B} and R^{2C} each, independently of one another, denote H, an alkyl radical having up to 15 C atoms which is unsubstituted, monosubstituted by CN or CF₃ or at least monosubstituted by halogen, where, in addition, one or more CH₂ groups in these radicals may be replaced by —O—, —S—, 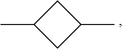
—C≡C—, —CF₂O—, —OCF₂—, —OC—O— or —O—CO— in such a way that O atoms are not linked directly to one another,
L¹⁻⁴ each, independently of one another, denote F, Cl, CF₃ or CHF₂,
Z² and Z²′ each, independently of one another, denote a single bond, —CH₂CH₂—, —CH═CH—, —CF₂O—, —OCF₂—, —COO—, —OCO—, —C₂F₄—, —CF═CF—, —CH═CHCH₂O—,
p denotes 1 or 2,
q denotes 0 or 1, and
v denotes 1 to 6.

27. A liquid-crystalline medium according to claim 22, further comprising one or more compounds selected from the group of the compounds of the formulae IIA, IIB and IIC, 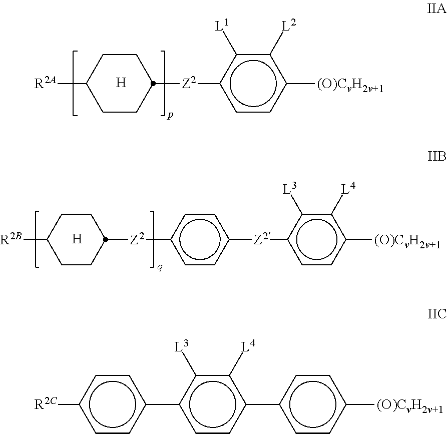
in which
R^{2A}, R^{2B} and R^{2C} each, independently of one another, denote H, an alkyl radical having up to 15 C atoms which is unsubstituted, monosubstituted by CN or CF₃ or at least monosubstituted by halogen, where, in addition, one or more CH₂ groups in these radicals may be replaced by —O—, —S—, 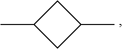
—C≡C—, —CF₂O—, —OCF₂—, —OC—O— or —O—CO— in such a way that O atoms are not linked directly to one another,
L¹⁻⁴ each, independently of one another, denote F, Cl, CF₃ or CHF₂,
Z² and Z^{2′} each, independently of one another, denote a single bond, —CH₂CH₂—, —CH═CH—, —CF₂O—, —OCF₂—, —COO—, —OCO—, —C₂F₄—, —CF═CF—, —CH═CHCH₂O—,
p denotes 1 or 2,
q denotes 0 or 1, and
v denotes 1 to 6.

28. A liquid-crystalline medium according to claim 23, further comprising one or more compounds selected from the group of the compounds of the formulae IIA, IIB and IIC, 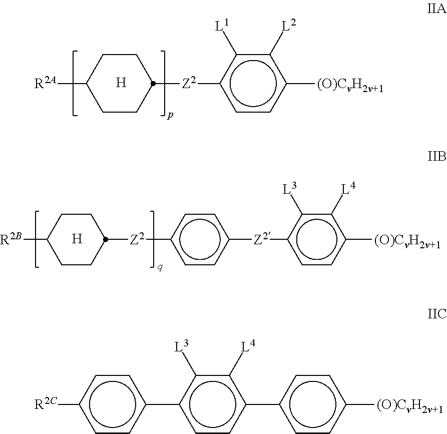
in which
R^{2A}, R^{2B} and R^{2C} each, independently of one another, denote H, an alkyl radical having up to 15 C atoms which is unsubstituted, monosubstituted by CN or CF₃ or at least monosubstituted by halogen, where, in addition, one or more CH₂ groups in these radicals may be replaced by —O—, —S—, 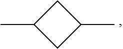
—C≡C—, —CF₂O—, —OCF₂—, —OC—O— or —O—CO— in such a way that O atoms are not linked directly to one another,
L¹⁻⁴ each, independently of one another, denote F, Cl, CF₃ or CHF₂,
Z² and Z^{2′} each, independently of one another, denote a single bond, —CH₂CH₂—, —CH═CH—, —CF₂O—, —OCF₂—, —COO—, —OCO—, —C₂F₄—, —CF═CF—, —CH═CHCH₂O—,
p denotes 1 or 2,
q denotes 0 or 1, and
v denotes 1 to 6.

29. A display according to claim 24, wherein the liquid-crystalline medium further comprising one or more compounds selected from the group of the compounds of the formulae IIA, IIB and IIC, 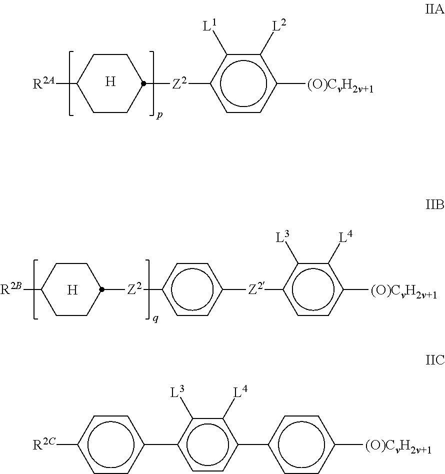
in which
R^{2A}, R^{2B} and R^{2C} each, independently of one another, denote H, an alkyl radical having up to 15 C atoms which is unsubstituted, monosubstituted by CN or CF₃ or at least monosubstituted by halogen, where, in addition, one or more CH₂ groups in these radicals may be replaced by —O—, —S—, 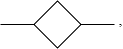
—C≡C—, —CF₂O—, —OCF₂—, —OC—O— or —O—CO— in such a way that O atoms are not linked directly to one another,
L¹⁻⁴ each, independently of one another, denote F, Cl, CF₃ or CHF₂,
Z² and Z²′ each, independently of one another, denote a single bond, —CH₂CH₂—, —CH═CH—, —CF₂O—, —OCF₂—, —COO—, —OCO—, —C₂F₄—, —CF═CF—, —CH═CHCH₂O—,
p denotes 1 or 2,
q denotes 0 or 1, and
v denotes 1 to 6.

30. Liquid-crystalline medium according to claim 22, which comprises one or more compounds selected from the group of the compounds of the formula III.

31. Liquid-crystalline medium according to claim 22, which comprises one or more compounds selected from the group of the compounds of the formulae L1-L12.

32. Liquid-crystalline medium according to claim 22, which comprises one or more compounds selected from the group of the compounds of the formulae T1-T21.

33. Liquid-crystalline medium according to claim 22, which comprises one or more compounds selected from the group of the compounds of the formulae O1-O16.

34. Liquid-crystalline medium according to claim 22, which comprises one or more compounds selected from the group of the compounds of the formula In.
